(19) United States
(12) Patent Application Publication
(10) Pub. No.: US 2025/0087917 A1
(43) Pub. Date: Mar. 13, 2025

(54) CONNECTOR SET AND CONNECTOR

(71) Applicants: ACES Electronics Co., Ltd., Taoyuan (TW); ACES Japan Co., Ltd., Tokyo (JP)

(72) Inventors: Nobukazu KATO, Tokyo (JP); Hiroaki Hashimoto, Tokyo (JP)

(21) Appl. No.: 18/958,157

(22) Filed: Nov. 25, 2024

Related U.S. Application Data
(63) Continuation-in-part of application No. PCT/JP2023/019767, filed on May 26, 2023.

(30) Foreign Application Priority Data
May 26, 2022 (JP) 2022-086331

(51) Int. Cl. H01R 12/77; H01R 12/79; H01R 13/6471

(52) U.S. Cl. CPC H01R 12/775; H01R 12/79; H01R 13/6471

(57) ABSTRACT

A connector set and a connector capable of meeting requirements for wiring in an information device such as a server and, in particular, enhancing a high-speed transmission characteristic are provided. The connector set includes: a first connector; and a counterpart second connector capable of being mated with the first connector, in which the first connector includes: a signal contact connected to a signal line; a ground contact connected to ground; and a flat ground plate connected to the ground, the signal contact includes a plurality of first signal contacts disposed to face a first main surface of the flat ground plate, the ground contact includes a first ground contact disposed between adjacent ones of the plurality of first signal contacts, and the first ground contact makes direct contact with the first main surface of the flat ground plate.

### CROSS REFERENCE TO RELATED APPLICATIONS

This application is a continuation in-part of International Patent Application No. PCT/JP2023/019767, filed on May 26, 2023, the disclosure of which is incorporated herein by reference in its entirety. International Patent Application No. PCT/JP2023/019767 is entitled to or claims the benefit of Japanese Patent Application No. 2022-086331, filed on May 26, 2022, the disclosure of which is incorporated herein by reference in its entirety.

### TECHNICAL FIELD

The present invention relates to a connector set and a connector, and more particularly relates to a technique suitable for high-speed signal transmission.

### BACKGROUND ART

There is a conventionally known technique to enable high-speed transmission by wiring with, for example, a cable for differential signal transmission (hereinafter referred to as “Twinax cable”) in an information device such as a server, a switch, and a storage. For example, Patent Literatures (hereinafter, referred to as “PTLs”) 1 and 2 disclose a connector capable of collectively connecting a plurality of Twinax cables to a circuit board or the like.

### CITATION LIST

### Patent Literature

### PTL 1

Japanese Patent No. 6872033

### PTL 2

US Patent Application Publication No. 2021/305740

### SUMMARY OF INVENTION

### Technical Problem

To enhance a high-speed transmission characteristic, it is essential to reinforce the ground structure of a connector. At the same time, it is required to ensure isolation between high-speed signal transmission lines.

An objective of the present invention is to provide a connector set and a connector capable of meeting a requirement for wiring in an information device such as a server, and more particularly enhancing a high-speed transmission characteristic.

### Solution to Problem

A connector set according to the present invention includes:
a first connector; and
a counterpart second connector capable of being mated with the first connector, wherein
the first connector includes:
   a signal contact connected to a signal line;
   a ground contact connected to ground; and
   a flat ground plate connected to the ground,
the signal contact includes a plurality of first signal contacts disposed to face a first main surface of the flat ground plate,
the ground contact includes a first ground contact disposed between adjacent ones of the plurality of first signal contacts, and
the first ground contact makes direct contact with the first main surface of the flat ground plate.

A connector according to the present invention includes:
a signal contact connected to a signal line;
a ground contact connected to ground; and
a flat ground plate connected to the ground, wherein
the signal contact includes a plurality of first signal contacts disposed to face a first main surface of the flat ground plate,
the ground contact includes a first ground contact disposed between adjacent ones of the plurality of first signal contacts, and
the first ground contact makes direct contact with the first main surface of the flat ground plate.

### BRIEF DESCRIPTION OF DRAWINGS

FIG. 1 illustrates the appearance of a connector set according to Embodiment 1;

FIGS. 2A and 2B are exploded perspective views of the connector set of Embodiment 1;

FIG. 3 is an exploded perspective view of a cable-side connector of Embodiment 1;

FIG. 4 is another exploded perspective view of the cable-side connector of Embodiment 1;

FIGS. 5A and 5B are perspective views illustrating how cables are attached to a cable-side connector body of Embodiment 1;

FIGS. 6A and 6B are enlarged views illustrating how the cables are attached to the cable-side connector body of Embodiment 1;

FIGS. 7A and 7B are exploded perspective views illustrating a contact structure in the cable-side connector body of Embodiment 1;

FIG. 8 is an exploded perspective view of a board-side connector of Embodiment 1;

FIGS. 9A to 9C illustrate a contact structure in the board-side connector body of Embodiment 1;

FIGS. 10A and 10B are sectional views illustrating the connection of grounds in the connector set of Embodiment 1;

FIGS. 11A and 11B are sectional views illustrating the connection of signal lines in the connector set of Embodiment 1;

FIGS. 12A to 12C illustrate a contact structure in the board-side connector body of a variation of Embodiment 1;

FIGS. 13A and 13B are sectional views illustrating the connection of grounds in the connector set of the variation of Embodiment 1;

FIG. 14 illustrates the appearance of a connector set according to Embodiment 2;

FIGS. 15A and 15B are exploded perspective views of the connector set of Embodiment 2;

FIG. 16 is an exploded perspective view of a cable-side connector of Embodiment 2;

FIG. 17 is another exploded perspective view of the cable-side connector of Embodiment 2;

FIGS. 18A and 18B are perspective views illustrating how cables are attached to a cable-side connector body of Embodiment 2;

FIGS. 19A and 19B are enlarged views illustrating how the cables are attached to the cable-side connector body of Embodiment 2;

FIGS. 20A and 20B are exploded perspective views illustrating a contact structure in the cable-side connector body of Embodiment 2;

FIG. 21 is an exploded perspective view of a board-side connector of Embodiment 2;

FIGS. 22A to 22C illustrate a contact structure in the board-side connector body of Embodiment 2;

FIGS. 23A and 23B are sectional views illustrating the connection of grounds in the connector set of Embodiment 2;

FIGS. 24A and 24B are sectional views illustrating the connection of signal lines in the connector set of Embodiment 2;

FIG. 25 illustrates the appearance of a connector set according to Embodiment 3;

FIGS. 26A and 26B are exploded perspective views of the connector set of Embodiment 3;

FIG. 27 is an exploded perspective view of a cable-side connector of Embodiment 3;

FIG. 28 is another exploded perspective view of the cable-side connector of Embodiment 3;

FIGS. 29A and 29B are perspective views illustrating how cables are attached to a cable-side connector body of Embodiment 3;

FIGS. 30A and 30B are enlarged views illustrating how the cables are attached to the cable-side connector body of Embodiment 3;

FIG. 31 is an exploded perspective view illustrating a contact structure in the cable-side connector body of Embodiment 3;

FIG. 32 is an exploded perspective view of a board-side connector;

FIGS. 33A to 33C illustrate a contact structure in the board-side connector body of Embodiment 3;

FIGS. 34A and 34B are sectional views illustrating the connection of grounds in the connector set of Embodiment 3;

FIGS. 35A and 35B are sectional views illustrating the connection of signal lines in the connector set of Embodiment 3;

FIGS. 36A to 36C illustrate a contact structure in the board-side connector body of a variation of Embodiment 3;

FIGS. 37A and 37B are sectional views illustrating the connection of grounds in the connector set of the variation of Embodiment 3

FIG. 38 illustrates the appearance of a connector set according to Embodiment 4;

FIGS. 39A and 39B are exploded perspective views of the connector set of Embodiment 4;

FIG. 40 illustrates an example of a cable connected to the cable-side connector;

FIG. 41 is an exploded perspective view of the cable-side connector of Embodiment 4;

FIG. 42 is an exploded perspective view of a cable-side connector body of Embodiment 4;

FIG. 43 is a perspective view illustrating how cables are attached to the cable-side connector body of Embodiment 4;

FIG. 44 is an enlarged view illustrating how cables are attached to the cable-side connector body of Embodiment 4;

FIG. 45 is an exploded perspective view showing the contact structure in the cable-side connector body of Embodiment 4;

FIG. 46 illustrates an example of a lightening hole;

FIGS. 47A to 47C illustrate specific examples of the lightening hole;

FIG. 48 is an exploded perspective view of a board-side connector of Embodiment 4;

FIGS. 49A to 49C illustrate the contact structure in a board-side connector body of Embodiment 4;

FIG. 50 is a sectional view illustrating connection of grounds in a connector set of Embodiment 4;

FIG. 51 is a sectional view illustrating connection of signal lines in the connector set of Embodiment 4;

FIG. 52 illustrates the appearance of a connector set according to Embodiment 5;

FIGS. 53A and 53B are exploded perspective views of the connector set of Embodiment 5;

FIG. 54 is an exploded perspective view of a cable-side connector of Embodiment 5;

FIG. 55 is an exploded perspective view of a cable-side connector body of Embodiment 5;

FIG. 56 is a perspective view illustrating how cables are attached to the cable-side connector body of Embodiment 5;

FIG. 57 is an exploded perspective view showing the contact structure in the cable-side connector body of Embodiment 5;

FIG. 58 is an exploded perspective view of a board-side connector of Embodiment 5;

FIG. 59 illustrates the contact structure in a board-side connector body of Embodiment 5;

FIG. 60 is an exploded perspective view showing the contact structure in the board-side connector body of Embodiment 5;

FIG. 61 is a sectional view illustrating the connection of grounds in a connector set of Embodiment 5;

FIG. 62 is a sectional view illustrating the connection of signal lines in the connector set of Embodiment 5;

FIG. 63 illustrates an example of a flat cable connected to the cable-side connector;

FIG. 64 illustrates the cable-side connector body with a flat cable connected;

FIGS. 65A and 65B illustrate another example of a flat cable connected to the cable-side connector;

FIGS. 66A and 66B illustrate the cable-side connector body with a flat cable connected;

FIG. 67 is a sectional view showing a contact state between slits of flat-plane interconnection shielding sections and a flat cable;

FIG. 68 is an enlarged view showing the slits of the flat-plane interconnection shielding sections;

FIG. 69 illustrates another example of a cable-side connector to which a flat cable is applied;

FIG. 70 is an exploded perspective view of the cable-side connector shown in FIG. 69;

FIG. 71 is an enlarged view showing a mounting state of the cover shell to the cable-side connector body;

FIG. 72 is an exploded perspective view of cable-side connector body 601;

FIG. 73 is an enlarged view showing the connection part between the paddle card and the flat cable;

FIGS. 74A and 74B are enlarged views showing the inner structure of the ground shield;

FIG. 75 is a sectional view passing through the connection part between the cable-side signal contacts and the internal conductors; and

FIG. 76 is a sectional view passing through the connection part between the cable-side ground contacts and a partition section of the ground shield.

### DESCRIPTION OF THE PREFERRED EMBODIMENTS

Hereinafter, embodiments of the present invention will be described in detail with reference to the accompanying drawings.

### Embodiment 1

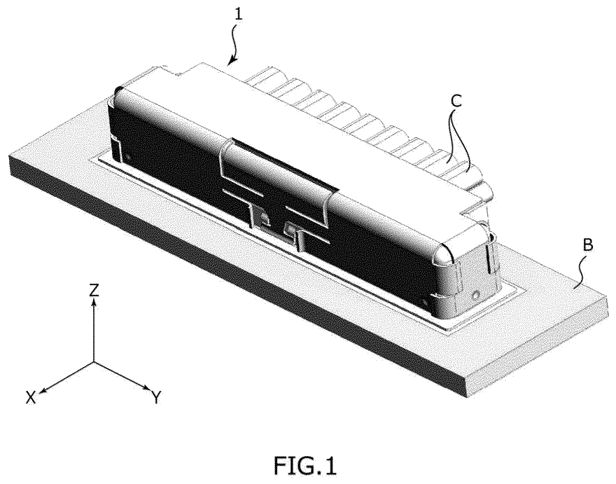

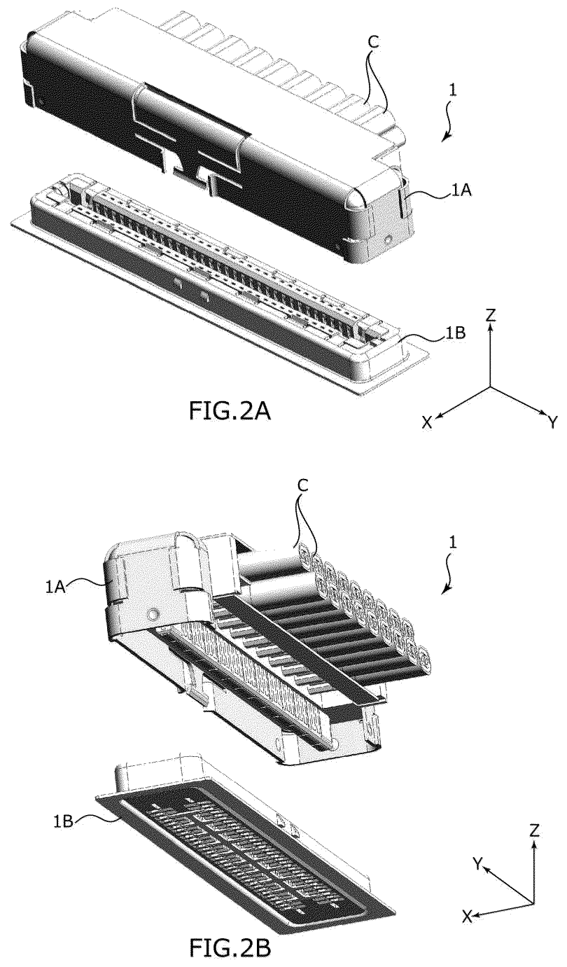

FIG. 1 illustrates the appearance of connector set 1 according to Embodiment 1 to which the present invention is applied. FIGS. 2A and 2B are exploded perspective views of connector set 1. In the present disclosure, the configuration of connector set 1 will be described using the orthogonal coordinate system (X, Y, Z). The orthogonal coordinate system (X, Y, Z) is commonly used in the drawings to be described later. The directions along the X-axis and the Y-axis are both parallel to the board surface of circuit board B, and the direction along the Z-axis is perpendicular to the board surface of circuit board B. Hereinafter, the directions along the X-axis, the Y-axis, and the Z-axis are referred to as the “X-axis direction,” the “Y-axis direction,” and the “Z-axis direction,” respectively. In addition, the positive side in the Z-axis direction is referred to as the upper side, and the negative side in the Z-axis direction is referred to as the lower side.

Connector set 1 is a vertical fitting type wire-to-board connector set, where the Y-axis direction is a pitch direction of connector set 1 and the Z-axis direction is a mating direction of connector set 1. Connector set 1 is used, for example, to interconnect circuit boards using cables C in an information device such as a server, a switch (network device), and storage.

As illustrated in FIGS. 1, 2A, and 2B, connector set 1 includes cable-side connector 1A and board-side connector 1B. Cable-side connector 1A is a connector to which cables C are connected, and board-side connector 1B is a connector to be mounted on circuit board B.

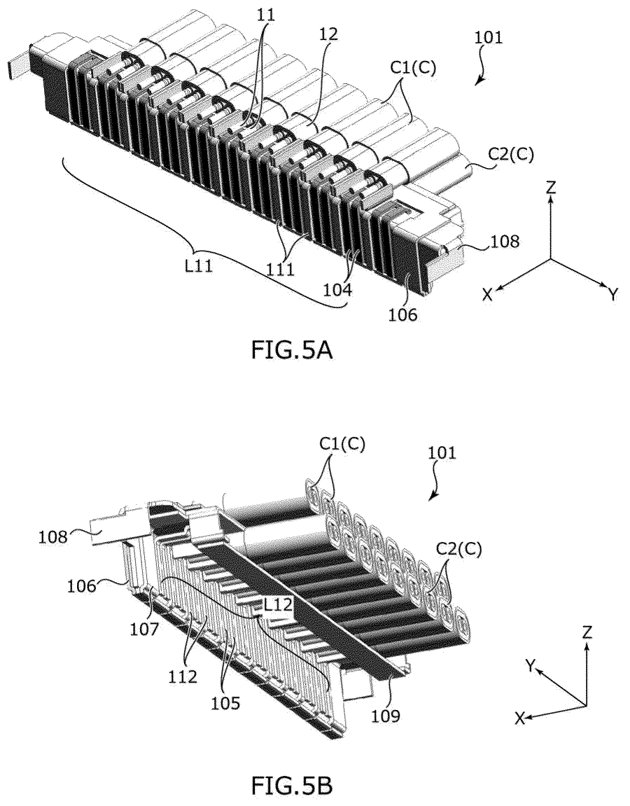

Each of cables C includes internal conductors 11 and external shield layer 12 placed outside internal conductors 11 via an insulator (whose reference sign is omitted) (see FIG. 5A, etc.). Internal conductors 11 of cable C are used, for example, for high-speed (high-frequency) signal transmission.

In the present embodiment, cable C is a Twinax cable in which two internal conductors 11 are collectively covered with an insulator, external shield layer 12, and a sheath (whose reference sign is omitted). In the present embodiment, 18 cables C are arranged along the Y-axis direction, 9 cables in the upper row and 9 cables in the lower row, and they are connected to cable-side connector 1A. That is, cables C include 9 first cables C1 in the upper row and 9 second cables C2 in the lower row.

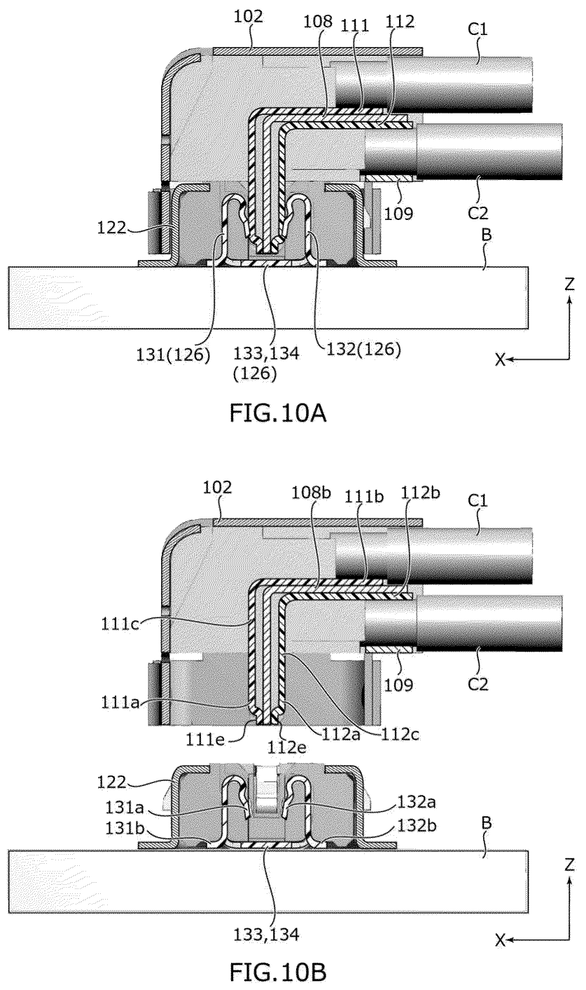

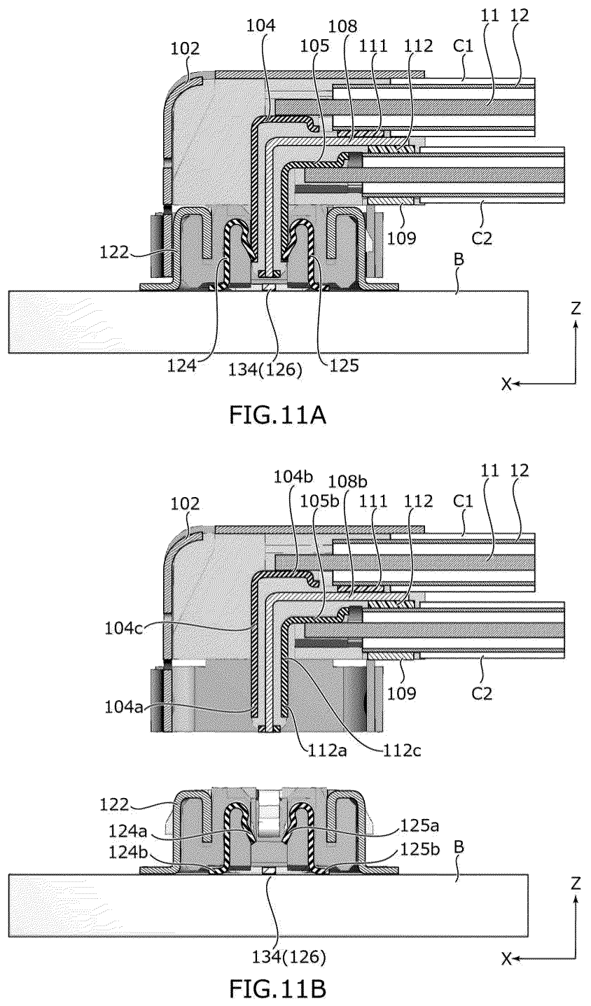

Connector set 1 electrically connects cables C and circuit board B by vertical fitting of cable-side connector 1A and board-side connector 1B. To be more specific, internal conductors 11 of cables C are electrically connected to the signal pattern of circuit board B via cable-side signal contacts 104 and 105 of cable-side connector 1A and board-side signal contacts 124 and 125 of board-side connector 1B (see FIG. 11A). In addition, external shield layers 12 of cables C are connected to the ground pattern of circuit board B via cable-side ground contacts 111 and 112 of cable-side connector 1A and board-side ground contacts 131 and 132 of board-side connector 1B (see FIG. 10A).

Specific configurations of cable-side connector 1A and board-side connector 1B will be described below.

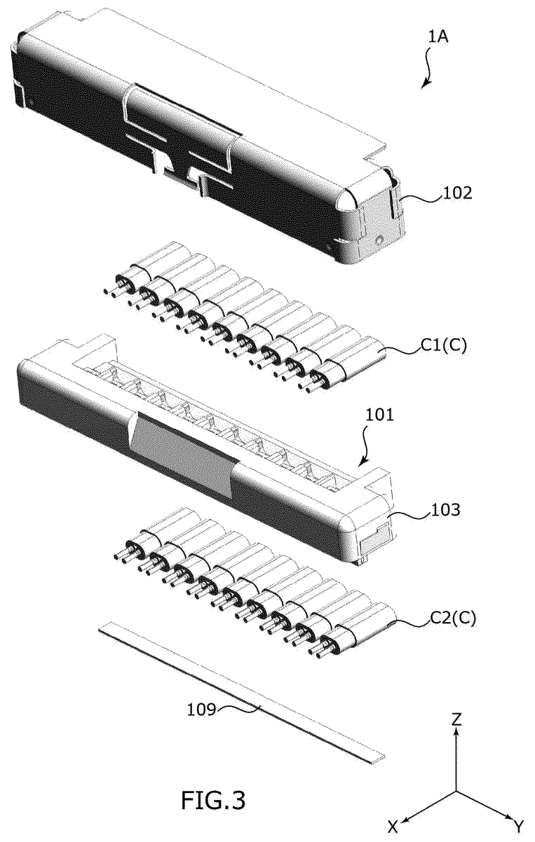

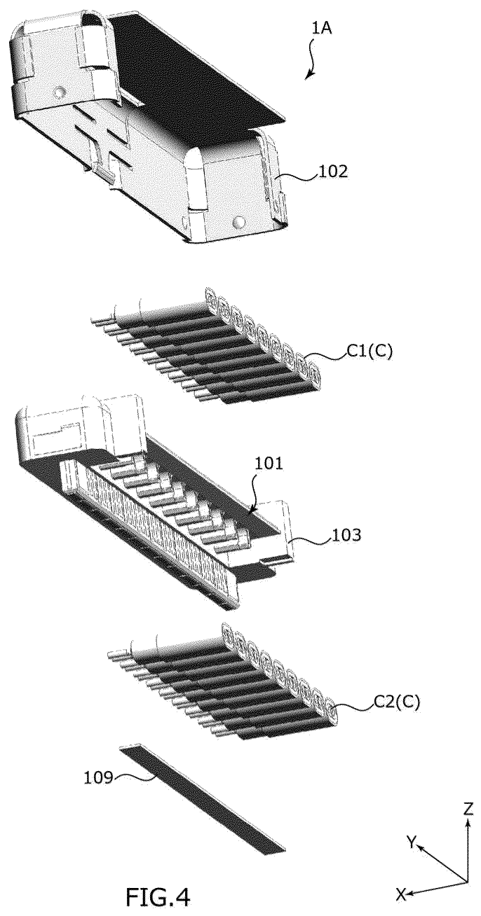

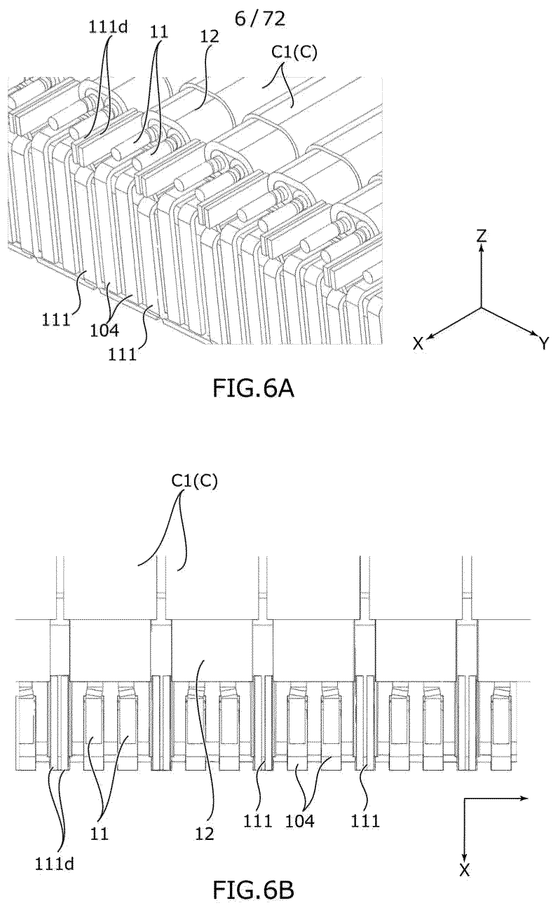

FIGS. 3 and 4 are exploded perspective views of cable-side connector 1A. FIGS. 5A and 5B are perspective views illustrating how cables C are attached to cable-side connector body 101. Cable-side insulator 103 is not illustrated in FIGS. 5A and 5B. FIGS. 6A and 6B are enlarged views illustrating how cables C are attached to cable-side connector body 101.

As illustrated in FIG. 3 and the like, cable-side connector 1A includes cable-side connector body 101 and cover shell 102. First cables C1 are attached to cable-side connector body 101 from above, and second cables C2 are attached to cable-side connector body 101 from below.

Cable-side connector body 101 includes cable-side insulator 103, first cable-side signal contacts 104, second cable-side signal contacts 105, first cable-side ground fitting 106, second cable-side ground fitting 107, ground plate 108, and the like.

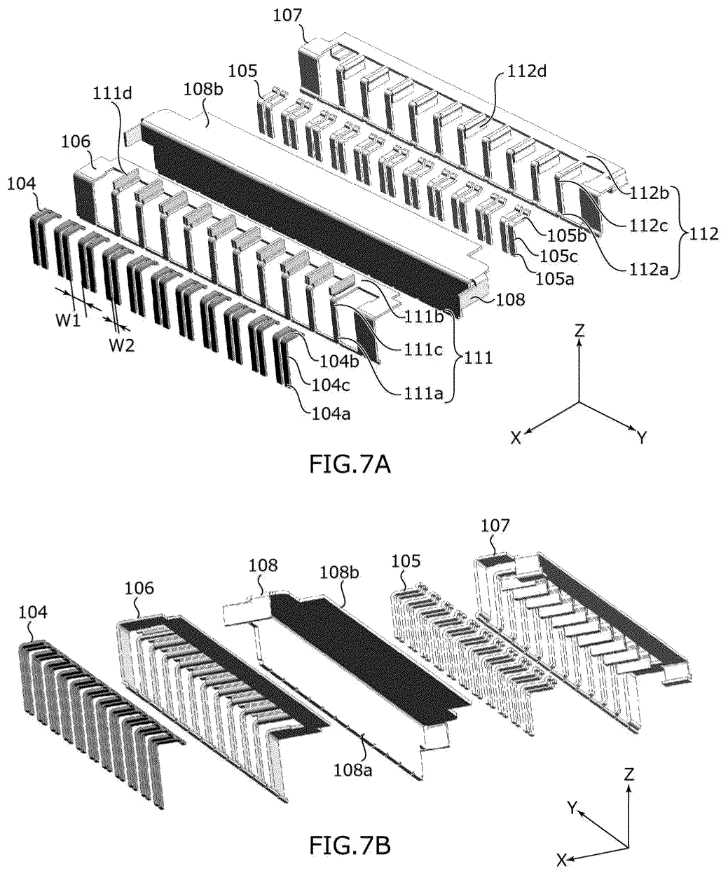

In the following, first cable-side signal contacts 104 and second cable-side signal contacts 105 are referred to as “cable-side signal contacts 104 and 105” unless they are distinguished from each other. Additionally, first cable-side ground fitting 106 and second cable-side ground fitting 107 are referred to as “cable-side ground fittings 106 and 107” unless they are distinguished from each other. FIGS. 7A and 7B illustrate disassembled cable-side signal contacts 104 and 105, cable-side ground fittings 106 and 107, and ground plate 108, which are assembled to cable-side insulator 103.

Cover shell 102, cable-side signal contacts 104 and 105, cable-side ground fittings 106 and 107, ground plate 108, and ground bar 109 are formed of a conductive material such as metal (e.g., copper alloy). Cable-side insulator 103 is formed of an insulating material such as a synthetic resin (e.g., liquid crystal polymer).

Cover shell 102 is placed to cover the outside of cable-side connector body 101 and is in contact with and electrically connected to cable-side ground fittings 106 and 107 and ground plate 108 of cable-side connector body 101. Cover shell 102 is at ground potential and functions as a shield. Like cable-side insulator 103, cover shell 102 may be formed of an insulating material such as a synthetic resin and form a housing of cable-side connector 1A.

Cable-side insulator 103 forms a housing of cable-side connector 1A. Cable-side signal contacts 104 and 105, cable-side ground fittings 106 and 107, and ground plate 108 are assembled to cable-side insulator 103. Cable-side signal contacts 104 and 105, cable-side ground fittings 106 and 107, and ground plate 108 are integrally formed with cable-side insulator 103 by, for example, insert molding. Cable-side signal contacts 104 and 105, cable-side ground fittings 106 and 107, and ground plate 108 are placed apart and electrically insulated from each other by cable-side insulator 103.

Ground plate 108 is a ground member connected to the ground, which is the reference potential, together with cable-side ground fittings 106 and 107. Ground plate 108 is formed by, for example, sheet metal working (including punching and bending) of a single metal sheet. Ground plate 108 includes first plate portion 108a and second plate portion 108b. First plate portion 108a has a planar shape extending along the YZ plane. Second plate portion 108b has a planar shape extending along the XY plane.

Cable-side signal contacts 104 and 105 are members connected to internal conductors 11 of cables C. To be more specific, first cable-side signal contacts 104 are connected to internal conductors 11 of first cables C1 placed in the upper row. Second cable-side signal contacts 105 are connected to internal conductors 11 of second cables C2 placed in the lower row. Cable-side signal contacts 104 and 105 are each formed by, for example, sheet metal working (including punching and bending) of a single metal sheet.

Cable-side signal contacts 104 and 105 have similar configurations and include signal line contact sections 104a and 105a, signal line connection sections 104b and 105b, and signal line relay sections 104c and 105c, respectively. Signal line relay sections 104c and 105c connect signal line contact sections 104a and 105a and signal line connection sections 104b and 105b.

Signal line contact sections 104a and 105a contact and electrically connect to signal line contact sections 124a and 125a of board-side connector 1B when cable-side connector 1A and board-side connector 1B are mated with each other (see FIGS. 11A and 11B). Internal conductors 11 of cables C exposed by stripping processing on the tips are connected to signal line connection sections 104b and 105b by a mechanical joining method such as soldering, welding, crimping, or the like.

Cable-side signal contacts 104 and 105 have an L-shaped cross section in which signal line relay sections 104c and 105c extend from signal line contact sections 104a and 105a to the positive side in the Z-axis direction (mating direction), bend by 90 degrees toward the negative side in the X-axis direction (pull-out direction of cables C), and reach signal line connection sections 104b and 105b.

Cable-side signal contacts 104 and 105 are each in pairs connected to the same cable C, and are aligned in the Y-axis direction, which is the pitch direction. First cable-side signal contacts 104 form first cable-side contact row L11 together with first cable-side ground contacts 111, which will be described later. Second cable-side signal contacts 105 form second cable-side contact row L12 together with second cable-side ground contacts 112, which will be described later.

Distance W1 between cable-side signal contacts 104 connected to adjacent cables C in the Y-axis direction is wider than distance W2 between cable-side signal contacts 104 connected to the same cable C (see FIG. 7A). The same applies to cable-side signal contacts 105. Hereinafter, cable-side signal contacts 104 or 105 which are connected to adjacent cables C in the Y-axis direction and which are adjacent to each other are simply referred to as “adjacent cable-side signal contacts 104 or 105.”

First cable-side signal contacts 104 are arranged so that the main surfaces (plate surfaces) are along one surface (first main surface) of ground plate 108. Signal line contact sections 104a of first cable-side signal contacts 104 are located on the positive side in the X-axis direction of first plate portion 108a of ground plate 108, and signal line connection sections 104b are located on the positive side (upper side) in the Z-axis direction of second plate portion 108b of ground plate 108.

Second cable-side signal contacts 105 are arranged so that the main surfaces (plate surfaces) are along the other surface (second main surface) of ground plate 108. Signal line contact sections 105a of second cable-side signal contacts 105 are located on the negative side in the X-axis direction of first plate portion 108a of ground plate 108, and signal line connection sections 105b are located on the negative side (lower side) in the Z-axis direction of second plate portion 108b of ground plate 108.

The first main surface of first plate portion 108a of ground plate 108 faces first cable-side signal contacts 104. The second main surface of first plate portion 108a of ground plate 108 faces second cable-side signal contacts 105. That is, planar grounds formed by ground plate 108 are placed for a plurality of cable-side signal contacts 104 and 105 aligned in the Y-axis direction.

Thus, ground plate 108 extends to shield between signal line connection sections 104b of first cable-side signal contacts 104 and signal line connection sections 105b of second cable-side signal contacts 105. Ground plate 108 also extends to shield between signal line relay sections 104c of first cable-side signal contacts 104 and signal line relay sections 105c of second cable-side signal contacts 105 over the entire length of signal line relay sections 104c and 105c. Further, ground plate 108 extends to shield between signal line contact sections 104a of first cable-side signal contacts 104 and signal line contact sections 105a of second cable-side signal contacts 105.

First cable-side signal contacts 104 and second cable-side signal contacts 105 have a symmetrical structure with respect to ground plate 108. The symmetrical structure is a structure securing electrical equivalency with respect to ground plate 108. To be more specific, first cable-side signal contacts 104 and second cable-side signal contacts 105 have the same shape in a cross-section taken perpendicular to the extending direction, and the distances from each of signal line contact sections 104a, signal line relay sections 104c, and signal line connection sections 104b of first cable-side signal contacts 104 to ground plate 108 are respectively the same as the distances from each of signal line contact sections 105a, signal line relay sections 105c, and signal line connection sections 105b of second cable-side signal contacts 105 to ground plate 108.

Cable-side ground fittings 106 and 107 are ground members connected to the ground, which is the reference potential. To be more specific, first cable-side ground fitting 106 is connected to external shield layers 12 of first cables C1 placed in the upper row. Second cable-side ground fitting 107 is connected to external shield layers 12 of second cables C2 placed in the lower row. Cable-side ground fittings 106 and 107 are each formed by sheet metal working (including punching and bending) of a single metal sheet. Cable-side ground fittings 106 and 107 have substantially similar configurations.

First cable-side ground fitting 106 includes a plurality of first cable-side ground contacts 111 each disposed between adjacent first cable-side signal contacts 104. Second cable-side ground fitting 107 includes a plurality of second cable-side ground contacts 112 each disposed between adjacent second cable-side signal contacts 105. In the following, first cable-side ground contacts 111 and second cable-side ground contacts 112 are referred to as “cable-side ground contacts 111 and 112” unless they are distinguished from each other.

Cable-side ground contacts 111 and 112 have ground contact sections 111a and 112a, ground connection sections 111b and 112b, and ground relay sections 111c and 112c, respectively. Ground relay sections 111c and 112c connect ground contact sections 111a and 112a and ground connection sections 111b and 112b.

Cable-side ground contacts 111 and 112 have an L-shaped cross section in which ground relay sections 111c and 112c extend from ground contact sections 111a and 112a to the positive side in the Z-axis direction, bend by 90 degrees toward the negative side in the X-axis direction, and reach ground connection sections 111b and 112b. The shapes of cable-side ground contacts 111 and 112 are substantially the same as the shapes of cable-side signal contacts 104 and 105.

Cable-side ground contacts 111 and 112 are aligned in the Y-axis direction, which is the pitch direction. Cable-side ground contacts 111 and 112 are each disposed between adjacent cable-side signal contacts 104 and 105.

Ground contact sections 111a of first cable-side ground contacts 111 are each disposed between signal line contact sections 104a of adjacent first cable-side signal contacts 104 and shield between signal line contact sections 104a. In addition, on the negative side in the Z-axis direction, end sections 111e of ground contact sections 111a of the plurality of first cable-side ground contacts 111 are connected to each other, so that the ground is equipotentialized. In the XZ cross section, end sections 111e each have a tapered portion that approaches ground plate 108 toward the negative side in the Z-axis direction and a flat surface portion that contacts ground plate 108.

Likewise, ground contact sections 112a of second cable-side ground contacts 112 are each disposed between signal line contact sections 105a of adjacent second cable-side signal contacts 105 and shield between signal line contact sections 105a. In addition, on the negative side in the Z-axis direction, end sections 112e of ground contact sections 112a of the plurality of second cable-side ground contacts 112 are connected to each other, so that the ground is equipotentialized. In the XZ cross section, end sections 112e each have a tapered portion that approaches ground plate 108 toward the negative side in the Z-axis direction and a flat surface portion that contacts ground plate 108.

Ground contact sections 111a and 112a contact and electrically connect to board-side ground contacts 131 and 132 of board-side connector 1B when cable-side connector 1A and board-side connector 1B are mated with each other (see FIGS. 10A and 10B).

Ground connection sections 111b of the plurality of first cable-side ground contacts 111 are connected in the Y-axis direction and have a flat plate shape. External shield layers 12 of first cables C1 are connected to the upper surfaces of ground connection sections 111b by a mechanical joining method such as soldering, welding, crimping, or the like. The lower surfaces of ground connection sections 111b are in contact with and electrically connected to the upper surface of second plate portion 108b of ground plate 108.

Likewise, ground connection sections 112b of the plurality of second cable-side ground contacts 112 are connected in the Y-axis direction and have a flat plate shape. Ground connection sections 112b collectively hold external shield layers 12 of second cables C2 together with ground bar 109 from the positive and negative sides in the Z-axis direction, and are connected by a mechanical bonding method such as soldering, welding, crimping, or the like. The upper surfaces of ground connection sections 112b are in contact with and electrically connected to the lower surface of second plate portion 108b of ground plate 108.

First cable-side ground fitting 106 is placed so that the main surface (plate surface) is along one surface of ground plate 108. In first cable-side ground fitting 106, ground contact sections 111a are located on the positive side in the X-axis direction of first plate portion 108a of ground plate 108, and ground connection sections 111b are located on the positive side (upper side) in the Z-axis direction of second plate portion 108b of ground plate 108.

Second cable-side ground fitting 107 is placed so that the main surface (plate surface) is along the other surface of ground plate 108. In second cable-side ground fitting 107, ground contact sections 112a are located on the negative side in the X-axis direction of first plate portion 108a of ground plate 108, and ground connection sections 112b are located on the negative side (lower side) in the Z-axis direction of second plate portion 108b of ground plate 108.

Signal line contact sections 104a and 105a of cable-side signal contacts 104 and 105 and ground contact sections 111a and 112a of cable-side ground contacts 111 and 112 are exposed from the surface of a fitting portion of cable-side insulator 103. Signal line connection sections 104b and 105b of cable-side signal contacts 104 and 105 and ground connection sections 111b and 112b of cable-side ground contacts 111 and 112 are exposed from the surface of a cable placement portion of cable-side insulator 103.

Cable-side signal contacts 104 and cable-side ground contacts 111 are placed so that the portions extending in the Z-axis direction are flush with each other. In addition, cable-side signal contacts 105 and cable-side ground contacts 112 are placed so that the portions extending in the Z-axis direction are flush with each other. A similar design (e.g., spring characteristics) can be applied in spring pieces forming signal line contact sections 124a and 125a and spring pieces forming ground contact sections 131a and 132a in board-side connector 1B.

The portion extending in the X-axis direction of ground relay section 111c of first cable-side ground contact 111 is provided with interconnection shielding sections 111d including two flat-plane shielding plates, which stand upright from both ends in the Y-axis direction to the positive side in the Z-axis direction and extend along the XZ plane. Interconnection shielding sections 111d are located between signal line connection sections 104b of two adjacent first cable-side signal contacts 104 among first cable-side signal contacts 104 connected to adjacent first cables C1, and are perpendicular to the facing direction of two signal line connection sections 104b. Further, the distance from one of the two shielding plates of interconnection shielding sections 111d to nearby first cable-side signal contact 104, and the distance from the other one of the shielding plates to nearby first cable-side signal contact 104 are the same. That is, two signal line connection sections 104b adjacent to interconnection shielding sections 111d are in a plane symmetrical arrangement with respect to the XZ plane passing through the midpoint between the shielding plates of two interconnection shielding sections 111d.

Likewise, the portion extending in the X-axis direction of ground relay section 112c of second cable-side ground contact 112 is provided with interconnection shielding sections 112d including two flat-plane shielding plates, which extend downward from both ends in the Y-axis direction to the negative side in the Z-axis direction and extend along the XZ plane. Interconnection shielding sections 112d are located between signal line connection sections 105b of two adjacent second cable-side signal contacts 105 among second cable-side signal contacts 105 connected to adjacent second cables C2, and are perpendicular to the facing direction of two signal line connection sections 105b. Further, the distance from one of the two shielding plates of interconnection shielding sections 112d to nearby second cable-side signal contact 105, and the distance from the other one of the shielding plates to nearby second cable-side signal contact 105 are the same. That is, two signal line connection sections 105b adjacent to interconnection shielding sections 112d are in a plane symmetrical arrangement with respect to the XZ plane passing through the midpoint between the shielding plates of two interconnection shielding sections 112d.

In cable-side connector 1A, ground contact sections 111a, which are at ground potential, are each disposed between signal line contact sections 104a of two adjacent cable-side signal contacts 104, and shield between signal line contact sections 104a. Likewise, ground contact sections 112a, which are at ground potential, are each disposed between signal line contact sections 105a of two adjacent cable-side signal contacts 105, and shield between signal line contact sections 105a.

Interconnection shielding sections 111d of first cable-side ground contacts 111 are each placed three-dimensionally so as to extend onto the XZ plane between signal line connection sections 104b of two adjacent cable-side signal contacts 104, and shield between signal line connection sections 104b. Likewise, interconnection shielding sections 112d of second cable-side ground contacts 112 are each placed three-dimensionally so as to extend onto the XZ plane between signal line connection sections 105b of two adjacent cable-side signal contacts 105, and shield between signal line connection sections 105b.

With interconnection shielding sections 111d and 112d, it is possible to improve EMS characteristics (e.g., characteristic impedance, insertion loss, return loss, crosstalk, etc.) in transmission lines, and to ensure favorable transmission quality. Further, two each of interconnection shielding sections 111d and 112d are provided and they have an even ground structure with respect to cable-side signal contacts 104 and 105, so that the transmission quality in two signal transmission lines is stabilized. To be more specific, since interconnection shielding sections 111d and 112d are formed at both ends in the Y-axis direction (width direction) by bending processing, the distance to cable-side signal contacts 104 and 105 can be easily adjusted by a setting of the bending position, and impedance control is also facilitated.

Ground plate 108 is in surface contact, at least in part, with cable-side ground contacts 111 and 112. To be more specific, first plate portion 108a of ground plate 108 is interposed between end sections 111e and 112e of cable-side ground contacts 111 and 112 at the lower end and they are in surface contact with each other. In addition, second plate portion 108b of ground plate 108 is interposed between ground connection sections 111b and 112b of cable-side ground contacts 111 and 112 and they are in surface contact with each other.

In the present embodiment, the portions extending in the Z-axis direction of cable-side signal contacts 104 and 105 and cable-side ground contacts 111 and 112 are flush with each other in order to facilitate the designing of spring pieces in board-side connector 1B; accordingly, gaps are formed between ground plate 108 and cable-side ground contacts 111 and 112. In terms of ground reinforcement, ground plate 108 and cable-side ground contacts 111 and 112 may be made in contact with each other over as much of the entire surface as possible without gaps.

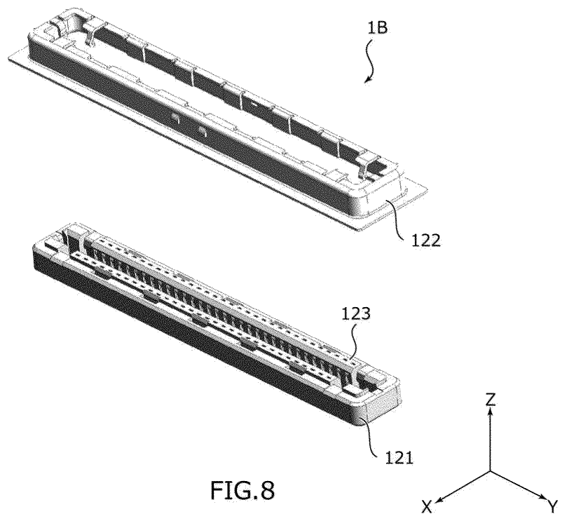

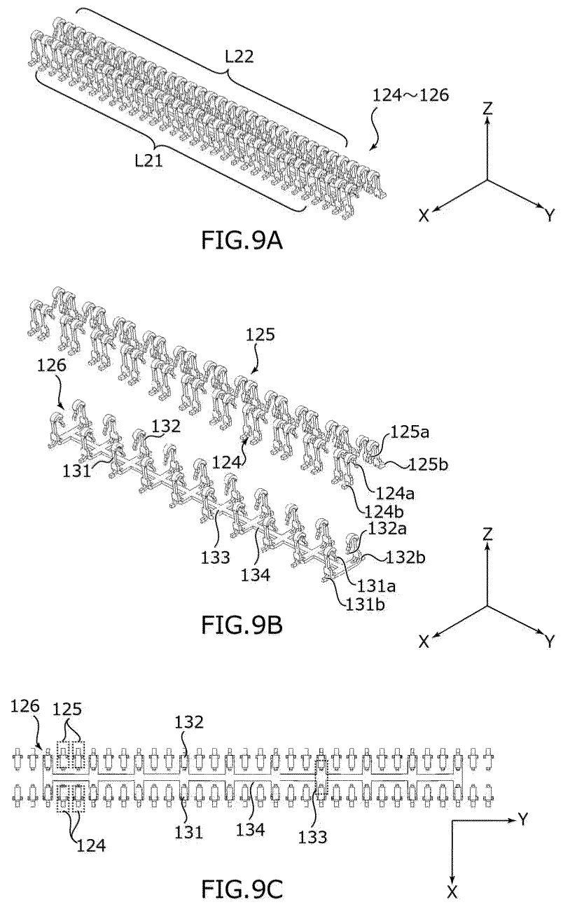

FIG. 8 is an exploded perspective view of board-side connector 1B to be mated with cable-side connector 1A, viewed from the positive side (hereinafter, sometimes referred to as the “fitting side”) in the Z-axis direction. FIGS. 9A to 9C illustrate a contact structure in board-side connector body 121.

As illustrated in FIG. 8 and FIGS. 9A to 9C, board-side connector 1B includes board-side connector body 121 and board-side shell 122. Board-side connector body 121 includes board-side insulator 123, first board-side signal contacts 124, second board-side signal contacts 125, and board-side ground fitting 126 (see FIGS. 9A to 9C).

In the following, first board-side signal contacts 124 and second board-side signal contacts 125 are referred to as “board-side signal contacts 124 and 125” unless they are distinguished from each other. FIG. 9B illustrates disassembled board-side signal contacts 124 and 125 and board-side ground fitting 126, which are assembled to board-side insulator 123.

Board-side shell 122, board-side signal contacts 124 and 125, and board-side ground fitting 126 are formed of a conductive material such as metal (e.g., copper alloy). Board-side insulator 123 is formed of an insulating material such as a synthetic resin (e.g., liquid crystal polymer).

Board-side shell 122 is a frame connected to the ground pattern of circuit board B and has a rectangular shape corresponding to the outer edge of board-side insulator 123 in plan view from the Z-axis direction. Board-side shell 122 is formed by, for example, drawing a metal sheet. Board-side shell 122 is placed to cover the outside of board-side connector body 121 and is in contact with and electrically connected to board-side ground fitting 126 of board-side connector body 121. Board-side shell 122 is at ground potential and functions as a shield. Board-side shell 122 is fitted to, for example, a peripheral portion of board-side insulator 123.

Board-side insulator 123 has a rectangular shape in plan view from the Z-axis direction and forms a housing of board-side connector 1B. Board-side signal contacts 124 and 125 and board-side ground fitting 126 are assembled to board-side insulator 123. Board-side signal contacts 124 and 125 and board-side ground fitting 126 are integrally formed with board-side insulator 123 by, for example, insert molding. Board-side signal contacts 124 and 125 and board-side ground fitting 126 are placed apart and electrically insulated from each other by board-side insulator 123.

Board-side signal contacts 124 and 125 are members respectively connected to cable-side signal contacts 104 and 105 of cable-side connector 1A. Board-side signal contacts 124 and 125 are formed by, for example, sheet metal working (including punching and bending) of a single metal sheet. Board-side signal contacts 124 and 125 are each in pairs, respectively corresponding to cable-side signal contacts 104 and 105, and are aligned in the Y-axis direction, which is the pitch direction. First board-side signal contacts 124 form first board-side contact row L21 together with first board-side ground contacts 131, which will be described later. Second board-side signal contacts 125 form second board-side contact row L22 together with second board-side ground contacts 132, which will be described later.

Board-side signal contacts 124 and 125 have similar configurations, with signal line contact sections 124a and 125a and signal line surface-mounted sections 124b and 125b, respectively. To be more specific, signal line contact sections 124a and 125a are each formed so as to be curved inward in a U-shape viewed from the Y-axis direction, and have at the tips being free ends a spring piece (whose reference sign is omitted) that exerts biasing force against the facing surface (signal line contact sections 104a and 105a of cable-side connector 1A).

Signal line contact sections 124a and 125a contact and electrically connect to signal line contact sections 104a and 105a of cable-side connector 1A when cable-side connector 1A and board-side connector 1B are mated with each other (see FIGS. 11A and 11B). Signal line surface-mounted sections 124b and 125b are connected to the signal pattern of circuit board B by soldering, for example.

Board-side ground fitting 126 includes a plurality of board-side ground contacts 131 and 132 to be respectively connected to cable-side ground contacts 111 and 112 of cable-side connector 1A. Board-side ground contacts 131 and 132 respectively include ground contact sections 131a and 132a and ground surface-mounted sections 131b and 132b.

Board-side ground contacts 131 and 132 have shapes similar to those of board-side signal contacts 124 and 125 respectively. To be more specific, ground contact sections 131a and 132a are each formed so as to be curved inward in a U-shape viewed from the Y-axis direction, and have at the tips being free ends a spring piece (whose reference sign is omitted) that exerts biasing force against the facing surface (ground contact sections 111a and 112a of cable-side connector 1A). Board-side ground fitting 126 supports cable-side ground contacts 111 and 112 and ground plate 108 integrally by the spring force of the spring pieces.

Ground contact sections 131a and 132a contact and electrically connect to ground contact sections 111a and 112a of cable-side connector 1A when cable-side connector 1A and board-side connector 1B are mated with each other (see FIGS. 10A and 10B). Ground surface-mounted sections 131b and 132b are connected to the signal pattern of circuit board B by soldering, for example.

In board-side ground fitting 126, a pair of board-side ground contacts 131 and 132 facing in the X-axis direction are coupled by pair coupling section 133 extending in the X-axis direction, and are electrically and mechanically connected. In addition, a plurality of first board-side ground contacts 131 and a plurality of second board-side ground contacts 132 placed in the Y-axis direction are connected by pin coupling sections 134 extending in the Y-axis direction, and are electrically and mechanically connected. Pair coupling sections 133 and pin coupling section 134 have a flat plate shape, and the main surfaces are perpendicular to the mating direction. Pair coupling sections 133 and pin coupling sections 134 are connected to the ground pattern of circuit board B by soldering, for example, and function as the surface-mounted sections of board-side ground fitting 126. By providing pair coupling sections 133 and pin coupling sections 134, the area of the ground element is increased, and the ground is equipotentialized.

Note that, although board-side ground contacts 131 and 132 are connected by pair coupling sections 133 and pin coupling sections 134 in Embodiment 1, they may be separated from each other. That is, pin coupling section 134 only needs to be provided to couple at least two adjacent first board-side ground contacts 131 or two adjacent second board-side ground contacts 132.

For example, although all of first board-side ground contacts 131 and second board-side ground contacts 132 are formed in single board-side ground fitting 126 in the present embodiment, a plurality of board-side ground fittings 126 in which some first board-side ground contacts 131 and second board-side ground contacts 132 are formed may be placed along the Y-axis direction.

In addition, two separate board-side ground fittings 126 may be provided; one with a plurality of first board-side ground contacts 131 coupled by pin coupling sections 134, and the other with a plurality of second board-side ground contacts 132 coupled by pin coupling sections 134. That is, board-side ground fitting 126 need not include pair coupling sections 133.

Further, a plurality of board-side ground fittings 126 in which facing pairs of first board-side ground contact 131 and second board-side ground contact 132 are coupled by pair coupling sections 133 may be placed along the Y-axis direction. That is, board-side ground fitting 126 need not include pin coupling sections 134.

FIGS. 10A and 10B are sectional views illustrating the connection of grounds in connector set 1, and illustrate XZ sections between adjacent cables C in the Y-axis direction (pitch direction). FIG. 10A illustrates a state after cable-side connector 1A and board-side connector 1B are fitted, and FIG. 10B illustrates a state before cable-side connector 1A and board-side connector 1B are fitted.

FIGS. 11A and 11B are sectional views illustrating the connection of signal lines in connector set 1, and illustrate XZ sections through internal conductors 11 of cables C. FIG. 11A illustrates a state after cable-side connector 1A and board-side connector 1B are fitted, and FIG. 11B illustrates a state before cable-side connector 1A and board-side connector 1B are fitted.

As illustrated in FIGS. 10A and 10B, ground contact sections 111a and 112a of cable-side ground contacts 111 and 112 are fitted and electrically connected to ground contact sections 131a and 132a of board-side ground contacts 131 and 132.

In cable-side connector 1A, ground plate 108 is mechanically connected and integrated with cable-side ground contacts 111 and 112. Accordingly, board-side ground contacts 131 and 132 of board-side ground fitting 126 are electrically connected to ground plate 108 via cable-side ground contacts 111 and 112.

Further, as illustrated in FIGS. 11A and 11B, when cable-side connector 1A and board-side connector 1B are fitted, signal line contact sections 104a and 105a of cable-side signal contacts 104 and 105 are fitted and electrically connected to signal line contact sections 124a and 125a of board-side signal contacts 124 and 125.

Connector set 1 according to Embodiment 1 includes the following features alone or in combination as appropriate.

That is, connector set 1 includes board-side connector 1B (first connector) and counterpart cable-side connector 1A (second connector) that can be mated with board-side connector 1B. Board-side connector 1B includes board-side signal contacts 124 and 125 connected to signal lines and board-side ground contacts 131 and 132 connected to the ground. Board-side ground contacts 131 and 132 include a plurality of first board-side ground contacts 131 aligned in first board-side contact row L21 (first contact row) along the pitch direction, and first board-side ground contacts 131 are electrically and mechanically connected by pin coupling sections 134.

Board-side connector 1B (first connector) includes board-side ground fitting 126, which is a single member formed with a plurality of first board-side ground contacts 131 and pin coupling sections 134.

Pin coupling sections 134 have a flat plate shape, and the main surfaces are perpendicular to the mating direction.

The same can be applied to cable-side connector 1A. That is, in cable-side connector 1A (first connector), a plurality of first cable-side ground contacts 111 aligned in first cable-side contact row L11 (first contact row) along the pitch direction are electrically and mechanically connected by pin coupling sections. The coupling sections of ground connection sections 111b and the coupling sections of end sections 111e correspond to the pin coupling sections.

Cable-side connector 1A (first connector) includes cable-side ground fitting 106, which is a single member formed with a plurality of first cable-side ground contacts 111 and the pin coupling sections.

The main surfaces of the pin coupling sections, which are formed of the coupling sections of ground connection sections 111b, are perpendicular to the mating direction.

Board-side ground contacts 131 and 132 include a plurality of second board-side ground contacts 132 aligned in second board-side contact row L22 (second contact row) along the pitch direction, and first board-side ground contacts 131 and second board-side ground contacts 132 are electrically and mechanically connected to each other by pair coupling sections 133.

Board-side connector 1B (first connector) includes board-side ground fitting 126, which is a single member formed with first board-side ground contacts 131, second board-side ground contacts 132, and pair coupling sections 133.

Pair coupling sections 133 have a flat plate shape, and the main surfaces are perpendicular to the mating direction.

Cable-side connector 1A (second connector) includes cable-side signal contacts 104 and 105 (counterpart signal contacts) connected to board-side signal contacts 124 and 125, cable-side ground contacts 111 and 112 (counterpart ground contacts) connected to board-side ground contacts 131 and 132, and flat ground plate 108 connected to the ground. Cable-side signal contacts 104 and 105 include a plurality of first cable-side signal contacts 104 (first counterpart signal contacts) aligned in first cable-side contact row L11 (first counterpart contact row) along the pitch direction and connected to first board-side signal contacts 124, and the first main surface of ground plate 108 faces the plurality of first cable-side signal contacts 104.

Cable-side signal contacts 104 and 105 (counterpart signal contacts) include a plurality of second cable-side contacts 105 aligned in second cable-side signal contact row L12 (second counterpart contact row) along the pitch direction, and the second main surface of ground plate 108 faces second cable-side signal contacts 105.

Ground plate 108 is in surface contact, at least in part, with first cable-side ground contacts 111 and second cable-side ground contacts 112.

Board-side connector 1B (first connector) includes board-side ground fitting 126, which is a single member formed with first board-side ground contacts 131 and second board-side ground contacts 132. Ground plate 108 is mechanically connected and integrated with first cable-side ground contacts 111 and second cable-side ground contacts 112. Board-side ground fitting 126 makes contact with first cable-side ground contacts 111 and second cable-side ground contacts 112 and is electrically connected to ground plate 108 via first cable-side ground contacts 111 and/or second cable-side ground contacts 112.

Board-side ground fitting 126 supports first cable-side ground contacts 111, second cable-side ground contacts 112, and ground plate 108 integrally by the spring force.

First cable-side signal contacts 104 and second cable-side signal contacts 105 respectively include signal line connection sections 104b and 105b connected to signal lines, signal line contact sections 104a and 105a connected to board-side signal contacts 124 and 125, and signal line relay sections 104c and 105c connecting signal line connection sections 104b and 105b and signal line contact sections 104a and 105a. Ground plate 108 extends to shield at least between signal line connection sections 104b of first cable-side signal contacts 104 and signal line connection sections 105b of second cable-side signal contacts 105.

Ground plate 108 extends to shield between signal line relay sections 104c of first cable-side signal contacts 104 and signal line relay sections 105c of second cable-side signal contacts 105 over the entire length of signal line relay sections 104c and 105c.

Ground plate 108 extends to shield between signal line contact sections 104a of first cable-side signal contacts 104 and signal line contact sections 105a of second cable-side signal contacts 105.

Cable-side connector 1A (second connector) includes cable-side signal contacts 104 and 105 connected to board-side signal contacts 124 and 125, cable-side ground contacts 111 and 112 connected to board-side ground contacts 131 and 132, and flat ground plate 108 connected to the ground. Cable-side signal contacts 104 and 105 include a plurality of first cable-side signal contacts 104 aligned in first cable-side contact row L11 (first counterpart contact row) along the pitch direction and connected to first board-side signal contacts 124, and a plurality of second cable-side contacts 105 aligned in second cable-side signal contact row L12 (second counterpart contact row) along the pitch direction and connected to second board-side signal contacts 125. Ground plate 108 is disposed between first cable-side contact row L11 and second cable-side contact row L12. First cable-side signal contacts 104 and second cable-side signal contacts 105 have a symmetrical structure with respect to ground plate 108.

First cable-side signal contacts 104 and second cable-side signal contacts 105 have the same shape in a cross-section taken perpendicular to the extending direction, and the distances from each of signal line contact sections 104a, signal line relay sections 104c, and signal line connection sections 104b of first cable-side signal contacts 104 to ground plate 108 are respectively the same as the distances from each of signal line contact sections 105a, signal line relay sections 105c, and signal line connection sections 105b of second cable-side signal contacts 105 to ground plate 108.

Cable-side connector 1A (second connector) is a wire-to-board cable-side connector connected to a plurality of cables C (coaxial cables) used for high-frequency signal transmission. The plurality of cables C include first cables C1 connected to first cable-side signal contacts 104 and second cables C2 connected to second cable-side signal contacts 105. First cables C1 and second cables C2 are pulled out in a direction perpendicular to the mating direction and stacked in the mating direction. Ground plate 108 is bent in an L-shape and extends in the mating direction and the pull-out direction of cables C.

Connector set 1 has the above-described features, which remarkably reinforces the ground structure. In addition, it is possible to improve EMS characteristics (e.g., characteristic impedance, insertion loss, return loss, crosstalk, etc.) in transmission lines, and to ensure favorable transmission quality. Further, a plurality of cables C can be connected to circuit board B collectively. Thus, it is possible to meet a requirement for wiring in an information device such as a server, and more particularly to enhance a high-speed transmission characteristic. It is also possible to improve the connection workability of cables C and reduce the size of the connector.

### Variation

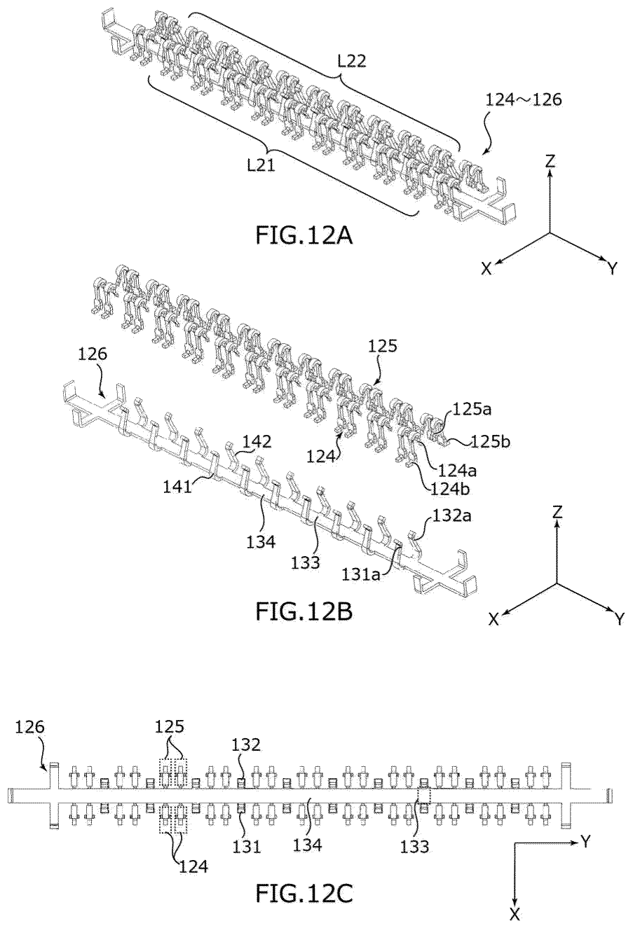

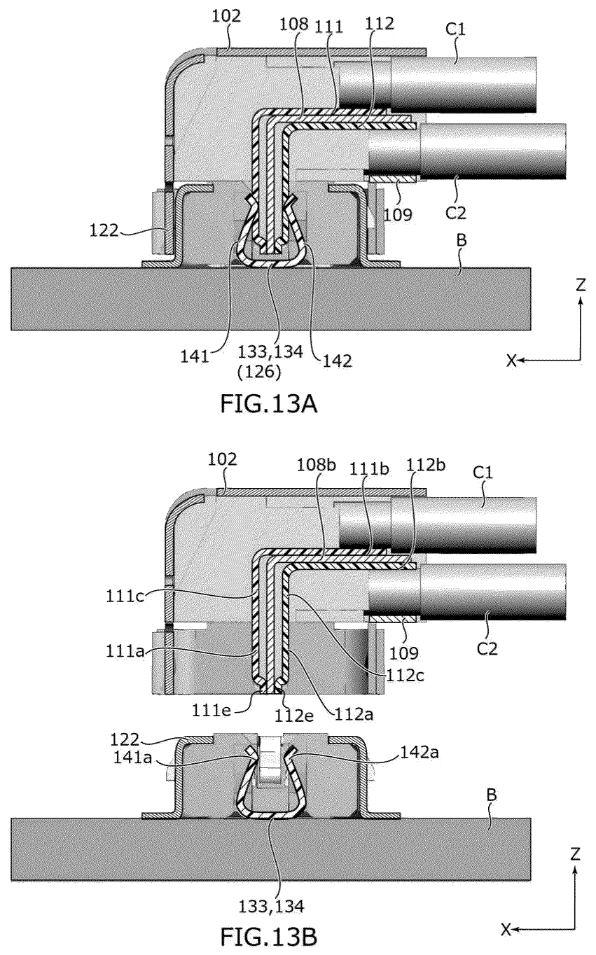

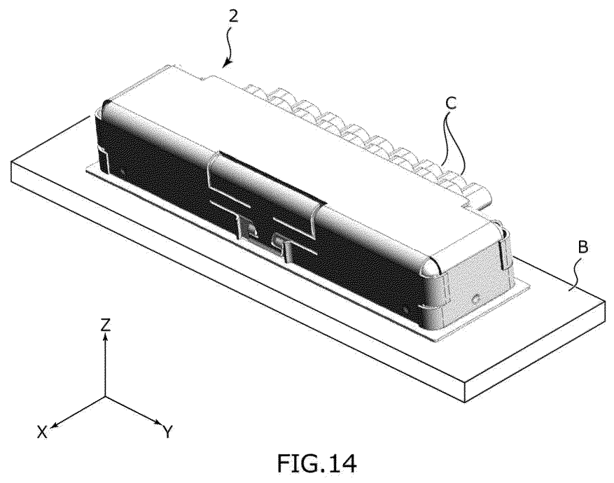

Board-side connector 1B may have the following configuration, for example. FIGS. 12A to 12C illustrate a contact structure in board-side connector body 121 according to the variation. FIGS. 13A and 13B are sectional views illustrating the connection of grounds in connector set 1 according to the variation, and illustrate XZ sections between adjacent cables C in the Y-axis direction (pitch direction). FIG. 13A illustrates a state after cable-side connector 1A and board-side connector 1B are fitted, and FIG. 13B illustrates a state before cable-side connector 1A and board-side connector 1B are fitted.

In the variation, the shapes of board-side ground contacts 141 and 142 are different from those in Embodiment 1. That is, board-side ground contacts 141 and 142 of the variation are each formed so as to be curved outward in a U-shape viewed from the Y-axis direction, and have at the tips being free ends a spring piece that exerts biasing force against the facing surface.

As illustrated in FIGS. 13A and 13B, ground contact sections 111a and 112a of cable-side ground contacts 111 and 112 are fitted and electrically connected to ground contact sections 141a and 142a of board-side ground contacts 141 and 142.

### Embodiment 2

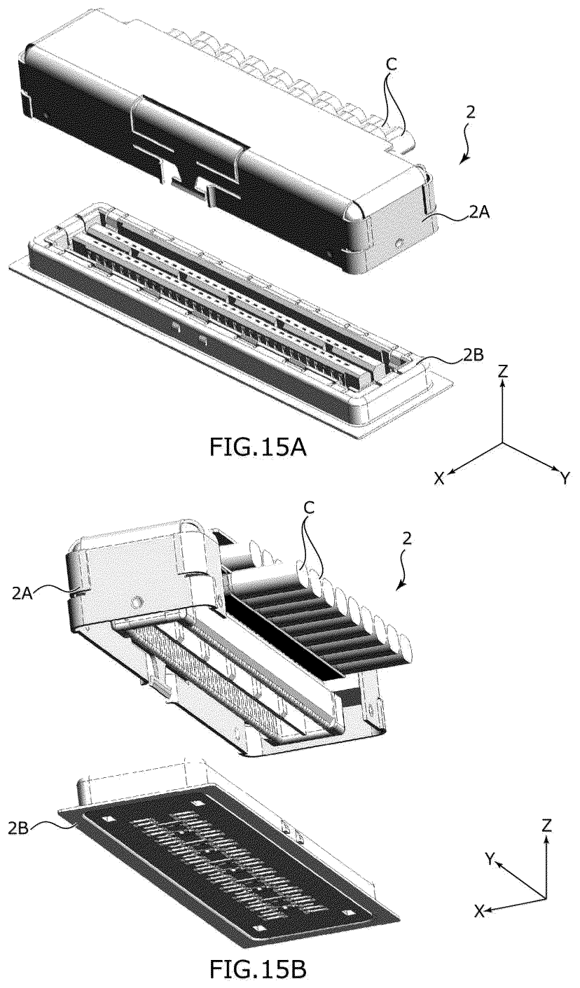

FIG. 14 illustrates the appearance of connector set 2 according to Embodiment 2 to which the present invention is applied. FIGS. 15A and 15B are exploded perspective views of connector set 2. Note that configurations common to those in Embodiment 1, e.g., cables C, will not be described.

As in Embodiment 1, connector set 2 is a vertical fitting type wire-to-board connector set, where the Y-axis direction is a pitch direction of connector set 2 and the Z-axis direction is a mating direction of connector set 2. Connector set 2 is used, for example, to interconnect circuit boards using cables C in an information device such as a server, a switch (network device), and storage.

As illustrated in FIGS. 14, 15A, and 15B, connector set 2 includes cable-side connector 2A and board-side connector 2B. Cable-side connector 2A is a connector to which cables C are connected, and board-side connector 2B is a connector to be mounted on circuit board B.

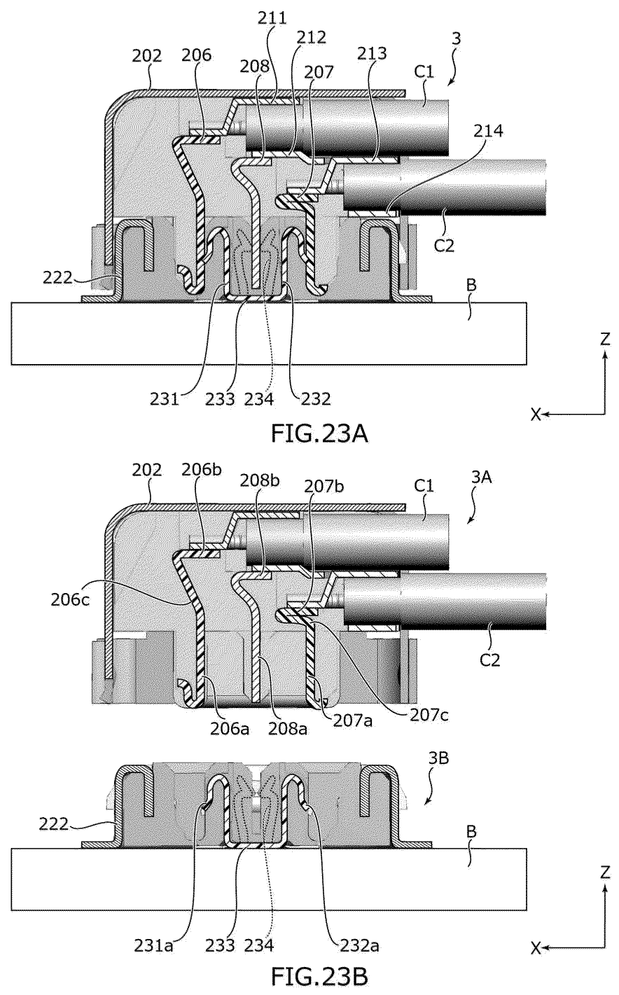

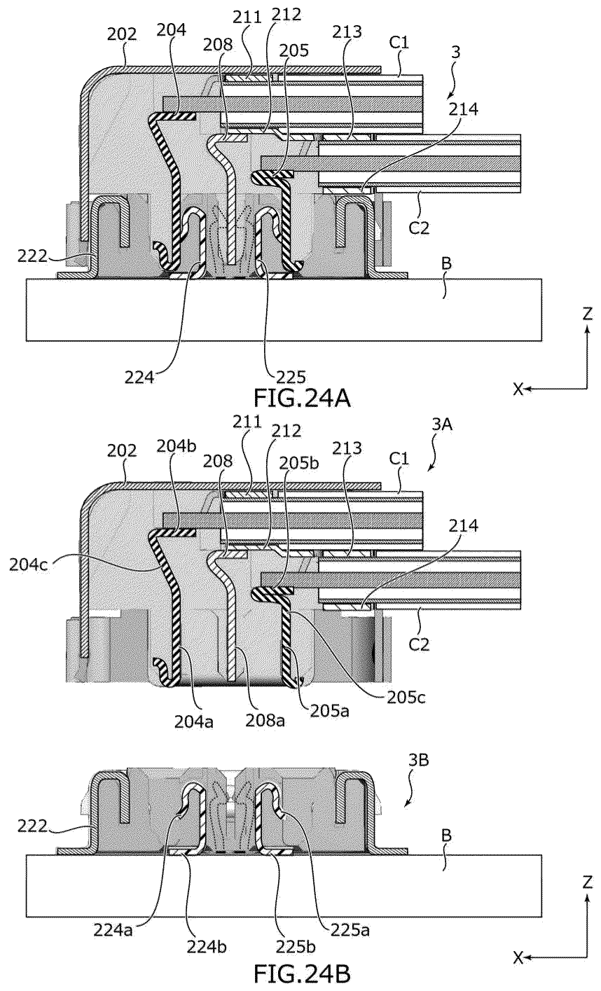

Connector set 2 electrically connects cables C and circuit board B by vertical fitting of cable-side connector 2A and board-side connector 2B. To be more specific, internal conductors 11 of cables C are electrically connected to the signal pattern of circuit board B via cable-side signal contacts 204 and 205 of cable-side connector 2A and board-side signal contacts 224 and 225 of board-side connector 2B (see FIG. 24A). In addition, external shield layers 12 of cables C are connected to the ground pattern of circuit board B via cable-side ground contacts 206 and 207 of cable-side connector 2A and board-side ground contacts 231 and 232 of board-side connector 2B (see FIG. 23B).

Specific configurations of cable-side connector 2A and board-side connector 2B will be described below.

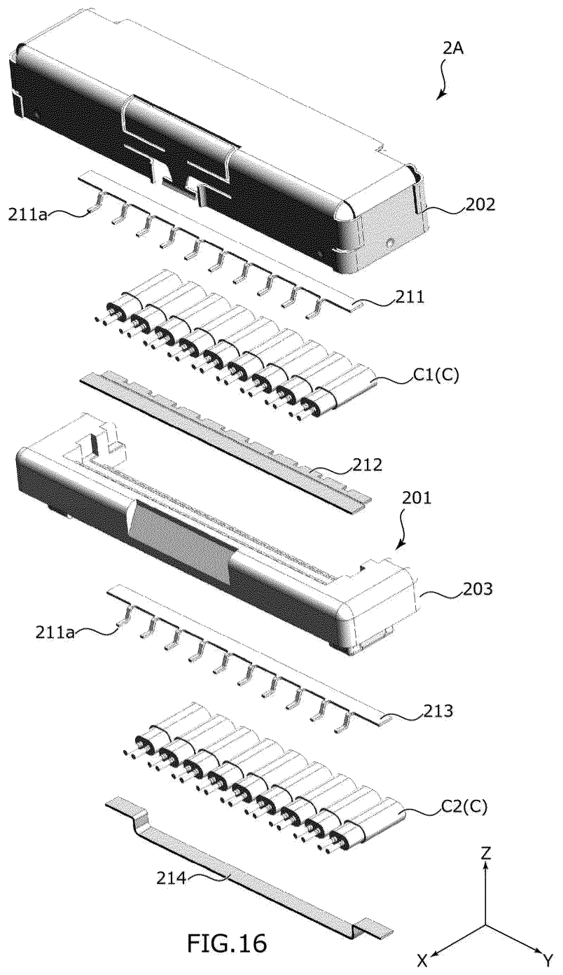

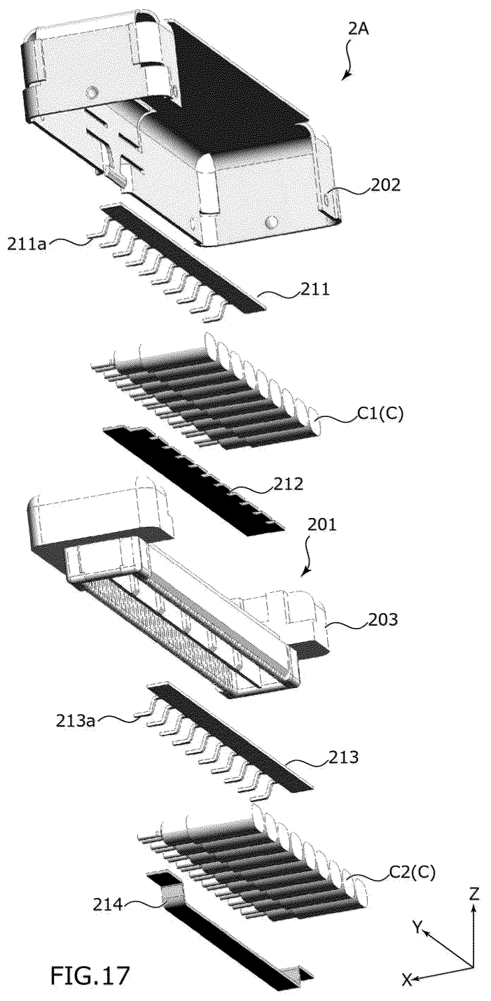

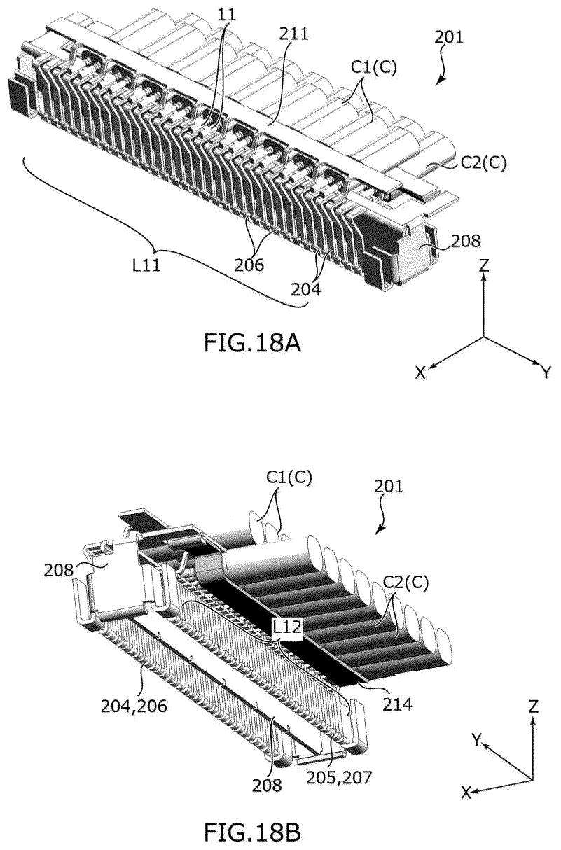

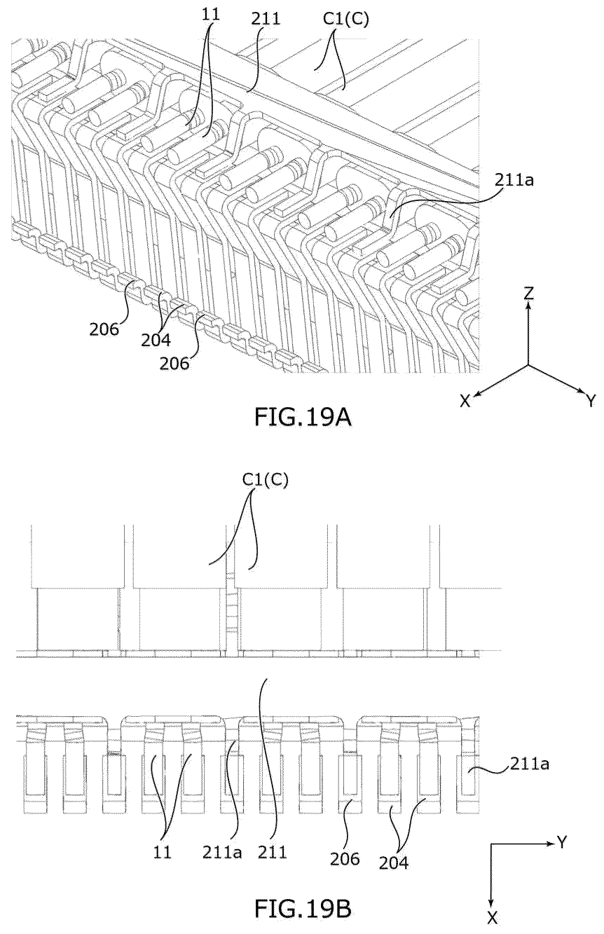

FIGS. 16 and 17 are exploded perspective views of cable-side connector 2A. FIGS. 18A and 18B are perspective views illustrating how cables C are attached to cable-side connector body 201. Cable-side insulator 203 is not illustrated in FIGS. 18A and 18B. FIGS. 19A and 19B are enlarged views illustrating how cables C are attached to cable-side connector body 201.

As illustrated in FIG. 16 and the like, cable-side connector 2A includes cable-side connector body 201 and cover shell 202. First cables C1 are attached to cable-side connector body 201 from above, and second cables C2 are attached to cable-side connector body 201 from below.

Cable-side connector body 201 includes cable-side insulator 203, first cable-side signal contacts 204, second cable-side signal contacts 205, first cable-side ground contacts 206, second cable-side ground contacts 207, ground plate 208, and the like.

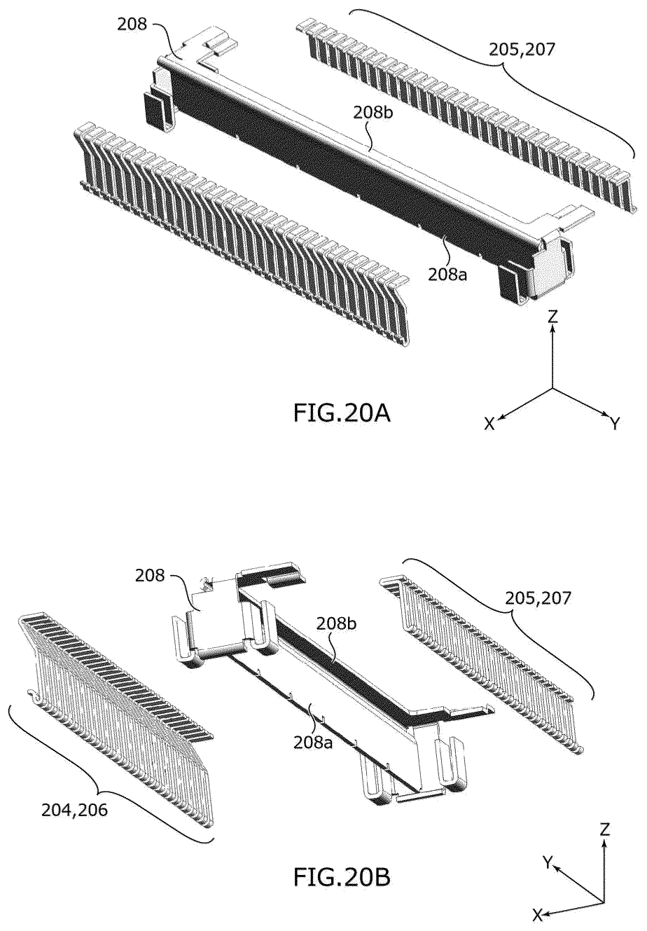

In the following, first cable-side signal contacts 204 and second cable-side signal contacts 205 are referred to as “cable-side signal contacts 204 and 205” unless they are distinguished from each other. Additionally, first cable-side ground contacts 206 and second cable-side ground contacts 207 are referred to as “cable-side ground contacts 206 and 207” unless they are distinguished from each other. FIGS. 20A and 20B illustrate disassembled cable-side signal contacts 204 and 205, cable-side ground contacts 206 and 207, and ground plate 208, which are assembled to cable-side insulator 203.

Cover shell 202, cable-side signal contacts 204 and 205, cable-side ground contacts 206 and 207, and ground plate 208 are formed of a conductive material such as metal (e.g., copper alloy). Cable-side insulator 203 is formed of an insulating material such as a synthetic resin (e.g., liquid crystal polymer).

Cover shell 202 is placed to cover the outside of cable-side connector body 201 and is in contact with and electrically connected to ground plate 208 of cable-side connector body 201. Cover shell 202 is at ground potential and functions as a shield. Like cable-side insulator 203, cover shell 202 may be formed of an insulating material such as a synthetic resin and form a housing of cable-side connector 2A.

Cable-side insulator 203 forms a housing of cable-side connector 2A. Cable-side signal contacts 204 and 205, cable-side ground contacts 206 and 207, and ground plate 208 are assembled to cable-side insulator 203. Cable-side signal contacts 204 and 205, cable-side ground contacts 206 and 207, and ground plate 208 are integrally formed with cable-side insulator 203 by, for example, insert molding. Cable-side signal contacts 204 and 205, cable-side ground contacts 206 and 207, and ground plate 208 are placed apart and electrically insulated from each other by cable-side insulator 203.

Ground plate 208 is a ground member connected to the ground, which is the reference potential, together with cable-side ground contacts 206 and 207. Ground plate 208 is formed by, for example, sheet metal working (including punching and bending) of a single metal sheet. Ground plate 208 includes first plate portion 208a and second plate portion 208b. First plate portion 208a has a planar shape extending along the YZ plane. Second plate portion 208b has a planar shape extending along the XY plane.

Cable-side signal contacts 204 and 205 are members connected to internal conductors 11 of cables C. To be more specific, first cable-side signal contacts 204 are connected to internal conductors 11 of first cables C1 placed in the upper row. Second cable-side signal contacts 205 are connected to internal conductors 11 of second cables C2 placed in the lower row. Cable-side signal contacts 204 and 205 are each formed by, for example, sheet metal working (including punching and bending) of a single metal sheet.

Cable-side signal contacts 204 and 205 have similar configurations and include signal line contact sections 204a and 205a, signal line connection sections 204b and 205b, and signal line relay sections 204c and 205c, respectively. Signal line relay sections 204c and 205c connect signal line contact sections 204a and 205a and signal line connection sections 204b and 205b.

Signal line contact sections 204a and 205a contact and electrically connect to signal line contact sections 224a and 225a of board-side connector 2B when cable-side connector 2A and board-side connector 2B are mated with each other (see FIGS. 24A and 24B). Internal conductors 11 of cables C exposed by stripping processing on the tips are connected to signal line connection sections 204b and 205b by a mechanical joining method such as soldering, welding, crimping, or the like.

Cable-side signal contacts 204 and 205 have an L-shaped cross section in which signal line relay sections 204c and 205c extend from signal line contact sections 204a and 205a to the positive side in the Z-axis direction (mating direction), bend by 90 degrees toward the negative side in the X-axis direction (pull-out direction of cables C), and reach signal line connection sections 204b and 205b.

Cable-side signal contacts 204 and 205 are each in pairs connected to the same cable C, and are aligned in the Y-axis direction, which is the pitch direction. First cable-side signal contacts 204 form first cable-side contact row L11 together with first cable-side ground contacts 206. Second cable-side signal contacts 205 form second cable-side contact row L12 together with second cable-side ground contacts 207.

As in Embodiment 1, the distance between cable-side signal contacts 204 respectively connected to adjacent cables C in the Y-axis direction is wider than the distance between cable-side signal contacts 204 connected to the same cable C. The same applies to cable-side signal contacts 205. Hereinafter, two adjacent cable-side signal contacts 204 or 205 among cable-side signal contacts 204 and 205 connected to adjacent cables C in the Y-axis direction are simply referred to as “adjacent cable-side signal contacts 204 and 205.”

First cable-side signal contacts 204 are arranged so that the main surfaces (plate surfaces) are along one surface (first main surface) of ground plate 208. Signal line contact sections 204a of first cable-side signal contacts 204 are located on the positive side in the X-axis direction of first plate portion 208a of ground plate 208, and signal line connection sections 204b are located on the positive side (upper side) in the Z-axis direction of second plate portion 208b of ground plate 208.

Second cable-side signal contacts 205 are arranged so that the main surfaces (plate surfaces) are along the other surface (second main surface) of ground plate 208. Signal line contact sections 205a of second cable-side signal contacts 205 are located on the negative side in the X-axis direction of first plate portion 208a of ground plate 208, and signal line connection sections 205b are located on the negative side (lower side) in the Z-axis direction of second plate portion 208b of ground plate 208.

The first main surface of first plate portion 208a of ground plate 208 faces first cable-side signal contacts 204. The second main surface of first plate portion 208a of ground plate 208 faces second cable-side signal contacts 205. That is, planar grounds formed by ground plate 208 are placed for a plurality of cable-side signal contacts 204 and 205 aligned in the Y-axis direction.

Thus, ground plate 208 extends to shield between signal line connection sections 204b of first cable-side signal contacts 204 and signal line connection sections 205b of second cable-side signal contacts 205. Ground plate 208 also extends to shield between signal line relay sections 204c of first cable-side signal contacts 204 and signal line relay sections 205c of second cable-side signal contacts 205 over the entire length of signal line relay sections 204c and 205c. Further, ground plate 208 extends to shield between signal line contact sections 204a of first cable-side signal contacts 204 and signal line contact sections 205a of second cable-side signal contacts 205.

First cable-side signal contacts 204 and second cable-side signal contacts 205 have a symmetrical structure with respect to ground plate 208. The symmetrical structure is a structure securing electrical equivalency with respect to ground plate 208. To be more specific, first cable-side signal contacts 204 and second cable-side signal contacts 205 have the same shape in a cross-section taken perpendicular to the extending direction, and the distances from each of signal line contact sections 204a, signal line relay sections 204c, and signal line connection sections 204b of first cable-side signal contacts 204 to ground plate 208 are respectively the same as the distances from each of signal line contact sections 205a, signal line relay sections 205c, and signal line connection sections 205b of second cable-side signal contacts 205 to ground plate 208.

Cable-side ground contacts 206 and 207 are ground members connected to the ground, which is the reference potential. To be more specific, first cable-side ground contacts 206 are connected to external shield layers 12 of first cables C1 placed in the upper row. Second cable-side ground contacts 207 are connected to external shield layers 12 of second cables C2 placed in the lower row. Cable-side ground contacts 206 and 207 are each formed by sheet metal working (including punching and bending) of a single metal sheet.

First cable-side ground contacts 206 are each disposed between adjacent first cable-side signal contacts 204. Second cable-side ground contacts 207 are each disposed between adjacent second cable-side signal contacts 205. Cable-side ground contacts 206 and 207 have shapes similar to those of cable-side signal contacts 204 and 205, respectively.

Cable-side ground contacts 206 and 207 have ground contact sections 206a and 207a, ground connection sections 206b and 207b, and ground relay sections 206c and 207c, respectively. Ground relay sections 206c and 207c connect ground contact sections 206a and 207a and ground connection sections 206b and 207b.

Cable-side ground contacts 206 and 207 have substantially the same configuration. That is, they have an L-shaped cross section in which ground relay sections 206c and 207c extend from ground contact sections 206a and 207a to the positive side in the Z-axis direction, bend by 90 degrees toward the negative side in the X-axis direction, and reach ground connection sections 206b and 207b. The shapes of cable-side ground contacts 206 and 207 are substantially the same as the shapes of cable-side signal contacts 204 and 205, respectively.

Cable-side ground contacts 206 and 207 are aligned in the Y-axis direction, which is the pitch direction. Cable-side ground contacts 206 and 207 are each disposed between adjacent cable-side signal contacts 204 and 205.

Ground contact sections 206a of first cable-side ground contacts 206 are each disposed between signal line contact sections 204a of adjacent first cable-side signal contacts 204 and shield between signal line contact sections 204a.

Likewise, ground contact sections 207a of second cable-side ground contacts 207 are each disposed between signal line contact sections 205a of adjacent second cable-side signal contacts 205 and shield between signal line contact sections 205a.

Ground contact sections 206a and 207a contact and electrically connect to board-side ground contacts 231 and 232 of board-side connector 2B when cable-side connector 2A and board-side connector 2B are mated with each other (see FIGS. 23A and 23B).

External shield layers 12 of first cables C1 are collectively interposed between first upper ground bar 211 and second upper ground bar 212 in the Z-axis direction. Drawn portions 211a of first upper ground bar 211 are respectively connected to the upper surfaces of ground connection sections 206b of first cable-side ground contacts 206 by a mechanical bonding method such as soldering, welding, crimping, or the like. In addition, the lower surface of second upper ground bar 212 is connected to second plate portion 208b of ground plate 208.

External shield layers 12 of second cables C2 are collectively interposed between first lower ground bar 213 and second lower ground bar 214 in the Z-axis direction. Drawn portions 213a of first lower ground bar 213 are respectively connected to the upper surfaces of ground connection sections 207b of second cable-side ground contacts 207 by a mechanical bonding method such as soldering, welding, crimping, or the like.

First cable-side ground contacts 206 are placed so that the main surfaces (plate surfaces) are along one surface of ground plate 208. In first cable-side ground contacts 206, ground contact sections 206a are located on the positive side in the X-axis direction of first plate portion 208a of ground plate 208, and ground connection sections 206b are located on the positive side (upper side) in the Z-axis direction of second plate portion 208b of ground plate 208.

Second cable-side ground contacts 207 are placed so that the main surfaces (plate surfaces) are along the other surface of ground plate 208. In second cable-side ground contacts 207, ground contact sections 207a are located on the negative side in the X-axis direction of first plate portion 208a of ground plate 208, and ground connection sections 207b are located on the negative side (lower side) in the Z-axis direction of second plate portion 208b of ground plate 208.

First cable-side ground contacts 206 are placed so that ground contact sections 206a are located on the positive side in the X-axis direction of first plate portion 208a of ground plate 208, and ground connection sections 206b are located on the positive side (upper side) in the Z-axis direction of second plate portion 208b of ground plate 208. Second cable-side ground contacts 207 are placed so that ground contact sections 207a are located on the negative side in the X-axis direction of first plate portion 208a of ground plate 208, and ground connection sections 207b are located on the negative side (lower side) in the Z-axis direction of second plate portion 208b of ground plate 208. Note that ground connection sections 206b and 207b of cable-side ground contacts 206 and 207 do not overlap with second plate portion 208b of ground plate 208 in the Z-axis direction.

Signal line contact sections 204a and 205a of cable-side signal contacts 204 and 205 and ground contact sections 206a and 207a of cable-side ground contacts 206 and 207 are exposed from the surface of a fitting portion of cable-side insulator 203. Signal line connection sections 204b and 205b of cable-side signal contacts 204 and 205 and ground connection sections 206b and 207b of cable-side ground contacts 206 and 207 are exposed from the surface of a cable placement portion of cable-side insulator 203.

Cable-side signal contacts 204 and 205 and cable-side ground contacts 206 and 207 respectively have the similar shapes. Signal line contact sections 204a and 205a of cable-side signal contacts 204 and 205 and ground contact sections 206a and 207a of cable-side ground contacts 206 and 207 are flush with each other. A similar design (e.g., spring characteristics) can be applied in spring pieces forming signal line contact sections 224a and 225a and spring pieces forming ground contact sections 231a and 232a in board-side connector 2B.

Note that ground connection sections 206b and 207b of cable-side ground contacts 206 and 207 may be provided with interconnection shielding sections including two flat-plane shielding plates extending along the XZ plane at both ends in the Y-axis direction (see Embodiment 1).

In cable-side connector 2A, ground contact sections 206a, which are at ground potential, are each disposed between signal line contact sections 204a of two adjacent cable-side signal contacts 204, and shield between signal line contact sections 204a. Likewise, ground contact sections 207a, which are at ground potential, are each disposed between signal line contact sections 205a of two adjacent cable-side signal contacts 205, and shield between signal line contact sections 205a.

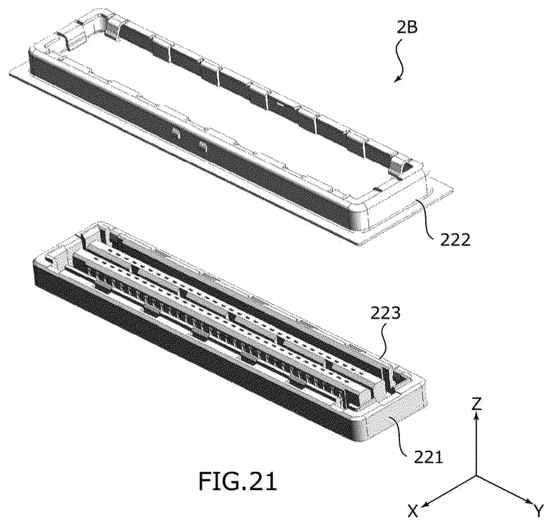

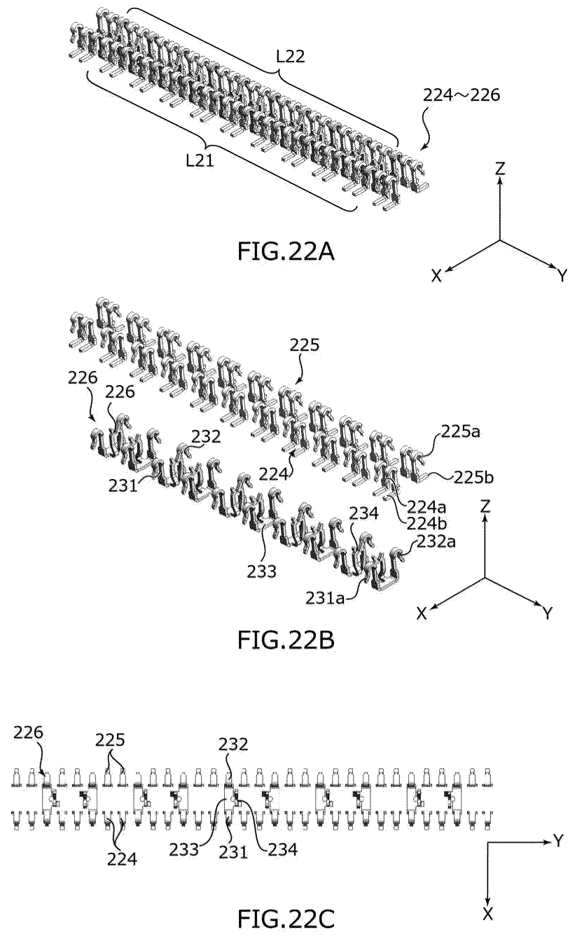

FIG. 21 is an exploded perspective view of board-side connector 2B to be mated with cable-side connector 2A, viewed from the positive side (hereinafter, sometimes referred to as the “fitting side”) in the Z-axis direction. FIGS. 22A to 22C illustrate a contact structure in board-side connector body 221.

As illustrated in FIG. 21 and FIGS. 22A to 22C, board-side connector 2B includes board-side connector body 221 and board-side shell 222. Board-side connector body 221 includes board-side insulator 223, first board-side signal contacts 224, second board-side signal contacts 225, and board-side ground fittings 226 (see FIGS. 22A to 22C).

In the following, first board-side signal contacts 224 and second board-side signal contacts 225 are referred to as “board-side signal contacts 224 and 225” unless they are distinguished from each other. FIG. 22B illustrates board-side signal contacts 224 and 225 and board-side ground fittings 226, which are assembled to board-side insulator 223, shifted in the Z-axis direction.

Board-side shell 222, board-side signal contacts 224 and 225, and board-side ground fittings 226 are formed of a conductive material such as metal (e.g., copper alloy). Board-side insulator 223 is formed of an insulating material such as a synthetic resin (e.g., liquid crystal polymer).

Board-side shell 222 is a frame connected to the ground pattern of circuit board B and has a rectangular shape corresponding to the outer edge of board-side insulator 223 in plan view from the Z-axis direction. Board-side shell 222 is formed by, for example, drawing a metal sheet. Board-side shell 222 is placed to cover the outside of board-side connector body 221 and is in contact with and electrically connected to board-side ground fittings 226 of board-side connector body 221. Board-side shell 222 is at ground potential and functions as a shield. Board-side shell 222 is fitted to, for example, a peripheral portion of board-side insulator 223.

Board-side insulator 223 has a rectangular shape in plan view from the Z-axis direction and forms a housing of board-side connector 2B. Board-side signal contacts 224 and 225 and board-side ground fittings 226 are assembled to board-side insulator 223. Board-side signal contacts 224 and 225 and board-side ground fittings 226 are integrally formed with board-side insulator 223 by, for example, insert molding. Board-side signal contacts 224 and 225 and board-side ground fittings 226 are placed apart and electrically insulated from each other by board-side insulator 223.

Board-side signal contacts 224 and 225 are members respectively connected to cable-side signal contacts 204 and 205 of cable-side connector 2A. Board-side signal contacts 224 and 225 are formed by, for example, sheet metal working (including punching and bending) of a single metal sheet. Board-side signal contacts 224 and 225 are each in pairs, respectively corresponding to cable-side signal contacts 204 and 205, and are aligned in the Y-axis direction, which is the pitch direction. First board-side signal contacts 224 form first board-side contact row L21 together with first board-side ground contacts 231, which will be described later. Second board-side signal contacts 225 form second board-side contact row L22 together with second board-side ground contacts 232, which will be described later.

Board-side signal contacts 224 and 225 have similar configurations, with signal line contact sections 224a and 225a and signal line surface-mounted sections 224b and 225b, respectively. To be more specific, signal line contact sections 224a and 225a are each formed so as to be curved outward in a U-shape viewed from the Y-axis direction, and have a spring piece (whose reference sign is omitted) at the free end that exerts biasing force against the facing surface (signal line contact sections 204a and 205a of cable-side connector 2A).

Signal line contact sections 224a and 225a contact and electrically connect to signal line contact sections 204a and 205a of cable-side connector 2A when cable-side connector 2A and board-side connector 2B are mated with each other (see FIGS. 24A and 24B). Signal line surface-mounted sections 224b and 225b are connected to the signal pattern of circuit board B by soldering, for example.

Board-side ground fittings 226 include a plurality of board-side ground contacts 231 and 232 to be respectively connected to cable-side ground contacts 206 and 207 of cable-side connector 2A. Board-side ground contacts 231 and 232 respectively include ground contact sections 231a and 232a. Ground contact sections 231a and 232a have shapes similar to those of signal line contact sections 224a and 225a of board-side signal contacts 224 and 225.

In each of board-side ground fittings 226, a pair of board-side ground contacts 231 and 232 facing in the X-axis direction are coupled by pair coupling section 233 extending in the X-axis direction, and are electrically and mechanically connected. It is considered that board-side ground contacts 231 and 232 are placed at both ends in the extending direction of pair coupling section 233. Pair coupling section 233 has a flat plate shape, and the main surface is perpendicular to the mating direction. Pair coupling section 233 is connected to the ground pattern of circuit board B by soldering, for example, and functions as the surface-mounted section of board-side ground contacts 231 and 232. By providing pair coupling section 233, the area of the ground element is increased, and the ground is equipotentialized.

Further, board-side ground fittings 226 include plate contact sections 234 connected to first plate portion 208a of ground plate 208 of cable-side connector 2A. Each plate contact section 234 includes two plate contact pieces interposing ground plate 208 therebetween. Plate contact section 234 is shifted in the Y-axis direction with respect to board-side ground contacts 231 and 232. Plate contact section 234 is coupled to pair coupling section 233. Plate contact section 234 is placed in the center in the extending direction of pair coupling section 233, for example.

Note that a plurality of board-side ground fittings 226 aligned in the Y-axis direction may be coupled to each other by pin coupling sections extending in the Y-axis direction as is the case with board-side ground fitting 126 in Embodiment 1.

FIGS. 23A and 23B are sectional views illustrating the connection of grounds in connector set 2, and illustrate XZ sections between adjacent cables C in the Y-axis direction (pitch direction). FIG. 23A illustrates a state after cable-side connector 2A and board-side connector 2B are fitted, and FIG. 23B illustrates a state before cable-side connector 2A and board-side connector 2B are fitted.

FIGS. 24A and 24B are sectional views illustrating the connection of signal lines in connector set 2, and illustrate XZ sections through internal conductors 11 of cables C. FIG. 24A illustrates a state after cable-side connector 2A and board-side connector 2B are fitted, and FIG. 24B illustrates a state before cable-side connector 2A and board-side connector 2B are fitted.

As illustrated in FIGS. 23A and 23B, ground contact sections 206a and 207a of cable-side ground contacts 206 and 207 are fitted and electrically connected to ground contact sections 231a and 232a of board-side ground contacts 231 and 232. In addition, ground plate 208 is inserted between and electrically connected to the two contact pieces of plate contact section 234. That is, board-side ground fitting 226 contacts and electrically connects to each of cable-side ground contacts 206 and 207 and ground plate 208.

Further, as illustrated in FIGS. 24A and 24B, when cable-side connector 2A and board-side connector 2B are fitted, signal line contact sections 204a and 205a of cable-side signal contacts 204 and 205 are fitted and electrically connected to signal line contact sections 224a and 225a of board-side signal contacts 224 and 225.

Connector set 2 according to Embodiment 2 includes the following features alone or in combination as appropriate.

That is, connector set 2 includes board-side connector 2B (first connector) and counterpart cable-side connector 2A (second connector) that can be mated with board-side connector 2B. Board-side connector 2B includes board-side signal contacts 224 and 225 connected to signal lines and board-side ground contacts 231 and 232 connected to the ground. Board-side ground contacts 231 and 232 include a plurality of first board-side ground contacts 231 aligned in first board-side contact row L21 (first contact row) along the pitch direction and a plurality of second board-side ground contacts 232 aligned in second board-side contact row L22 (second contact row). First board-side ground contacts 231 and second board-side ground contacts 232 are electrically and mechanically connected to each other by pair coupling sections 233.

Board-side connector 2B (first connector) includes board-side ground fittings 226, which are each a single member formed with first board-side ground contact 231, second board-side ground contact 232, and pair coupling section 233.

Pair coupling section 233 has a flat plate shape, and the main surface is perpendicular to the mating direction.

Cable-side connector 2A (second connector) includes cable-side signal contacts 204 and 205 (counterpart signal contacts) connected to board-side signal contacts 224 and 225, cable-side ground contacts 206 and 207 (counterpart ground contacts) connected to board-side ground contacts 231 and 232, and flat ground plate 208 connected to the ground. Cable-side signal contacts 204 and 205 include a plurality of first cable-side signal contacts 204 (first counterpart signal contacts) aligned in first cable-side contact row L11 (first counterpart contact row) along the pitch direction and connected to first board-side signal contacts 224, and the first main surface of ground plate 208 faces the plurality of first cable-side signal contacts 204.

Board-side connector 2B (first connector) includes board-side ground fittings 226, which are each a single member formed with first board-side ground contact 231 and plate contact section 234 that makes contact with ground plate 208.

Cable-side signal contacts 204 and 205 (counterpart signal contacts) include a plurality of second cable-side contacts 205 aligned in second cable-side signal contact row L12 (second counterpart contact row) along the pitch direction, and the second main surface of ground plate 208 faces second cable-side signal contacts 205.

Ground plate 208 is mechanically separated from first cable-side ground contacts 206 and second cable-side ground contacts 207. Board-side connector 2B includes board-side ground fittings 226, which are each a single member formed with first board-side ground contact 231, second board-side ground contact 232, and plate contact section 234 that makes contact with ground plate 208. Board-side ground fitting 226 contacts and electrically connects to each of first cable-side ground contact 206, second cable-side ground contact 207, and ground plate 208.

Plate contact section 234 includes two plate contact pieces interposing ground plate 208 therebetween.

Each of board-side ground fittings 226 includes pair coupling section 233 that couples first board-side ground contact 231 and second board-side ground contact 232. Plate contact section 234 is placed in the center in the extending direction (X-axis direction) of pair coupling section 233, and first board-side ground contact 231 and second board-side ground contact 232 are placed at both ends of pair coupling section 233 in the extending direction.

First cable-side signal contacts 204 and second cable-side signal contacts 205 respectively include signal line connection sections 204b and 205b connected to signal lines, signal line contact sections 204a and 205a connected to board-side signal contacts 224 and 225, and signal line relay sections 204c and 205c connecting signal line connection sections 204b and 205b and signal line contact sections 204a and 205a. Ground plate 208 extends to shield at least between signal line connection sections 204b of first cable-side signal contacts 204 and signal line connection sections 205b of second cable-side signal contacts 205.

Ground plate 208 extends to shield between signal line relay sections 204c of first cable-side signal contacts 204 and signal line relay sections 205c of second cable-side signal contacts 205 over the entire length of signal line relay sections 204c and 205c.

Ground plate 208 extends to shield between signal line contact sections 204a of first cable-side signal contacts 204 and signal line contact sections 205a of second cable-side signal contacts 205.

Cable-side connector 2A (second connector) includes cable-side signal contacts 204 and 205 connected to board-side signal contacts 224 and 225, cable-side ground contacts 206 and 207 connected to board-side ground contacts 231 and 232, and flat ground plate 208 connected to the ground. Cable-side signal contacts 204 and 205 include a plurality of first cable-side signal contacts 204 aligned in first cable-side contact row L11 (first counterpart contact row) along the pitch direction and connected to first board-side signal contacts 224, and a plurality of second cable-side contacts 205 aligned in second cable-side signal contact row L12 (second counterpart contact row) along the pitch direction and connected to second board-side signal contacts 225. Ground plate 208 is disposed between first cable-side contact row L11 and second cable-side contact row L12. First cable-side signal contacts 204 and second cable-side signal contacts 205 have a symmetrical structure with respect to ground plate 208.

First cable-side signal contacts 204 and second cable-side signal contacts 205 have the same shape in a cross-section taken perpendicular to the extending direction, and the distances from each of signal line contact sections 204a, signal line relay sections 204c, and signal line connection sections 204b of first cable-side signal contacts 204 to ground plate 208 are respectively the same as the distances from each of signal line contact sections 205a, signal line relay sections 205c, and signal line connection sections 205b of second cable-side signal contacts 205 to ground plate 208.

Cable-side connector 2A (second connector) is a wire-to-board cable-side connector connected to a plurality of cables C (coaxial cables) used for high-frequency signal transmission. The plurality of cables C include first cables C1 connected to first cable-side signal contacts 204 and second cables C2 connected to second cable-side signal contacts 205. First cables C1 and second cables C2 are pulled out in a direction perpendicular to the mating direction and stacked in the mating direction. Ground plate 208 is bent in an L-shape and extends in the mating direction and the pull-out direction of cables C.

Connector set 2 has the above-described features, which remarkably reinforces the ground structure. In addition, it is possible to improve EMS characteristics (e.g., characteristic impedance, insertion loss, return loss, crosstalk, etc.) in transmission lines, and to ensure favorable transmission quality. Further, a plurality of cables C can be connected to circuit board B collectively. Thus, it is possible to meet a requirement for wiring in an information device such as a server, and more particularly to enhance a high-speed transmission characteristic. It is also possible to improve the connection workability of cables C and reduce the size of the connector.

### Embodiment 3

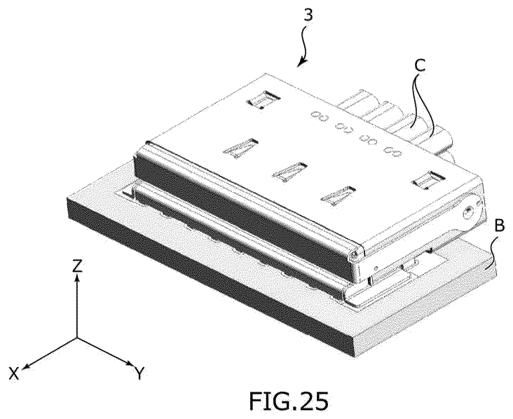

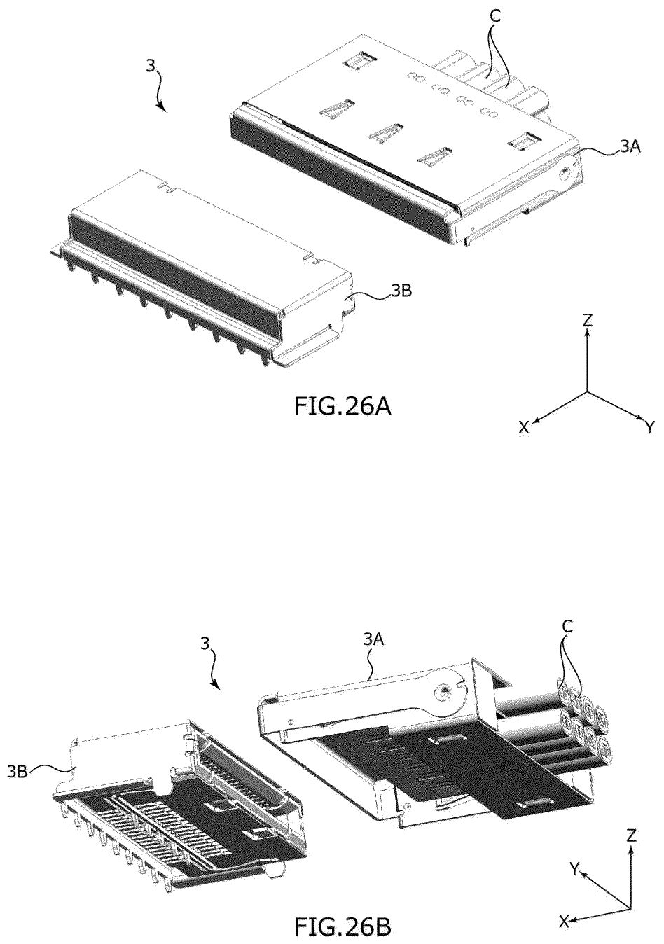

FIG. 25 illustrates the appearance of connector set 3 according to Embodiment 3 to which the present invention is applied. FIGS. 26A and 26B are exploded perspective views of connector set 3. Note that configurations common to those in Embodiment 1, e.g., cables C, will not be described.

Connector set 3 is a horizontal fitting type wire-to-board connector set, where the Y-axis direction is a pitch direction of connector set 3 and the X-axis direction is a mating direction of connector set 3. Connector set 3 is used, for example, to interconnect circuit boards using cables C in an information device such as a server, a switch (network device), and storage.

As illustrated in FIGS. 25, 26A, and 26B, connector set 3 includes cable-side connector 3A and board-side connector 3B. Cable-side connector 3A is a connector to which cables C are connected, and board-side connector 3B is a connector to be mounted on circuit board B.

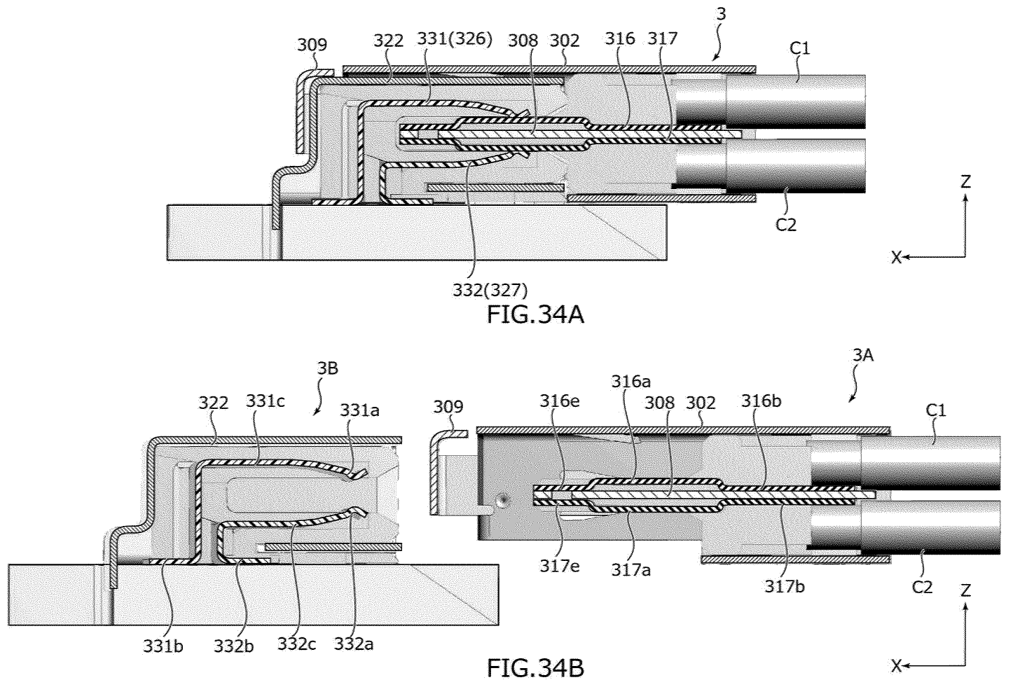

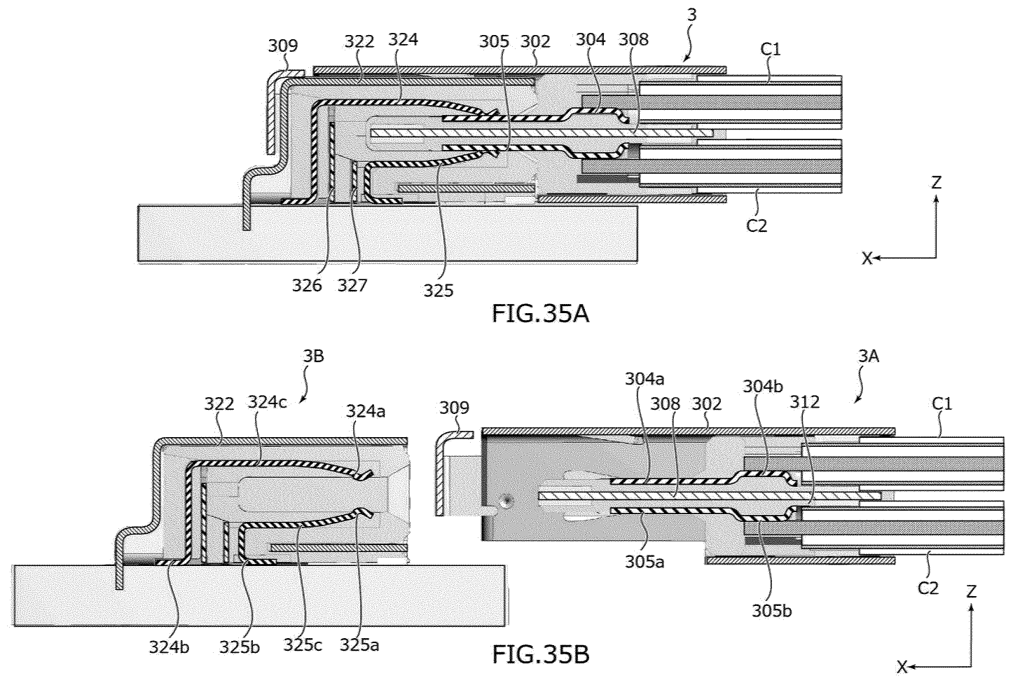

Connector set 3 electrically connects cables C and circuit board B by horizontal fitting of cable-side connector 3A and board-side connector 3B. To be more specific, internal conductors 11 of cables C are electrically connected to the signal pattern of circuit board B via cable-side signal contacts 304 and 305 of cable-side connector 3A and board-side signal contacts 324 and 325 of board-side connector 3B (see FIG. 35A). In addition, external shield layers 12 of cables C are connected to the ground pattern of circuit board B via cable-side ground contacts 316 and 317 of cable-side connector 3A and board-side ground contacts 331 and 332 of board-side connector 3B (see FIG. 34A).

Specific configurations of cable-side connector 3A and board-side connector 3B will be described below.

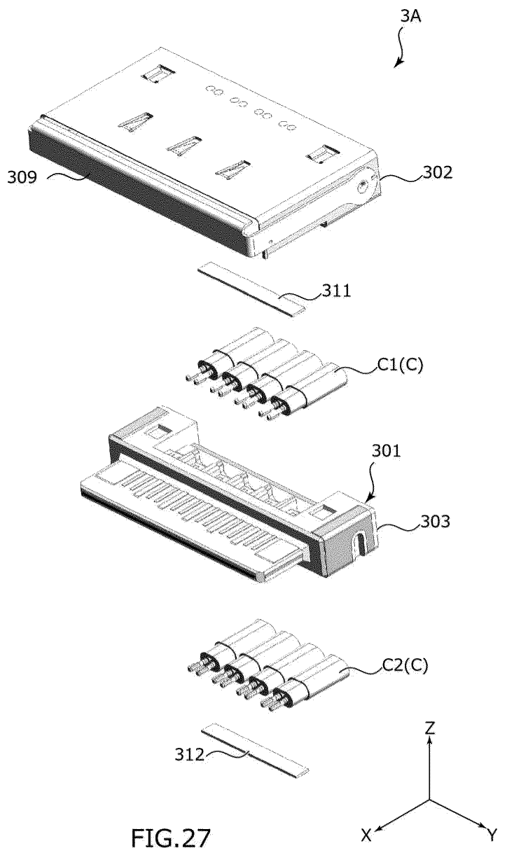

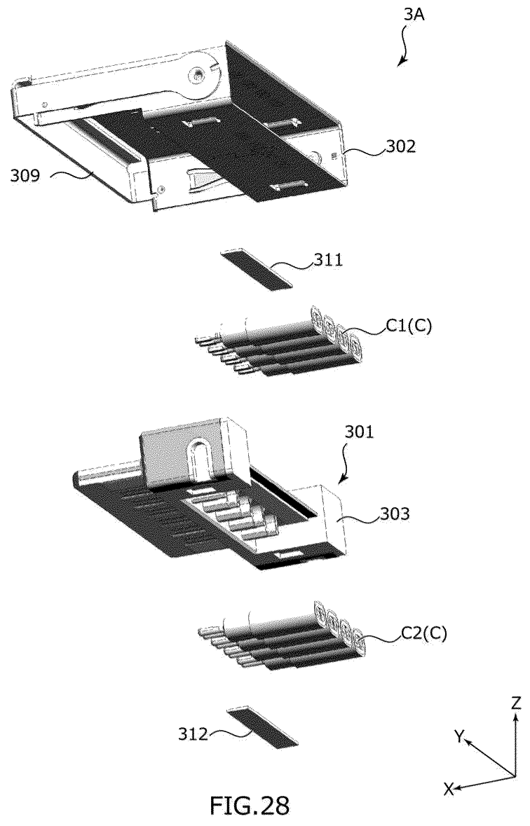

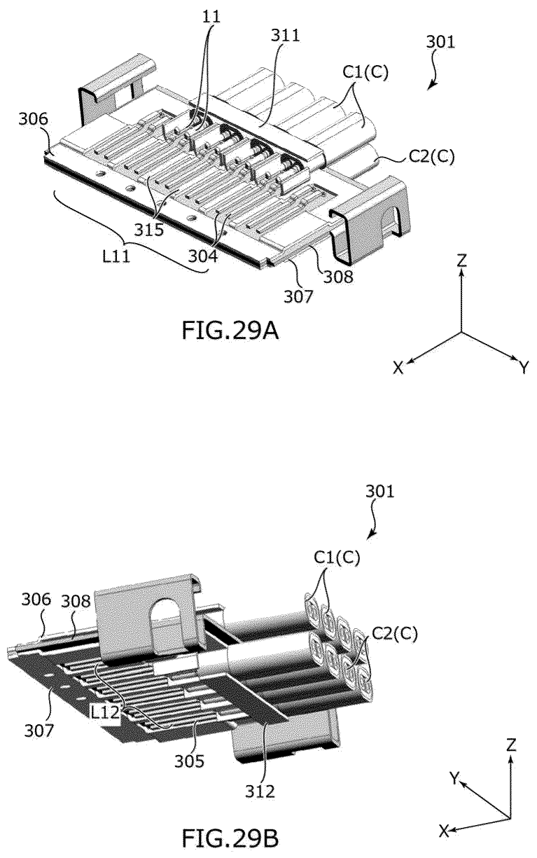

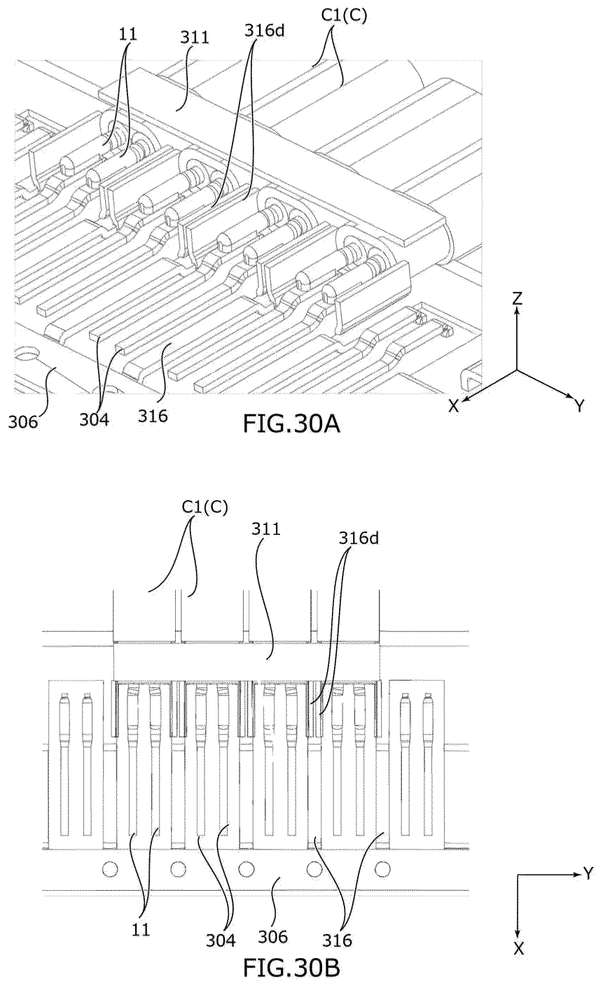

FIGS. 27 and 28 are exploded perspective views of cable-side connector 3A. FIGS. 29A and 29B are perspective views illustrating how cables C are attached to cable-side connector body 301. Cable-side insulator 303 is not illustrated in FIGS. 29A and 29B. FIGS. 30A and 30B are enlarged views illustrating how cables C are attached to cable-side connector body 301.

As illustrated in FIG. 27 and the like, cable-side connector 3A includes cable-side connector body 301 and cover shell 302. First cables C1 are attached to cable-side connector body 301 from above, and second cables C2 are attached to cable-side connector body 301 from below.

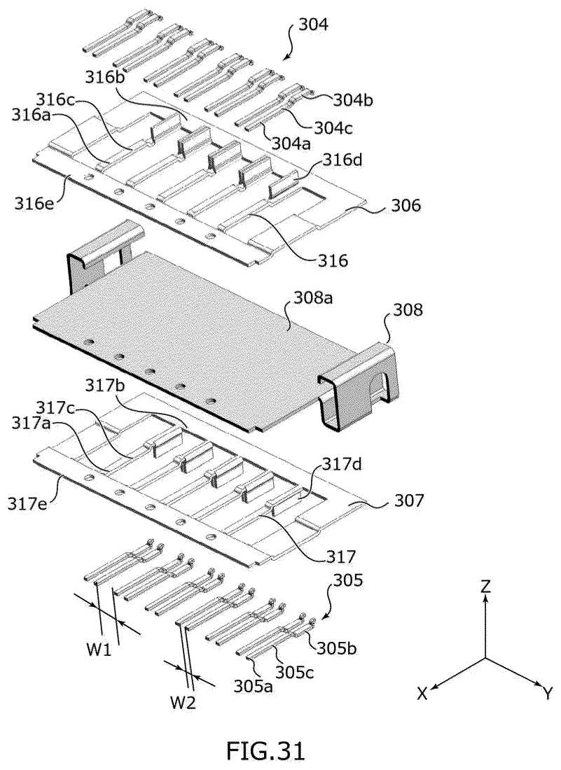

Cable-side connector body 301 includes cable-side insulator 303, first cable-side signal contacts 304, second cable-side signal contacts 305, first cable-side ground fitting 306, second cable-side ground fitting 307, ground plate 308, and the like (see FIG. 31).

In the following, first cable-side signal contacts 304 and second cable-side signal contacts 305 are referred to as “cable-side signal contacts 304 and 305” unless they are distinguished from each other. Additionally, first cable-side ground fitting 306 and second cable-side ground fitting 307 are referred to as “cable-side ground fittings 306 and 307” unless they are distinguished from each other. FIG. 31 illustrates disassembled cable-side signal contacts 304 and 305, cable-side ground fittings 306 and 307, and ground plate 308, which are assembled to cable-side insulator 303.

Cover shell 302, cable-side signal contacts 304 and 305, cable-side ground fittings 306 and 307, and ground plate 308 are formed of a conductive material such as metal (e.g., copper alloy). Cable-side insulator 303 is formed of an insulating material such as a synthetic resin (e.g., liquid crystal polymer).

Cover shell 302 is placed to cover the outside of cable-side connector body 301 and is in contact with and electrically connected to ground plate 308 of cable-side connector body 301. Cover shell 302 is at ground potential and functions as a shield. Like cable-side insulator 303, cover shell 302 may be formed of an insulating material such as a synthetic resin and form a housing of cable-side connector 3A.

In addition, locking member 309 is attached to cover shell 302 to secure the fitting state of connector set 3. Locking member 309 is rotatably attached to cover shell 302 and capable of opening and closing the end of cable-side connector 3A on the positive side in the X-axis direction.

Cable-side insulator 303 forms a housing of cable-side connector 3A. Cable-side signal contacts 304 and 305, cable-side ground fittings 306 and 307, and ground plate 308 are assembled to cable-side insulator 303. Cable-side signal contacts 304 and 305, cable-side ground fittings 306 and 307, and ground plate 308 are integrally formed with cable-side insulator 303 by, for example, insert molding. Cable-side signal contacts 304 and 305, cable-side ground fittings 306 and 307, and ground plate 308 are placed apart and electrically insulated from each other by cable-side insulator 303.

Ground plate 308 is a ground member connected to the ground, which is the reference potential, together with cable-side ground fittings 306 and 307. Ground plate 308 is formed by, for example, sheet metal working (including punching and bending) of a single metal sheet. Ground plate 308 includes flat first plate portion 308a extending along the XY plane.

Cable-side signal contacts 304 and 305 are members connected to internal conductors 11 of cables C. To be more specific, first cable-side signal contacts 304 are connected to internal conductors 11 of first cables C1 placed in the upper row. Second cable-side signal contacts 305 are connected to internal conductors 11 of second cables C2 placed in the lower row. Cable-side signal contacts 304 and 305 are each formed by, for example, sheet metal working (including punching and bending) of a single metal sheet.

Cable-side signal contacts 304 and 305 have similar configurations and include signal line contact sections 304a and 305a, signal line connection sections 304b and 305b, and signal line relay sections 304c and 305c, respectively. Signal line relay sections 304c and 305c connect signal line contact sections 304a and 305a and signal line connection sections 304b and 305b.

Signal line contact sections 304a and 305a contact and electrically connect to signal line contact sections 324a and 325a of board-side connector 3B when cable-side connector 3A and board-side connector 3B are mated with each other (see FIGS. 35A and 35B). Internal conductors 11 of cables C exposed by stripping processing on the tips are connected to signal line connection sections 304b and 305b by a mechanical joining method such as soldering, welding, crimping, or the like.

Cable-side signal contacts 304 and 305 have a straight shape extending in the X-axis direction (mating direction).

Cable-side signal contacts 304 and 305 are each in pairs connected to the same cable C, and are aligned in the Y-axis direction, which is the pitch direction. First cable-side signal contacts 304 form first cable-side contact row L11 together with first cable-side ground contacts 316, which will be described later. Second cable-side signal contacts 305 form second cable-side contact row L12 together with second cable-side ground contacts 317, which will be described later.

Distance W1 between cable-side signal contacts 304 respectively connected to adjacent cables C in the Y-axis direction is wider than distance W2 between cable-side signal contacts 304 connected to the same cable C (see FIG. 31). The same applies to cable-side signal contacts 305. Hereinafter, cable-side signal contacts 304 and 305 respectively connected to adjacent cables C in the Y-axis direction are simply referred to as “adjacent cable-side signal contacts 304 and 305.”

Cable-side signal contacts 304 and 305 are arranged so that the main surfaces (plate surfaces) are along ground plate 308. First cable-side signal contacts 304 are arranged on the upper surface of cable-side insulator 303 so as to face the (upper) surface of ground plate 308 on the positive side in the Z-axis direction. Second cable-side signal contacts 305 are arranged on the lower surface of cable-side insulator 303 so as to face the (lower) surface of ground plate 308 on the negative side in the Z-axis direction.

The first main surface (upper surface) of first plate portion 308a of ground plate 308 faces first cable-side signal contacts 304. The second main surface (lower surface) of first plate portion 308a of ground plate 308 faces second cable-side signal contacts 305. That is, planar ground elements formed by ground plate 308 are placed for a plurality of cable-side signal contacts 304 and 305 aligned in the Y-axis direction.

Thus, ground plate 308 extends to shield between signal line connection sections 304b of first cable-side signal contacts 304 and signal line connection sections 305b of second cable-side signal contacts 305. Ground plate 308 also extends to shield between signal line relay sections 304c of first cable-side signal contacts 304 and signal line relay sections 305c of second cable-side signal contacts 305 over the entire length of signal line relay sections 304c and 305c. Further, ground plate 308 extends to shield between signal line contact sections 304a of first cable-side signal contacts 304 and signal line contact sections 305a of second cable-side signal contacts 305.

First cable-side signal contacts 304 and second cable-side signal contacts 305 have a symmetrical structure with respect to ground plate 308. The symmetrical structure is a structure securing electrical equivalency with respect to ground plate 308. To be more specific, first cable-side signal contacts 304 and second cable-side signal contacts 305 have the same shape in a cross-section taken perpendicular to the extending direction, and the distances from each of signal line contact sections 304a, signal line relay sections 304c, and signal line connection sections 304b of first cable-side signal contacts 304 to ground plate 308 are respectively the same as the distances from each of signal line contact sections 305a, signal line relay sections 305c, and signal line connection sections 305b of second cable-side signal contacts 305 to ground plate 308.

Cable-side ground fittings 306 and 307 are ground members connected to the ground, which is the reference potential. To be more specific, first cable-side ground fitting 306 is connected to external shield layers 12 of first cables C1 placed in the upper row. Second cable-side ground fitting 307 is connected to external shield layers 12 of second cables C2 placed in the lower row. Cable-side ground fittings 306 and 307 are each formed by sheet metal working (including punching and bending) of a single metal sheet. Cable-side ground fittings 306 and 307 have similar configurations.

First cable-side ground fitting 306 includes a plurality of first cable-side ground contacts 316 each disposed between adjacent first cable-side signal contacts 304. Second cable-side ground fitting 307 includes a plurality of second cable-side ground contacts 317 each disposed between adjacent second cable-side signal contacts 305. In the following, first cable-side ground contacts 316 and second cable-side ground contacts 317 are referred to as “cable-side ground contacts 316 and 317” unless they are distinguished from each other.

Cable-side ground contacts 316 and 317 have ground contact sections 316a and 317a, ground connection sections 316b and 317b, and ground relay sections 316c and 317c, respectively. Ground relay sections 316c and 317c connect ground contact sections 316a and 317a and ground connection sections 316b and 317b.

Similar to cable-side signal contacts 304 and 305, cable-side ground contacts 316 and 317 have a straight shape extending in the X-axis direction (mating direction). The shapes of cable-side ground contacts 316 and 317 are substantially the same as the shapes of cable-side signal contacts 304 and 305.

Cable-side ground contacts 316 and 317 are aligned in the Y-axis direction, which is the pitch direction. Cable-side ground contacts 316 and 317 are each disposed between adjacent cable-side signal contacts 304 and 305.

Ground contact sections 316a of first cable-side ground contacts 316 are each disposed between signal line contact sections 304a of adjacent first cable-side signal contacts 304 and shield between signal line contact sections 304a. In addition, on the positive side in the X-axis direction, end sections 316e of ground contact sections 316a of the plurality of first cable-side ground contacts 316 are connected to each other, so that the ground is equipotentialized. In the XZ cross section, end sections 316e each have a tapered portion that approaches ground plate 308 toward the positive side in the X-axis direction and a flat surface portion that contacts ground plate 308.

Likewise, ground contact sections 317a of second cable-side ground contacts 317 are each disposed between signal line contact sections 305a of adjacent second cable-side signal contacts 305 and shield between signal line contact sections 305a. In addition, on the positive side in the X-axis direction, end sections 317e of ground contact sections 317a of the plurality of second cable-side ground contacts 317 are connected to each other, so that the ground is equipotentialized. In the XZ cross section, end sections 317e each have a tapered portion that approaches ground plate 308 toward the positive side in the X-axis direction and a flat surface portion that contacts ground plate 308.

Ground contact sections 316a and 317a contact and electrically connect to board-side ground contacts 331 and 332 of board-side connector 3B when cable-side connector 3A and board-side connector 3B are mated with each other (see FIGS. 34A and 34B).

Ground connection sections 316b of the plurality of first cable-side ground contacts 316 are connected in the Y-axis direction and have a flat plate shape. Ground connection sections 316b collectively hold external shield layers 12 of first cables C1 together with upper ground bar 311 from the positive and negative sides in the Z-axis direction, and are connected by a mechanical bonding method such as soldering, welding, crimping, or the like. The lower surfaces of ground connection sections 316b are in contact with and electrically connected to the upper surface of ground plate 308.

Likewise, ground connection sections 317b of the plurality of second cable-side ground contacts 317 are connected in the Y-axis direction and have a flat plate shape. Ground connection sections 317b collectively hold external shield layers 12 of second cables C2 together with lower ground bar 312 from the positive and negative sides in the Z-axis direction, and are connected by a mechanical bonding method such as soldering, welding, crimping, or the like. The upper surfaces of ground connection sections 317b are in contact with and electrically connected to the lower surface of ground plate 308.

First cable-side ground fitting 306 is placed at the surface of ground plate 308 on the positive side in the Z-axis direction. Second cable-side ground fitting 307 is placed at the surface of ground plate 308 on the negative side in the Z-axis direction.

Signal line contact sections 304a and 305a of cable-side signal contacts 304 and 305 and ground contact sections 316a and 317a of cable-side ground contacts 316 and 317 are exposed from the surface of a fitting portion of cable-side insulator 303. Signal line connection sections 304b and 305b of cable-side signal contacts 304 and 305 and ground connection sections 316b and 317b of cable-side ground contacts 316 and 317 are exposed from the surface of a cable placement portion of cable-side insulator 303.

Cable-side signal contacts 304 and cable-side ground contacts 316 are placed so that signal line contact sections 304a and ground contact sections 316a are flush with each other. In addition, cable-side signal contacts 305 and cable-side ground contacts 317 are placed so that signal line contact sections 305a and ground contact sections 317a are flush with each other. A similar design (e.g., spring characteristics) can be applied in spring pieces forming signal line contact sections 324a and 325a and spring pieces forming ground contact sections 331a and 332a in board-side connector 3B.

Ground relay section 316c of first cable-side ground contact 316 is provided with interconnection shielding sections 316d including two flat-plane shielding plates, which stand upright from both ends in the Y-axis direction to the positive side in the Z-axis direction and extend along the XZ plane. Interconnection shielding sections 316d are located between signal line connection sections 304b of two adjacent first cable-side signal contacts 304 among first cable-side signal contacts 304 connected to adjacent first cable C1, and are perpendicular to the facing direction of two signal line connection sections 304b. Further, the distance from one of the two shielding plates of each interconnection shielding section 316d to nearby first cable-side signal contact 304, and the distance from the other one of the shielding plates to nearby first cable-side signal contact 304 are the same. That is, two signal line connection sections 304b adjacent to interconnection shielding sections 316d are in a plane symmetrical arrangement with respect to the XZ plane passing through the midpoint between the two shielding plates of interconnection shielding section 316d.

Likewise, ground relay section 317c of second cable-side ground contact 317 is provided with interconnection shielding sections 317d including two flat-plane shielding plates, which extend downward from both ends in the Y-axis direction to the negative side in the Z-axis direction and extend along the XZ plane. Interconnection shielding sections 317d are located between signal line connection sections 305b of two adjacent second cable-side signal contacts 305 among first cable-side signal contacts 304 connected to adjacent first cable C1, and are perpendicular to the facing direction of two signal line connection sections 305b. Further, the distance from one of the two shielding plates of each interconnection shielding section 317d to nearby first cable-side signal contact 305, and the distance from the other one of the shielding plates to nearby first cable-side signal contact 305 are the same. That is, two signal line connection sections 305b adjacent to interconnection shielding sections 317d are in a plane symmetrical arrangement with respect to the XZ plane passing through the midpoint between the two shielding plates of interconnection shielding section 317d.

In cable-side connector 3A, ground contact sections 316a, which are at ground potential, are each disposed between signal line contact sections 304a of two adjacent cable-side signal contacts 304, and shield between signal line contact sections 304a. Likewise, ground contact sections 317a, which are at ground potential, are each disposed between signal line contact sections 305a of two adjacent cable-side signal contacts 305, and shield between signal line contact sections 305a.

Interconnection shielding sections 316d of first cable-side ground contacts 316 are each placed three-dimensionally so as to extend onto the XZ plane between signal line connection sections 304b of two adjacent cable-side signal contacts 304, and shield between signal line connection sections 304b. Likewise, interconnection shielding sections 317d of second cable-side ground contacts 317 are each placed three-dimensionally so as to extend onto the XZ plane between signal line connection sections 305b of two adjacent cable-side signal contacts 305, and shield between signal line connection sections 305b.

With interconnection shielding sections 316d and 317d, it is possible to improve EMS characteristics (e.g., characteristic impedance, insertion loss, return loss, crosstalk, etc.) in transmission lines, and to ensure favorable transmission quality. Further, two each of interconnection shielding sections 316d and 317d are provided and they have an even ground structure with respect to cable-side signal contacts 304 and 305, so that the transmission quality in two signal transmission lines is stabilized. To be more specific, since interconnection shielding sections 316d and 317d are formed at both ends in the Y-axis direction (width direction) by bending processing, the distance to cable-side signal contacts 304 and 305 can be easily adjusted by a setting of the bending position, and impedance control is also facilitated.

Ground plate 308 is in surface contact, at least in part, with cable-side ground contacts 316 and 317. To be more specific, ground plate 308 is interposed between end sections 316e and 317e of cable-side ground contacts 316 and 317 and they are in surface contact with each other. In addition, ground plate 308 is interposed between ground connection sections 316b and 317b of cable-side ground contacts 316 and 317 and they are in surface contact with each other.

In the present embodiment, signal line contact sections 304a and 305a of cable-side signal contacts 304 and 305 and ground contact sections 316a and 317a of cable-side ground contacts 316 and 317 are flush with each other in order to facilitate the designing of spring pieces in board-side connector 3B; accordingly, gaps are formed between ground plate 308 and cable-side ground contacts 316 and 317. In terms of ground reinforcement, ground plate 308 and cable-side ground contacts 316 and 317 may be made in contact with each other over as much of the entire surface as possible without gaps.

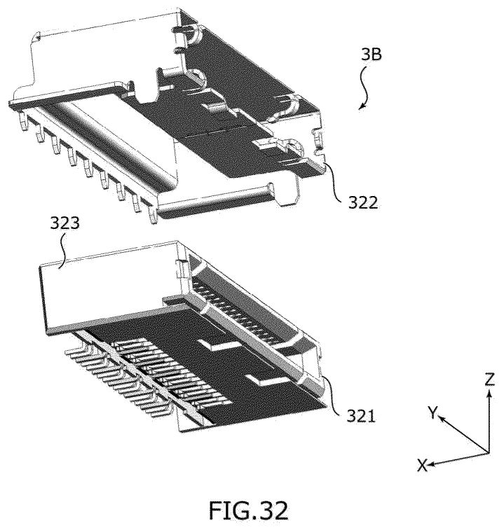

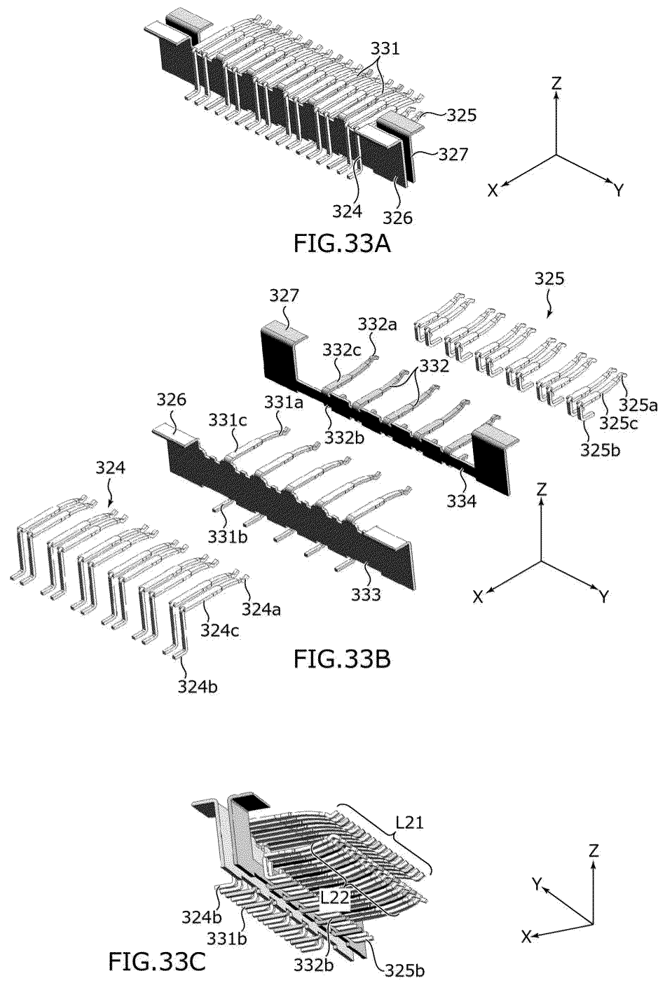

FIG. 32 is an exploded perspective view of board-side connector 3B to be mated with cable-side connector 3A, viewed from the negative side in the Z-axis direction. FIGS. 33A to 33C illustrate a contact structure in board-side connector body 321.

As illustrated in FIG. 32 and FIGS. 33A to 33C, board-side connector 3B includes board-side connector body 321 and board-side shell 322. Board-side connector body 321 includes board-side insulator 323, first board-side signal contacts 324, second board-side signal contacts 325, first board-side ground fitting 326, second board-side ground fitting 327, and the like.

In the following, first board-side signal contacts 324 and second board-side signal contacts 325 are referred to as “board-side signal contacts 324 and 325” unless they are distinguished from each other. Also, first board-side ground fitting 326 and second board-side ground fitting 327 are referred to as “board-side ground fittings 326 and 327” unless they are distinguished from each other. FIG. 33B illustrates board-side signal contacts 324 and 325 and board-side ground fittings 326 and 327, which are assembled to board-side insulator 323, shifted in the X-axis direction.

Board-side shell 322, board-side signal contacts 324 and 325, and board-side ground fittings 326 and 327 are formed of a conductive material such as metal (e.g., copper alloy). Board-side insulator 323 is formed of an insulating material such as a synthetic resin (e.g., liquid crystal polymer).

Board-side shell 322 is a frame connected to the ground pattern of circuit board B and has a rectangular shape corresponding to the outer edge of board-side insulator 323 in plan view from the Z-axis direction. Board-side shell 322 is formed by, for example, sheet metal working (including punching and bending) of a single metal sheet. Board-side shell 322 is placed to cover the outside of board-side connector body 321 and is in contact with and electrically connected to board-side ground fittings 326 and 327 of board-side connector body 321. Board-side shell 322 is at ground potential and functions as a shield. Board-side shell 322 is fitted to, for example, a peripheral portion of board-side insulator 323.

Board-side insulator 323 has a rectangular shape in plan view from the Z-axis direction and forms a housing of board-side connector 3B. Board-side signal contacts 324 and 325 and board-side ground fittings 326 and 327 are assembled to board-side insulator 323. Board-side signal contacts 324 and 325 and board-side ground fittings 326 and 327 are integrally formed with board-side insulator 323 by, for example, insert molding. Board-side signal contacts 324 and 325 and board-side ground fittings 326 and 327 are placed apart and electrically insulated from each other by board-side insulator 323.

Board-side signal contacts 324 and 325 are members respectively connected to cable-side signal contacts 304 and 305 of cable-side connector 3A. Board-side signal contacts 324 and 325 are formed by, for example, sheet metal working (including punching and bending) of a single metal sheet. Board-side signal contacts 324 and 325 are each in pairs, respectively corresponding to cable-side signal contacts 304 and 305, and are aligned in the Y-axis direction, which is the pitch direction. First board-side signal contacts 324 form first board-side contact row L21 together with first board-side ground contacts 331, which will be described later. Second board-side signal contacts 325 form second board-side contact row L22 together with second board-side ground contacts 332, which will be described later.

Board-side signal contacts 324 and 325 include signal line contact sections 324a and 325a, signal line surface-mounted sections 324b and 325b, and signal line relay sections 324c and 325c, respectively. Signal line relay sections 324c and 325c connect signal line contact sections 324a and 325a and signal line surface-mounted sections 324b and 325b.

Signal line contact sections 324a and 325a contact and electrically connect to signal line contact sections 304a and 305a of cable-side connector 3A when cable-side connector 3A and board-side connector 3B are mated with each other (see FIGS. 35A and 35B). Signal line surface-mounted sections 324b and 325b are connected to the signal pattern of circuit board B by soldering, for example.

Board-side signal contacts 324 and 325 have an L-shaped cross section in which signal line relay sections 324c and 325c extend from signal line contact sections 324a and 325a to the positive side in the X-axis direction (mating direction), bend by 90 degrees toward the negative side in the Z-axis direction, and reach signal line surface-mounted sections 324b and 325b.

Signal line contact sections 324a and 325a each have at the tips being free ends a spring piece (whose reference sign is omitted) that exerts biasing force against the facing surface. Signal line surface-mounted sections 324b of first board-side signal contacts 324 extend to the positive side in the X-axis direction, and signal line surface-mounted sections 325b of second board-side signal contacts 325 extend to the negative side in the X-axis direction. The extending length of signal line relay sections 324c of first board-side signal contacts 324 in the X-axis and Z-axis directions is longer than the extending length of signal line relay sections 325c of second board-side signal contacts 325 in the X-axis and Z-axis directions

Board-side signal contacts 324 and 325 are arranged so that their main surfaces (plate surfaces) face each other in the Z-axis direction.

Board-side ground fittings 326 and 327 respectively include a plurality of board-side ground contacts 331 and 332 connected to cable-side ground contacts 316 and 317 of cable-side connector 3A. Board-side ground contacts 331 and 332 include ground contact sections 331a and 332a, ground surface-mounted sections 331b and 332b, and ground relay sections 331c and 332c, respectively. Ground relay sections 331c and 332c connect ground contact sections 331a and 332a and ground surface-mounted sections 331b and 332b.

Ground contact sections 331a and 332a contact and electrically connect to ground contact sections 316a and 317a of cable-side connector 3A when cable-side connector 3A and board-side connector 3B are mated with each other (see FIGS. 34A and 34B). Ground surface-mounted sections 331b and 332b are connected to the signal pattern of circuit board B by soldering, for example.

Board-side ground contacts 331 and 332 have an L-shaped cross section in which ground relay sections 331c and 332c extend from ground contact sections 331a and 332a to the positive side in the X-axis direction (mating direction), bend by 90 degrees toward the negative side in the Z-axis direction, and reach ground surface-mounted sections 331b and 332b.

Ground contact sections 331a and 332a each have at the tips being free ends a spring piece (whose reference sign is omitted) that exerts biasing force against the facing surface. Ground surface-mounted sections 331b of first board-side ground contacts 331 extend to the positive side in the X-axis direction, and ground surface-mounted sections 332b of second board-side ground contacts 332 extend to the negative side in the X-axis direction. The extending length of ground relay sections 331c of first board-side ground contacts 331 in the X-axis and Z-axis directions is longer than the extending length of ground relay sections 332c of second board-side ground contacts 332 in the X-axis and Z-axis directions

Board-side ground contacts 331 and 332 are arranged so that their main surfaces (plate surfaces) face each other in the Z-axis direction.

In board-side ground fittings 326 and 327, the plurality of board-side ground contacts 331 and the plurality of board-side ground contacts 332 aligned in the Y-axis direction are respectively coupled by pin coupling sections 333 and 334 extending in the Y-axis direction, and are electrically and mechanically connected. Pin coupling sections 333 and 334 have a flat plate shape extending along the YZ plane, and the main surfaces are perpendicular to the X-axis direction (mating direction). The lower end portions of pin coupling sections 333 and 334 are connected to the ground pattern of circuit board B by soldering, for example, and function as the surface-mounted sections of board-side ground fittings 326. By providing pin coupling sections 333 and 334, the area of the ground element is increased, and the ground is equipotentialized.

Note that pin coupling sections 333 and 334 may each include a first plate portion along the YZ plane and a second plate portion along the XY plane, resulting in an L-shaped cross section viewed in the Y-axis direction, and board-side ground contacts 331 and 332 may be connected to the tip ends (end surfaces on the negative side in the X-axis direction) of the second plate portions.

Although board-side ground contacts 331 and 332 are coupled by pin coupling sections 333 and 334 in board-side ground fittings 326 and 327 in Embodiment 3, they may be separated from each other. That is, pin coupling sections 333 and 334 only need to be provided to couple at least two adjacent first board-side ground contacts 331 or two adjacent second board-side ground contacts 332.

For example, although all of first board-side ground contacts 331 and second board-side ground contacts 332 are respectively formed in single first board-side ground fitting 326 and single second board-side ground fitting 327 in the present embodiment, a plurality of board-side ground fittings 326 and 327 in which some first board-side ground contacts 331 and second board-side ground contacts 332 are formed may be placed along the Y-axis direction.

In addition, first board-side ground fitting 326 in which a plurality of first board-side ground contacts 331 are coupled by pin coupling section 333 and second board-side ground fitting 327 in which a plurality of second board-side ground contacts 332 are coupled by pin coupling section 334 may be configured by a single member. For example, a pair coupling section extending to the opposite of ground surface-mounted sections 331b and 332b may be provided to couple first board-side ground fitting 326 and second board-side ground fitting 327.

FIGS. 34A and 34B are sectional views illustrating the connection of grounds in connector set 3, and illustrate XZ sections between adjacent cables C in the Y-axis direction (pitch direction). FIG. 34A illustrates a state after cable-side connector 3A and board-side connector 3B are fitted, and FIG. 34B illustrates a state before cable-side connector 3A and board-side connector 3B are fitted.

FIGS. 35A and 35B are sectional views illustrating the connection of signal lines in connector set 3, and illustrate XZ sections through internal conductors 11 of cables C. FIG. 35A illustrates a state after cable-side connector 3A and board-side connector 3B are fitted, and FIG. 35B illustrates a state before cable-side connector 3A and board-side connector 3B are fitted.

As illustrated in FIGS. 34A and 34B, ground contact sections 316a and 317a of cable-side ground contacts 316 and 317 are fitted and electrically connected to ground contact sections 331a and 332a of board-side ground contacts 331 and 332.

In cable-side connector 3A, ground plate 308 is mechanically connected and integrated with cable-side ground contacts 316 and 317. Accordingly, board-side ground contacts 331 and 332 of board-side ground fittings 326 and 327 are electrically connected to ground plate 308 via cable-side ground contacts 316 and 317.

Further, as illustrated in FIGS. 35A and 35B, when cable-side connector 3A and board-side connector 3B are fitted, signal line contact sections 304a and 305a of cable-side signal contacts 304 and 305 are fitted and electrically connected to signal line contact sections 324a and 325a of board-side signal contacts 324 and 325.

Connector set 3 according to Embodiment 3 includes the following features alone or in combination as appropriate.

That is, connector set 3 includes board-side connector 3B (first connector) and counterpart cable-side connector 3A (second connector) that can be mated with board-side connector 3B. Board-side connector 3B includes board-side signal contacts 324 and 325 connected to signal lines and board-side ground contacts 331 and 332 connected to the ground. Board-side ground contacts 331 and 332 include a plurality of first board-side ground contacts 331 aligned in first board-side contact row L21 (first contact row) along the pitch direction, and first board-side ground contacts 331 are electrically and mechanically connected by pin coupling section 333.

Board-side connector 3B (first connector) includes board-side ground fitting 326, which is a single member formed with a plurality of first board-side ground contacts 331 and pin coupling section 333.

Pin coupling section 333 has a flat plate shape, and the main surface is perpendicular to the mating direction.

The same can be applied to cable-side connector 3A. That is, in cable-side connector 3A (first connector), a plurality of first cable-side ground contacts 316 aligned in first cable-side contact row L11 (first contact row) along the pitch direction are electrically and mechanically connected by a pin coupling section. The coupling section of ground connection sections 316b and the coupling section of end sections 316e correspond to the pin coupling section.

Cable-side connector 3A (first connector) includes first cable-side ground fitting 306, which is a single member formed with a plurality of first cable-side ground contacts 316 and the pin coupling section.

Cable-side connector 3A (second connector) includes cable-side signal contacts 304 and 305 (counterpart signal contacts) connected to board-side signal contacts 324 and 325, cable-side ground contacts 316 and 317 (counterpart ground contacts) connected to board-side ground contacts 331 and 332, and flat ground plate 308 connected to the ground. Cable-side signal contacts 304 and 305 include a plurality of first cable-side signal contacts 304 (first counterpart signal contacts) aligned in first cable-side contact row L11 (first counterpart contact row) along the pitch direction and connected to first board-side signal contacts 324, and the first main surface of ground plate 308 faces the plurality of first cable-side signal contacts 304.

Cable-side signal contacts 304 and 305 (counterpart signal contacts) include a plurality of second cable-side contacts 305 aligned in second cable-side signal contact row L12 (second counterpart contact row) along the pitch direction, and the second main surface of ground plate 308 faces second cable-side signal contacts 305.

Ground plate 308 is in surface contact, at least in part, with first cable-side ground contacts 316 and second cable-side ground contacts 317.

Ground plate 308 is mechanically connected and integrated with first cable-side ground contacts 316 and second cable-side ground contacts 317. Board-side ground fittings 326 and 327 make contact with first cable-side ground contacts 316 and second cable-side ground contacts 317 respectively and are electrically connected to ground plate 308 via first cable-side ground contacts 316 and/or second cable-side ground contacts 317.

Board-side ground fittings 326 and 327 support first cable-side ground contacts 316, second cable-side ground contacts 317, and ground plate 308 integrally by the spring force.

First cable-side signal contacts 304 and second cable-side signal contacts 305 respectively include signal line connection sections 304b and 305b connected to signal lines, signal line contact sections 304a and 305a connected to board-side signal contacts 324 and 325, and signal line relay sections 304c and 305c connecting signal line connection sections 304b and 305b and signal line contact sections 304a and 305a. Ground plate 308 extends to shield at least between signal line connection sections 304b of first cable-side signal contacts 304 and signal line connection sections 305b of second cable-side signal contacts 305.

Ground plate 308 extends to shield between signal line relay sections 304c of first cable-side signal contacts 304 and signal line relay sections 305c of second cable-side signal contacts 305 over the entire length of signal line relay sections 304c and 305c.

Ground plate 308 extends to shield between signal line contact sections 304a of first cable-side signal contacts 304 and signal line contact sections 305a of second cable-side signal contacts 305.

Cable-side connector 3A (second connector) includes cable-side signal contacts 304 and 305 connected to board-side signal contacts 324 and 325, cable-side ground contacts 316 and 317 connected to board-side ground contacts 331 and 332, and flat ground plate 308 connected to the ground. Cable-side signal contacts 304 and 305 include a plurality of first cable-side signal contacts 304 aligned in first cable-side contact row L11 (first counterpart contact row) along the pitch direction and connected to first board-side signal contacts 324, and a plurality of second cable-side contacts 305 aligned in second cable-side signal contact row L12 (second counterpart contact row) along the pitch direction and connected to second board-side signal contacts 325. Ground plate 308 is disposed between first cable-side contact row L11 and second cable-side contact row L12. First cable-side signal contacts 304 and second cable-side signal contacts 305 have a symmetrical structure with respect to ground plate 308.

First cable-side signal contacts 304 and second cable-side signal contacts 305 have the same shape in a cross-section taken perpendicular to the extending direction, and the distances from each of signal line contact sections 304a, signal line relay sections 304c, and signal line connection sections 304b of first cable-side signal contacts 304 to ground plate 308 are respectively the same as the distances from each of signal line contact sections 305a, signal line relay sections 305c, and signal line connection sections 305b of second cable-side signal contacts 305 to ground plate 308.

Cable-side connector 3A (second connector) is a wire-to-board cable-side connector connected to a plurality of cables C (coaxial cables) used for high-frequency signal transmission. The plurality of cables C include first cables C1 connected to first cable-side signal contacts 304 and second cables C2 connected to second cable-side signal contacts 305. First cables C1 and second cables C2 are pulled out in a direction parallel to the mating direction and stacked in a direction perpendicular to the mating direction. Ground plate 308 extends parallel to the mating direction and the pull-out direction of cables C.

Connector set 3 has the above-described features, which remarkably reinforces the ground structure. In addition, it is possible to improve EMS characteristics (e.g., characteristic impedance, insertion loss, return loss, crosstalk, etc.) in transmission lines, and to ensure favorable transmission quality. Further, a plurality of cables C can be connected to circuit board B collectively. Thus, it is possible to meet a requirement for wiring in an information device such as a server, and more particularly to enhance a high-speed transmission characteristic. It is also possible to improve the connection workability of cables C and reduce the size of the connector.

### Variation

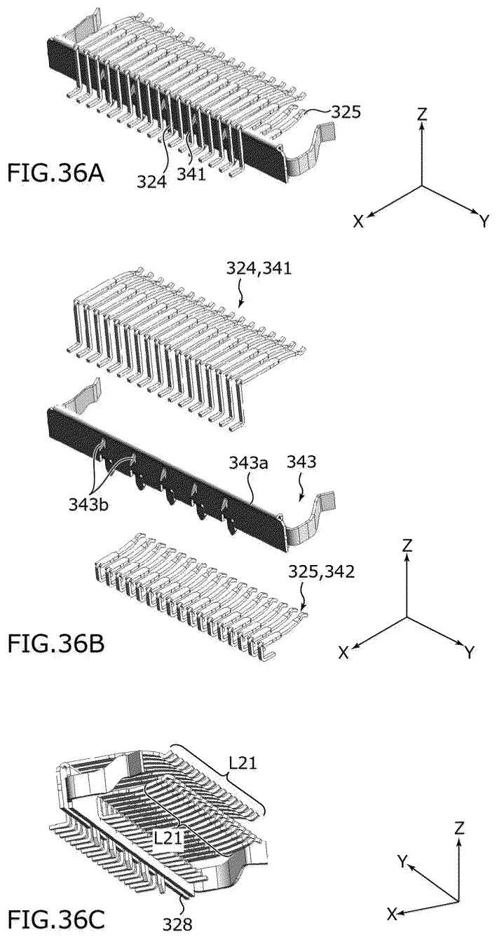

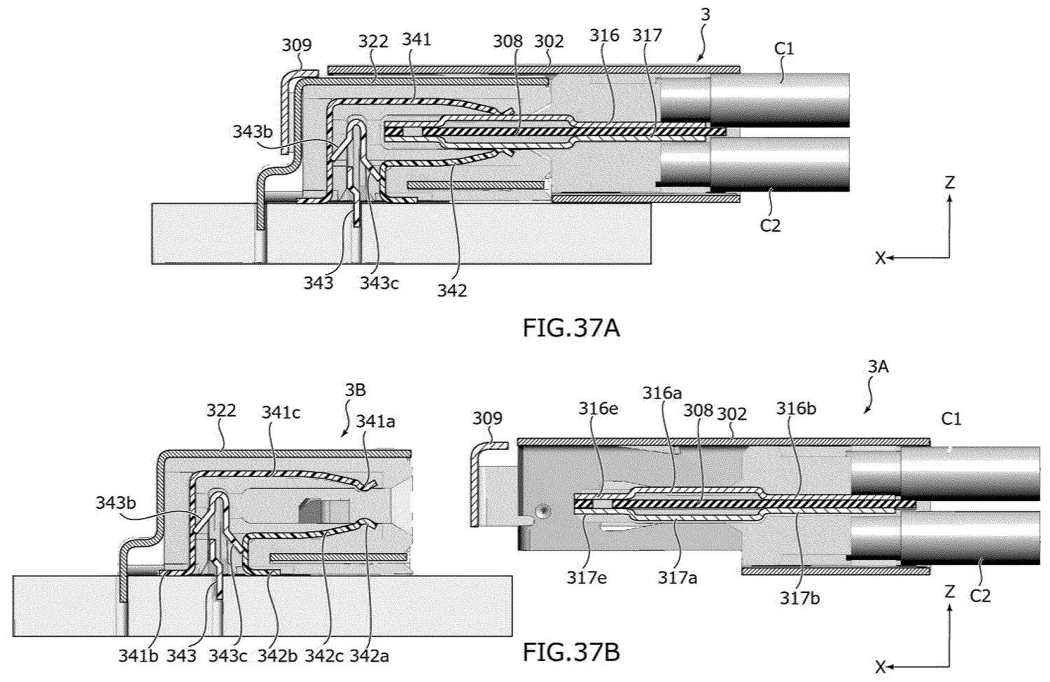

Board-side connector 3B may have the following configuration, for example. FIGS. 36A to 36C illustrate a contact structure in board-side connector body 321 according to the variation. FIGS. 37A and 37B are sectional views illustrating the connection of grounds in connector set 3 according to the variation, and illustrate XZ sections between adjacent cables C in the Y-axis direction (pitch direction). FIG. 37A illustrates a state after cable-side connector 3A and board-side connector 3B are fitted, and FIG. 37B illustrates a state before cable-side connector 3A and board-side connector 3B are fitted.

In the variation, the configuration of the board-side ground contact is different from that in Embodiment 3. That is, board-side ground contacts 341 and 342 according to the variation have the same shape as board-side signal contacts 324 and 325 placed in the same row.

Coupling ground fitting 343 is disposed between board-side ground contacts 341 and 342. Coupling ground fitting 343 includes coupling plate portion 343a, first contact pieces 343b, and second contact pieces 343c.

Coupling plate portion 343a has a flat plate shape extending along the YZ plane, and the main surface is perpendicular to the X-axis direction (mating direction). First contact pieces 343b are provided on one surface of coupling plate portion 343a and make contact with first board-side ground contacts 341. Second contact pieces 343c are provided on the other surface of coupling plate portion 343a and make contact with second board-side ground contacts 342. Coupling ground fitting 343 couples a plurality of first board-side ground contacts 341 and a plurality of second board-side ground contacts 342 aligned in the Y-axis direction.

That is, coupling ground fitting 343 functions as a pin coupling section coupling a plurality of board-side ground contacts 341 aligned in first board-side contact row L21. Likewise, coupling ground fitting 343 functions as a pin coupling section coupling a plurality of board-side ground contacts 342 aligned in second board-side contact row L22. Further, coupling ground fitting 343 functions as a pair coupling section coupling first board-side ground contacts 341 and second board-side ground contacts 342 facing in the Z-axis direction.

### Embodiment 4

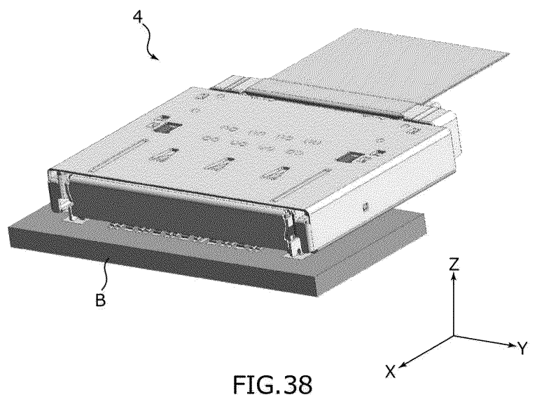

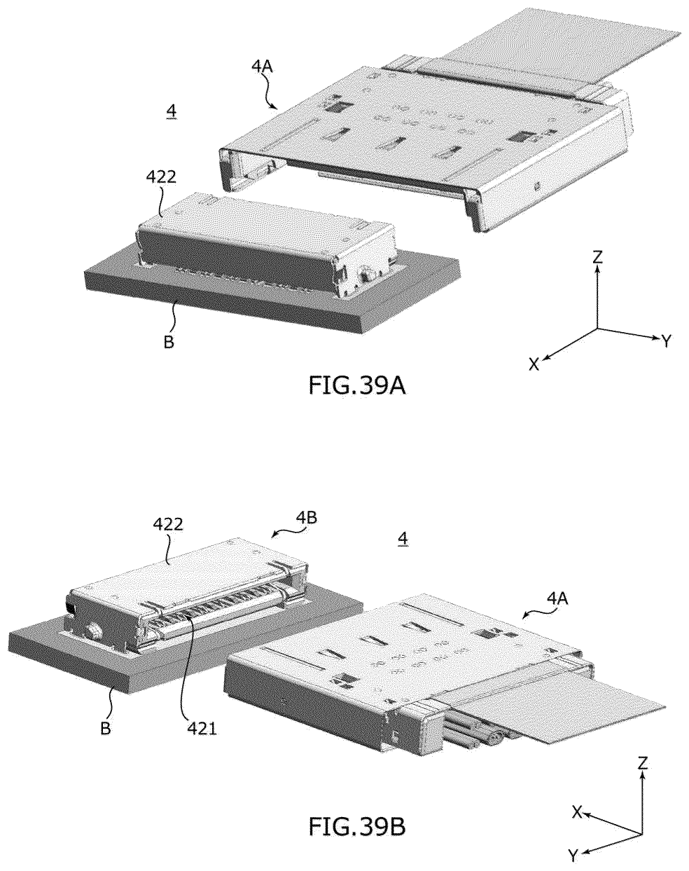

FIG. 38 illustrates the appearance of connector set 4 according to Embodiment 4 to which the present invention is applied. FIGS. 39A and 39B are exploded perspective views of connector set 4. Note that the description of components common to those in Embodiment 3 may be omitted.

Connector set 4 is a horizontal fitting type wire-to-board connector set, where the Y-axis direction is the pitch direction of connector set 4, and the X-axis direction is the mating direction of connector set 4. Connector set 4 is used, for example, to interconnect circuit boards using cables C in an information device such as a server, a switch (network device), and storage.

As illustrated in FIGS. 38, 39A, and 39B, connector set 4 includes cable-side connector 4A and board-side connector 4B. Cable-side connector 4A is a connector to which cables C are connected, and board-side connector 4B is a connector to be mounted on circuit board B.

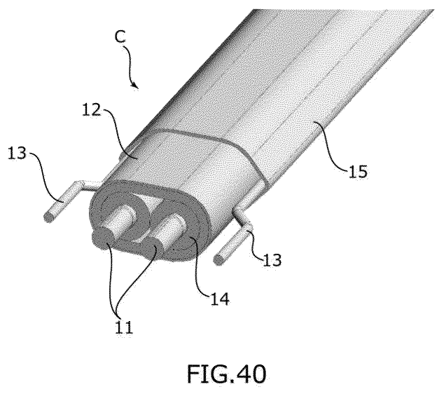

Each of cables C includes internal conductors 11 and external shield layer 12 placed outside internal conductors 11 via insulator 14 (see FIG. 40). Internal conductors 11 of cable C are used, for example, for high-speed (high-frequency) signal transmission.

In the present embodiment, as shown in FIG. 40, a Twinax cable is used for cable C, which is obtained by sheathing two insulated wires, which have internal conductors 11 (core wires) covered by insulator 14, collectively by external shield layer 12 and sheath 15. External shield layer 12 is composed of a metal foil composite film, for example, made by laminating metal foil (such as aluminum foil or copper foil) and a resin film on each other, and is disposed such that the metal foil is positioned on the outer surface. For external shield layer 12, for example, Alpet (registered trademark), which is a laminate of aluminum foil and polyester film, is used. Between external shield layer 12 and sheath 15, drain wires 13, which can be used as a grounding wire, are longitudinally arranged along the entire length of cable C.

In the present embodiment, 8 Twinax cables C are arranged along the Y-axis direction, 4 cables in the upper row and 4 cables in the lower row, and they are connected to cable-side connector 4A. That is, cables C include 4 first cables C1 in the upper row and 4 second cables C2 in the lower row. Also, two discrete cables (whose reference sign is omitted) are arranged on both sides of the arrays of first cables C1 and second cables C2 in the Y-axis direction.

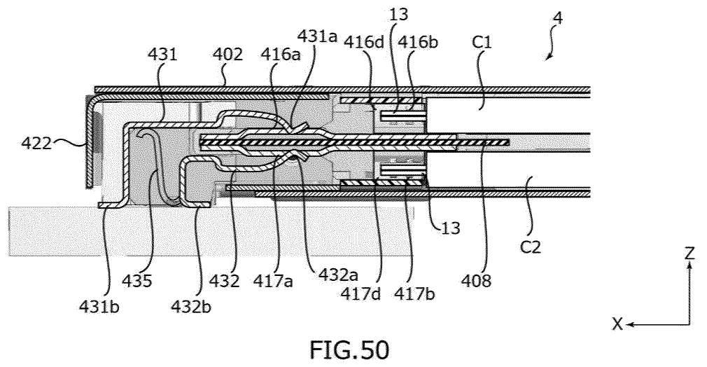

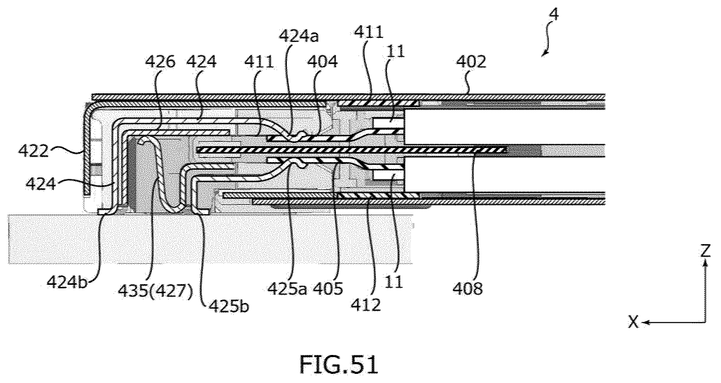

Connector set 4 electrically connects cables C to circuit board B by horizontal fitting of cable-side connector 4A and board-side connector 4B. Specifically, internal conductors 11 of cables C are electrically connected to the signal pattern of circuit board B via cable-side signal contacts 404 and 405 of cable-side connector 4A and board-side signal contacts 424 and 425 of board-side connector 4B (see FIG. 51). In addition, external shield layers 12 of cables C are connected to cable-side ground contacts 416 and 417 of cable-side connector 4A via drain wire 13 and are connected to the ground pattern of circuit board B via board-side ground contacts 431 and 432 of board-side connector 4B (see FIG. 50).

The specific configurations of cable-side connector 4A and board-side connector 4B will be described below.

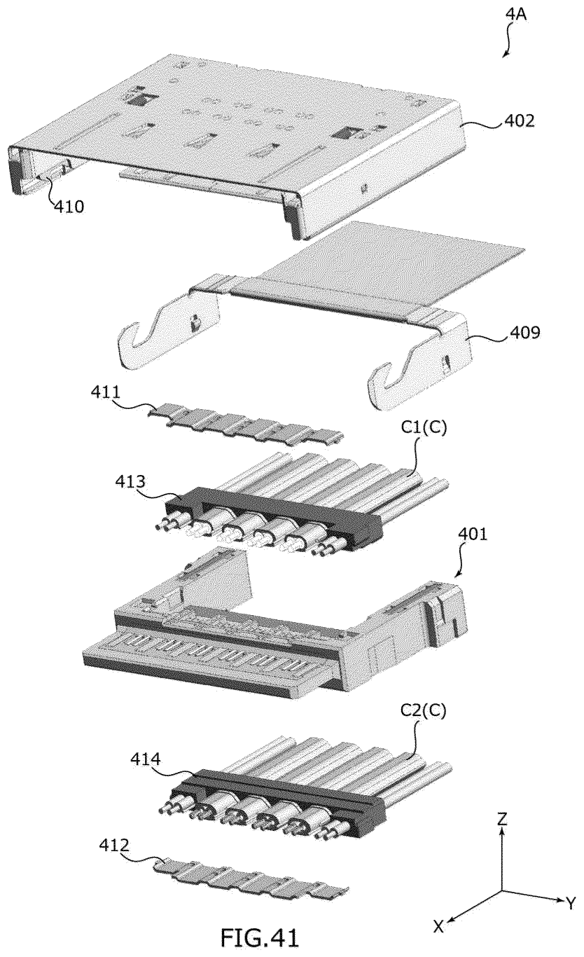

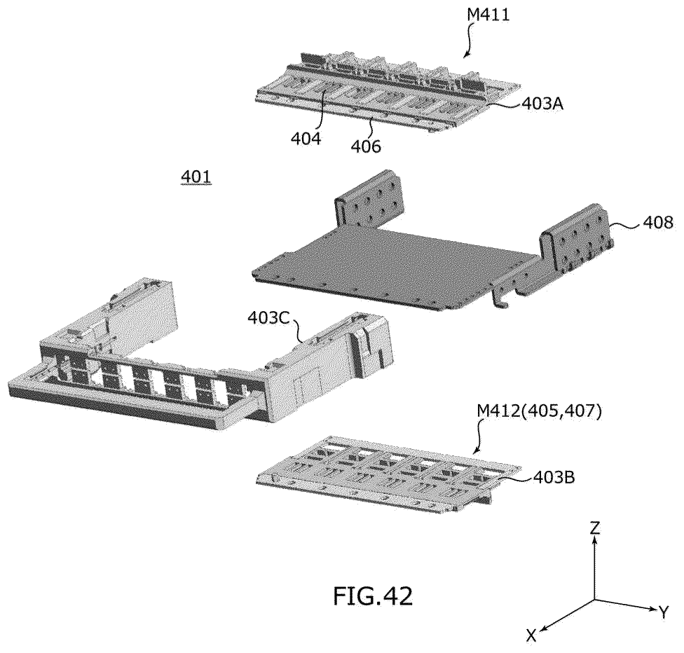

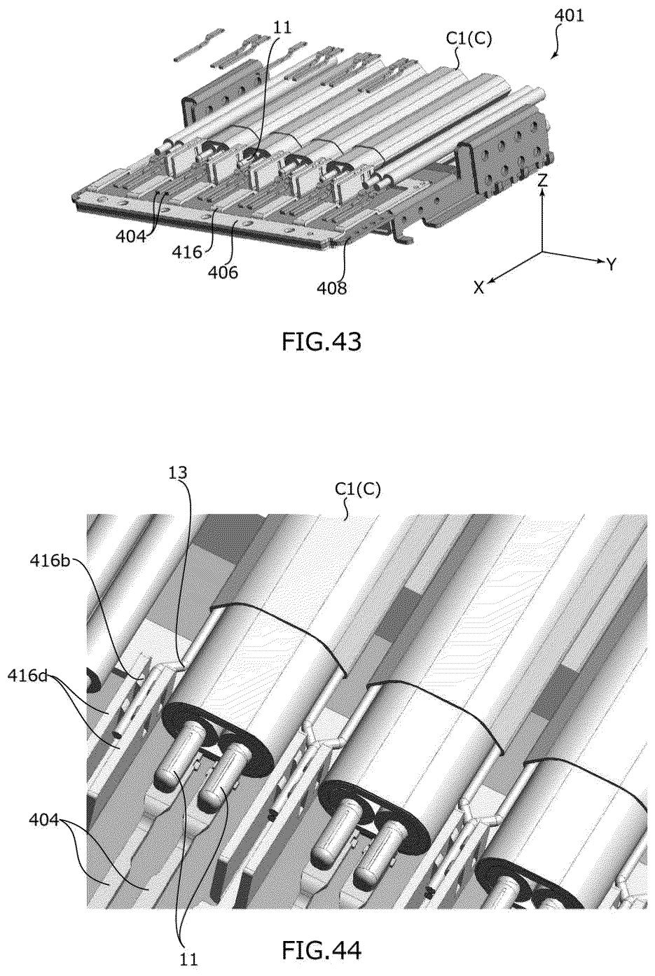

FIG. 41 is an exploded perspective view of cable-side connector 4A. FIG. 42 is an exploded perspective view of cable-side connector body 401. FIG. 43 is a perspective view showing how cables C are attached to cable-side connector body 401. In FIG. 43, cable-side insulator 403 is not illustrated. FIG. 44 is an enlarged view illustrating how cables C are attached to cable-side connector body 401.

As shown in FIG. 41 and the like, cable-side connector 4A includes cable-side connector body 401 and cover shell 402. Furthermore, cable-side connector body 401 includes cable-side insulator 403, first cable-side signal contacts 404, second cable-side signal contacts 405, first cable-side ground fitting 406, second cable-side ground fitting 407, ground plate 408, and the like.

When assembling cable-side connector 4A, first cables C1 and second cables C2 are held in alignment by resin cable holders 413 and 414. First cables C1 are attached to cable-side connector body 401 from above (positive side in the Z-axis direction), and second cables C2 are attached to cable-side connector body 401 from below (negative side in the Z-axis direction). After first cables C1 and second cables C2 are attached to cable-side connector body 401, connection-section protection plates 411 and 412 are placed to cover the connection part.

Cable-side connector body 401 includes first molded component M411, second molded component M412, ground plate 408, and third cable-side insulator 403C (see FIG. 42). First molded component M411 is positioned on the positive side relative to ground plate 408 in the Z-axis direction. Second molded component M412 is positioned on the negative side relative to ground plate 408 in the Z-axis direction.

First molded component M411 includes first cable-side signal contacts 404, first cable-side ground fitting 406, and first cable-side insulator 403A. First cable-side signal contacts 404, first cable-side ground fitting 406, and first cable-side insulator 403A are, for example, integrally formed by insert molding.

Second molded component M412 includes second cable-side signal contacts 405, second cable-side ground fitting 407, and second cable-side insulator 403B. Second cable-side signal contacts 405, second cable-side ground fitting 407, and second cable-side insulator 403B are, for example, integrally formed by insert molding.

Cable-side connector body 401 is manufactured by, for example, bonding first molded component M411 to second molded component M412 with ground plate 408 in between, and then forming third cable-side insulator 403C by insert molding (secondary molding). That is, in the present embodiment, cable-side insulator 403 is composed of first cable-side insulator 403A, second cable-side insulator 403B, and third cable-side insulator 403C.

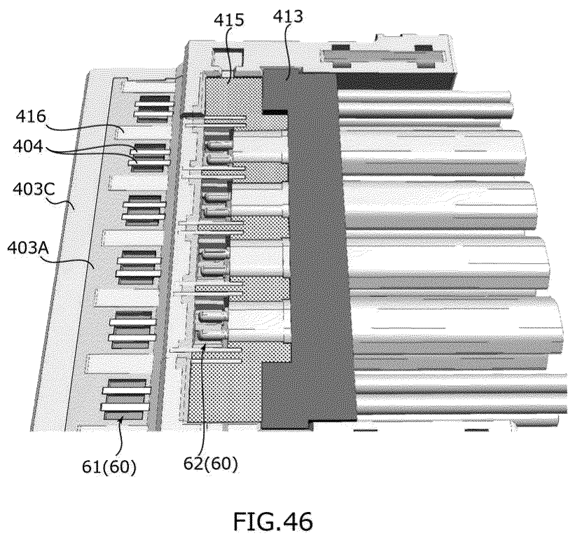

After first cables C1 and second cables C2 are attached to cable-side connector body 401, a resin material is poured between first cables C1, second cables C2, and cable-side insulator 403, forming connection-section reinforcement member 415 (see FIG. 46).

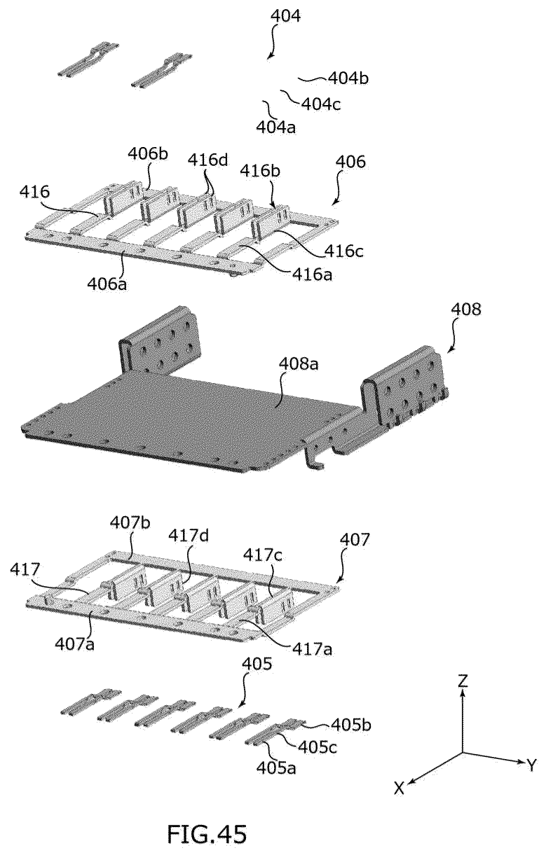

In the following, when not distinguishing between first cable-side signal contacts 404 and second cable-side signal contact 405, they are referred to as “cable-side signal contacts 404 and 405.” When not distinguishing between first cable-side ground fitting 406 and second cable-side ground fitting 407, they are referred to as “cable-side ground fittings 406, 407.” FIG. 45 shows an exploded view of cable-side signal contacts 404 and 405, cable-side ground fittings 406 and 407, and ground plate 408, which are assembled to cable-side insulator 403.

Cover shell 402, cable-side signal contacts 404 and 405, cable-side ground fittings 406 and 407, and ground plate 408 are formed of a conductive material such as metal (e.g., copper alloy). Cable-side insulator 403 is formed of an insulating material such as a synthetic resin (e.g., liquid crystal polymer).

Cover shell 402 is placed to cover the outside of cable-side connector body 401. Cover shell 402, for example, comes into contact with and is electrically connected to ground plate 408 of cable-side connector body 401. Cover shell 402 is at ground potential and functions as a shield. Furthermore, like cable-side insulator 403, cover shell 402 may be formed of an insulating material such as a synthetic resin and may form a housing of cable-side connector 4A.

Additionally, locking member 410 is attached to the inner surface of cover shell 402 to fix the mating state of connector set 4. Locking member 410 engages with removal operation member 409, and by pulling removal operation member 409 in the removal direction, the pulling force is transmitted to locking member 410, thereby releasing the locked state.

Cable-side insulator 403 forms a housing of cable-side connector 4A. As mentioned above, cable-side signal contacts 404 and 405, cable-side ground fittings 406 and 407, and ground plate 408 are assembled to cable-side insulator 403. Cable-side signal contacts 404 and 405, cable-side ground fittings 406 and 407, and ground plate 408 are integrally formed with cable-side insulator 403 by, for example, insert molding. Cable-side signal contacts 404 and 405, cable-side ground fittings 406 and 407, and ground plate 408 are placed apart and electrically insulated from each other by cable-side insulator 403.

Ground plate 408 is a ground member that is connected to the ground, which is the reference potential, together with cable-side ground fittings 406 and 407. Ground plate 408 is formed by, for example, sheet metal working (including punching and bending) of a single metal sheet. Ground plate 408 has flat first plate portion 408a that extends along the XY plane.

Cable-side signal contacts 404 and 405 are members connected to internal conductors 11 of cable C. Specifically, first cable-side signal contact 404 is connected to internal conductors 11 of first cables C1, which are placed in the upper row. Second cable-side signal contact 405 is connected to internal conductors 11 of second cables C2, which are placed in the lower row. Cable-side signal contacts 404 and 405 are formed by, for example, sheet metal working (including punching and bending) of a single metal sheet.

Cable-side signal contacts 404 and 405 have similar configurations and include signal line contact sections 404a and 405a, signal line connection sections 404b and 405b, and signal line relay sections 404c and 405c, respectively. Signal line relay sections 404c and 405c connect signal line contact sections 404a and 405a to signal line connection sections 404b and 405b.

Signal line contact sections 404a and 405a contact and electrically connect to signal line contact sections 424a and 425a of board-side connector 4B when cable-side connector 4A and board-side connector 4B are mated with each other (see FIG. 51). Internal conductors 11 of cables C exposed by stripping processing on the tips are connected to signal line connection sections 404b and 405b by a mechanical joining method such as soldering, welding, crimping, or the like.

Cable-side signal contacts 404 and 405 have a linear shape extending in the X-axis direction (mating direction).

Cable-side signal contacts 404 and 405 are connected as a pair to the same cable C, and are aligned in the Y-axis direction, which is the pitch direction. First cable-side signal contacts 404 form first cable-side contact row L11 together with first cable-side ground contacts 416, which will be described later. Second cable-side signal contacts 405 form second cable-side contact row L12 together with second cable-side ground contacts 417, which will be described later. Note that first cable-side contact row L11 and second cable-side contact row L12 are as described in Embodiment 3, etc.

As also described in Embodiment 3, distances W1 between cable-side signal contacts 404 and 405 connected to adjacent cables C in the Y-axis direction are wider than distances W2 between cable-side signal contacts 404 and 405 connected to the same cables C. Hereinafter, adjacent cable-side signal contacts 404 and 405 among cable-side signal contacts 404 and 405 connected to adjacent cables C in the Y-axis direction are simply referred to as “adjacent cable-side signal contacts 404 and 405.”

Cable-side signal contacts 404 and 405 are arranged so that the main surfaces (plate surfaces) are along ground plate 408. First cable-side signal contacts 404 are placed on the upper surface of cable-side insulator 403 so as to face the positive side surface (upper surface) of ground plate 408 in the Z-axis direction. Second cable-side signal contacts 405 are placed on the lower surface of cable-side insulator 403 so as to face the negative side surface (lower surface) of ground plate 408 in the Z-axis direction.

The first main surface (upper surface) of first plate portion 408a of ground plate 408 faces first cable-side signal contacts 404. Also, the second main surface (lower surface) of first plate portion 408a of ground plate 408 faces second cable-side signal contacts 405. That is, planar ground elements by ground plate 408 are placed for a plurality of cable-side signal contacts 404 and 405 arranged in the Y-axis direction.

Thus, ground plate 408 extends to shield between signal line connection sections 404b of first cable-side signal contacts 404 and signal line connection sections 405b of second cable-side signal contacts 405. Furthermore, ground plate 408 extends to shield between signal line relay sections 404c of first cable-side signal contacts 404 and signal line relay sections 405c of second cable-side signal contacts 405 over the entire length of signal line relay sections 404c and 405c. Moreover, ground plate 408 extends to shield between signal line contact sections 404a of first cable-side signal contacts 404 and signal line contact sections 405a of second cable-side signal contacts 405.

Also, first cable-side signal contacts 404 and second cable-side signal contacts 405 have a symmetrical structure with respect to ground plate 408. The symmetrical structure is a structure securing electrical equivalency with respect to ground plate 408. Specifically, first cable-side signal contacts 404 and second cable-side signal contacts 405 have the same cross-sectional shape orthogonal to the extending direction, and the distance from signal line contact sections 404a, signal line relay sections 404c, and signal line connection sections 404b of first cable-side signal contacts 404 to ground plate 408 is the same as the distance from signal line contact sections 405a, signal line relay sections 405c, and signal line connection sections 405b of second cable-side signal contacts 405 to ground plate 408.

Cable-side ground fittings 406 and 407 are ground members connected to the ground, which is the reference potential. Specifically, first cable-side ground fitting 406 is electrically connected to external shield layers 12 of first cables C1 placed in the upper row, via drain wires 13. Second cable-side ground fitting 407 is electrically connected to external shield layers 12 of second cables C2 placed in the lower row, via drain wires 13. Cable-side ground fittings 406 and 407 are each formed by sheet metal working (including punching and bending) of a single metal sheet. Cable-side ground fittings 406 and 407 have substantially similar configurations.

First cable-side ground fitting 406 is placed on the positive side surface of ground plate 408 in the Z-axis direction. Second cable-side ground fitting 407 is placed on the negative side of surface ground plate 408 in the Z-axis direction.

First cable-side ground fitting 406 includes a plurality of first cable-side ground contacts 416 each disposed between adjacent first cable-side signal contacts 404. Second cable-side ground fitting 407 includes a plurality of second cable-side ground contacts 417 each disposed between adjacent second cable-side signal contacts 405. In the following, first cable-side ground contacts 416 and second cable-side ground contacts 417 are referred to as “cable-side ground contacts 416 and 417” unless they are distinguished from each other.

Cable-side ground contacts 416 and 417 have ground contact sections 416a and 417a, ground connection sections 416b and 417b, and ground relay sections 416c and 417c, respectively. Ground relay sections 416c and 417c connect ground contact sections 416a and 417a to ground connection sections 416b and 417b, respectively. In the present embodiment, ground connection sections 416b and 417b are provided on the inner surfaces of interconnection shielding sections 416d and 417d.

Cable-side ground contacts 416 and 417 have a linear shape extending in the X-axis direction (mating direction), similar to cable-side signal contacts 404 and 405. Cable-side ground contacts 416 and 417 are formed wider than cable-side signal contacts 404 and 405.

Cable-side ground contacts 416 and 417 are aligned in the Y-axis direction, which is the pitch direction. Cable-side ground contacts 416 and 417 are each disposed between adjacent cable-side signal contacts 404 and 405.

Ground contact sections 416a of first cable-side ground contacts 416 are each disposed between signal line contact sections 404a of adjacent first cable-side signal contacts 404 among first cable-side signal contacts 404 connected to different first cables C1, and shield between signal line contact sections 404a. In addition, on the positive side in the X-axis direction, end sections 406a of ground contact sections 416a of the plurality of first cable-side ground contacts 416 are connected to each other, so that the ground is equipotentialized. End sections 406a have a flat surface portion that contacts ground plate 408.

Likewise, ground contact sections 417a of second cable-side ground contacts 417 are each disposed between signal line contact sections 405a of adjacent second cable-side signal contacts 405 among second cable-side signal contacts 405 connected to different second cables C2, and shield between signal line contact sections 405a. In addition, on the positive side in the X-axis direction, end sections 407a of ground contact sections 417a of the plurality of second cable-side ground contacts 417 are connected to each other, so that the ground is equipotentialized. End sections 407a have a tapered portion that approaches ground plate 408 as it goes toward the positive side in the X-axis direction in the XZ section, and a flat surface portion that contacts ground plate 408.

Ground contact sections 416a and 417a contact and electrically connect to board-side ground contacts 431 and 432 of board-side connector 4B when cable-side connector 4A and board-side connector 4B are mated with each other (see FIG. 50).

End sections 406b of interconnection shielding sections 416d of the plurality of first cable-side ground contacts 416 on the negative side in the X-axis direction are connected to one another in the Y-axis direction and have a flat plate shape. The lower surfaces of end sections 406b are in contact with and electrically connected to the upper surface of ground plate 408.

Likewise, end sections 407b of interconnection shielding sections 417d of the plurality of second cable-side ground contacts 417 on the negative side in the X-axis direction are connected to one another in the Y-axis direction and have a flat plate shape. The upper surfaces of end sections 407b are in contact with and electrically connected to the lower surface of ground plate 408.

Signal line contact sections 404a and 405a of cable-side signal contacts 404 and 405 and ground contact sections 416a and 417a of cable-side ground contacts 416 and 417 are exposed from the surface of a fitting portion of cable-side insulator 403. Signal line connection sections 404b and 405b of cable-side signal contacts 404 and 405 and ground connection sections 416b and 417b of cable-side ground contacts 416 and 417 are exposed from the surface of a cable placement portion of cable-side insulator 403.

Cable-side signal contacts 404 and cable-side ground contact 416 are placed so that signal line contact sections 404a and portions of ground contact section 416a are flush with each other. In addition, cable-side signal contacts 405 and cable-side ground contact 417 are placed so that signal line contact sections 405a and portions of ground contact section 417a are flush with each other. A similar design (e.g., spring characteristics) can be applied in spring pieces forming signal line contact sections 424a and 425a and spring pieces forming ground contact sections 431a and 432a in board-side connector 4B.

Ground relay sections 416c of first cable-side ground contact 416 are provided with interconnection shielding sections 416d including two flat-plane shielding plates, which stand upright from both ends in the Y-axis direction to the positive side in the Z-axis direction and extend along the XZ plane. Interconnection shielding sections 416d are located between signal line connection sections 404b of two adjacent first cable-side signal contacts 404 among first cable-side signal contacts 404 connected to adjacent first cables C1, and are perpendicular to the facing direction of two signal line connection sections 404b. Further, the distance from one of the two shielding plates of interconnection shielding sections 416d to nearby first cable-side signal contact 404, and the distance from the other one of the shielding plates to nearby first cable-side signal contact 404 are the same. That is, two signal line connection sections 404b adjacent to interconnection shielding sections 416d are in a plane symmetrical arrangement with respect to the XZ plane passing through the midpoint between the shielding plates of two interconnection shielding sections 416d.

Contact pieces functioning as ground connection sections 416b are provided on the inner surfaces (facing each other) of the two shielding plates of interconnection shielding sections 416d. The two shielding plates can clamp drain wire 13 that functions as the shield part of first cable C1. Drain wire 13 is placed in the space formed by the two shielding plates and is electrically connected to the shielding plates, for example, by soldering (see FIG. 44).

Although two drain wires 13 drawn from two first cables C1 placed on both sides of interconnection shielding section 416d are arranged in one space formed by the two shielding plates in the present embodiment, it may be configured to accommodate only one drain wire 13.

Likewise, ground relay section 417c of second cable-side ground contact 417 is provided with interconnection shielding sections 417d including two flat-plane shielding plates, which extend downward from both ends in the Y-axis direction to the negative side in the Z-axis direction and extend along the XZ plane. Interconnection shielding sections 417d are located between signal line connection sections 405b of two adjacent second cable-side signal contacts 405 among second cable-side signal contacts 405 connected to adjacent second cables C2, and are perpendicular to the facing direction of two signal line connection sections 405b. Further, the distance from one of the two shielding plates of interconnection shielding sections 417d to nearby second cable-side signal contact 405, and the distance from the other one of the shielding plates to nearby second cable-side signal contact 405 are the same. That is, two signal line connection sections 405b adjacent to interconnection shielding sections 417d are in a plane symmetrical arrangement with respect to the XZ plane passing through the midpoint between the shielding plates of two interconnection shielding sections 417d.

On the inner surfaces (facing each other) of the two shielding plates of interconnection shielding section 417d, there are contact pieces that function as ground connection section 417b. The two shielding plates can clamp drain wire 13 that functions as the shield part of second cable C2. Drain wire 13 is placed in the space formed by the two shielding plates and is electrically connected to the shielding plates, for example, by soldering.

In the present embodiment, two drain wires 13 drawn from the two second cables C2 located on both sides of interconnection shielding section 417d are arranged in one space formed by the two shielding plates, but it may be configured so that only one drain wire 13 is arranged.

Connection-section protection plates 411 and 412 are arranged so as to contact interconnection shielding sections 416d and 417d. Connection-section protection plates 411 and 412 contact the inner surface of cover shell 402. Cover shell 402 is electrically connected to interconnection shielding sections 416d and 417d through connection-section protection plates 411 and 412. Connection-section protection plates 411 and 412 and cover shell 402 may be connected, for example, by soldering.

In cable-side connector 4A, ground contact sections 416a, which are at ground potential, are each disposed between signal line contact sections 404a of two adjacent cable-side signal contacts 404, and shield between signal line contact sections 404a. Likewise, ground contact sections 417a, which are at ground potential, are each disposed between signal line contact sections 405a of two adjacent cable-side signal contacts 405, and shield between signal line contact sections 405a.

Additionally, interconnection shielding sections 416d of first cable-side ground contacts 416 are each placed three-dimensionally so as to extend in the XZ plane between signal line connection sections 404b of two adjacent cable-side signal contacts 404, and shield between signal line connection sections 404b. Likewise, interconnection shielding sections 417d of second cable-side ground contacts 417 are each placed three-dimensionally so as to extend in the XZ plane between signal line connection sections 405b of two adjacent cable-side signal contacts 405, and shield between signal line connection sections 405b.

By providing interconnection shielding sections 416d and 417d, it is possible to improve EMS characteristics (e.g., characteristic impedance, insertion loss, return loss, crosstalk, etc.) in transmission lines, and to ensure favorable transmission quality. Furthermore, two each of interconnection shielding sections 416d and 417d are provided, creating an even ground structure with respect to cable-side signal contacts 404 and 405, thereby stabilizing the transmission quality in two signal transmission lines. Specifically, since interconnection shielding sections 416d and 417d are formed at both ends in the Y-axis direction (width direction) by bending processing, the distance to cable-side signal contacts 404 and 405 can be easily adjusted by setting the bending position, making impedance control also easier.

Moreover, ground plate 408 is in surface contact, at least in part, with cable-side ground contacts 416 and 417. Specifically, ground plate 408 is interposed between end sections 406a and 407a of cable-side ground contacts 416 and 417, and they are in surface contact with each other. Additionally, ground plate 408 is interposed between portions of cable-side ground contacts 416 and 417 extending across ground relay sections 416c and 417c and end sections 406b and 407b, and is in surface contact with the portions.

In the present embodiment, to facilitate the design of spring pieces in board-side connector 4B, signal line contact sections 404a and 405a of cable-side signal contacts 404 and 405 and ground contact sections 416a and 417a of cable-side ground contacts 416 and 417 are made flush with each other, resulting in gaps formed between ground plate 408 and cable-side ground contacts 416 and 417. From the perspective of ground reinforcement, ground plate 408 and cable-side ground contacts 416 and 417 may be made to contact each other over as much of the entire surface as possible without gaps.

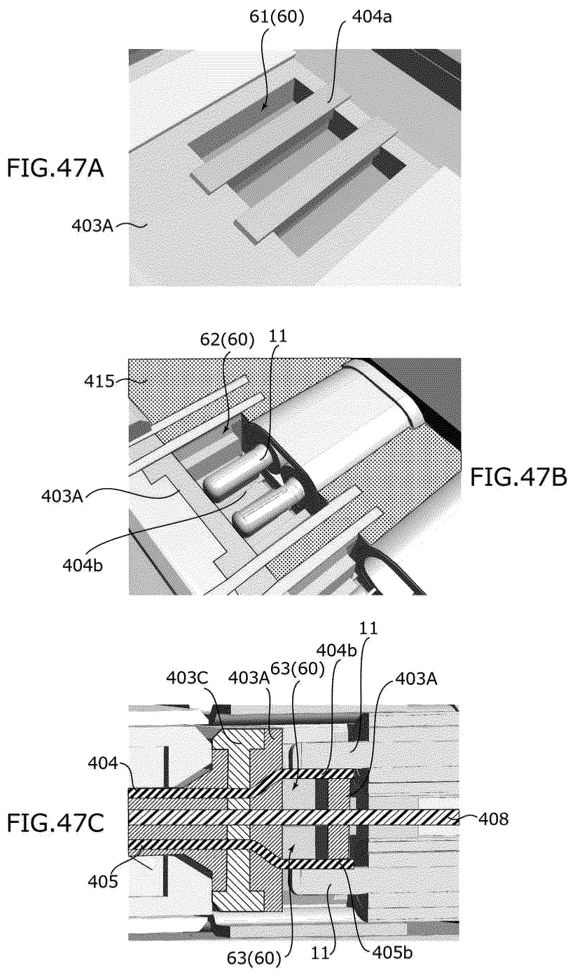

In the present embodiment, by forming voids 60 (see FIG. 46) in cable-side insulator 403 and connection-section reinforcement member 415, the impedance of cable-side signal contacts 404 and 405 is adjusted. An example of voids 60 is shown in FIGS. 47A to 47C.

In FIG. 47A, in first cable-side insulator 403A, voids 61 are provided around signal line contact sections 404a of first cable-side signal contacts 404. In the example shown in FIG. 47A, voids 61 are provided on both sides of first cable-side signal contacts 404. Although not shown, similarly, voids 61 are also provided around signal line contact sections 405a of second cable-side signal contacts 405 in second cable-side insulator 403B.

The end sections of signal line contact sections 404a and 405a of cable-side signal contacts 404 and 405 serve as open stubs, resulting in a low impedance state. In contrast, when voids 61 are provided around signal line contact sections 404a and 405a, the voids replace, with air, the resin that is the forming material of cable-side insulator 403 around signal line contact sections 404a and 405a, resulting in a higher impedance. Therefore, by appropriately designing the shape and size of voids 61, it is possible to cancel the impedance reduction caused by the stubs and improve the impedance characteristics.

In cable-side insulator 403, voids 61 formed around signal line contact sections 404a and 405a, for example, may be provided on the back side of cable-side signal contacts 404 and 405 (inside first cable-side insulator 403A and second cable-side insulator 403B).

In FIG. 47B, voids 62 are provided around signal line connection section 404b of first cable-side signal contact 404 in connection-section reinforcement member 415. Specifically, voids 62 are formed by preventing the flow of the forming material of connection-section reinforcement member 415 around signal line connection sections 404b. Although not shown, void 62 is similarly provided around signal line connection section 405b of second cable-side signal contact 405.

In FIG. 47C, voids 63 are provided around signal line connection sections 404b and 405b of cable-side signal contacts 404 and 405. In the example shown in FIG. 47C, voids 63 are provided on the back side of cable-side signal contacts 404 and 405.

Signal line connection sections 404b and 405b of cable-side signal contacts 404 and 405 become low impedance due to internal conductors 11, terminals mounted on the tips of internal conductors 11, or connecting materials such as solder. In contrast, when voids 62 and 63 are provided around signal line connection sections 404b and 405b, the voids replace, with air, the resin that is the forming material of cable-side insulator 403 around signal line connection sections 404b and 405b, resulting in a higher impedance. Therefore, by appropriately designing the shape and size of voids 62 and 63, it is possible to offset the reduction in impedance caused by the connecting material and improve impedance characteristics.

In cable-side insulator 403, void 63 formed around signal line connection sections 404b and 405b, for example, may be provided on both sides of cable-side signal contacts 404 and 405.

Cable-side insulator 403 forms a housing of cable-side connector 4A. Cable-side signal contacts 404 and 405, cable-side ground fittings 406 and 407, and ground plate 408 are assembled to cable-side insulator 403. Cable-side signal contacts 404 and 405, cable-side ground fittings 406 and 407, and ground plate 408 are integrally formed with cable-side insulator 403 by, for example, insert molding. Cable-side signal contacts 404 and 405, cable-side ground fittings 406 and 407, and ground plate 408 are placed apart and electrically insulated from each other by cable-side insulator 403.

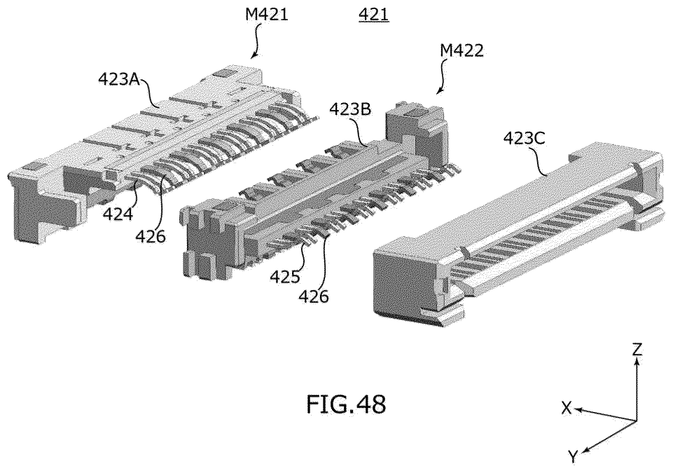

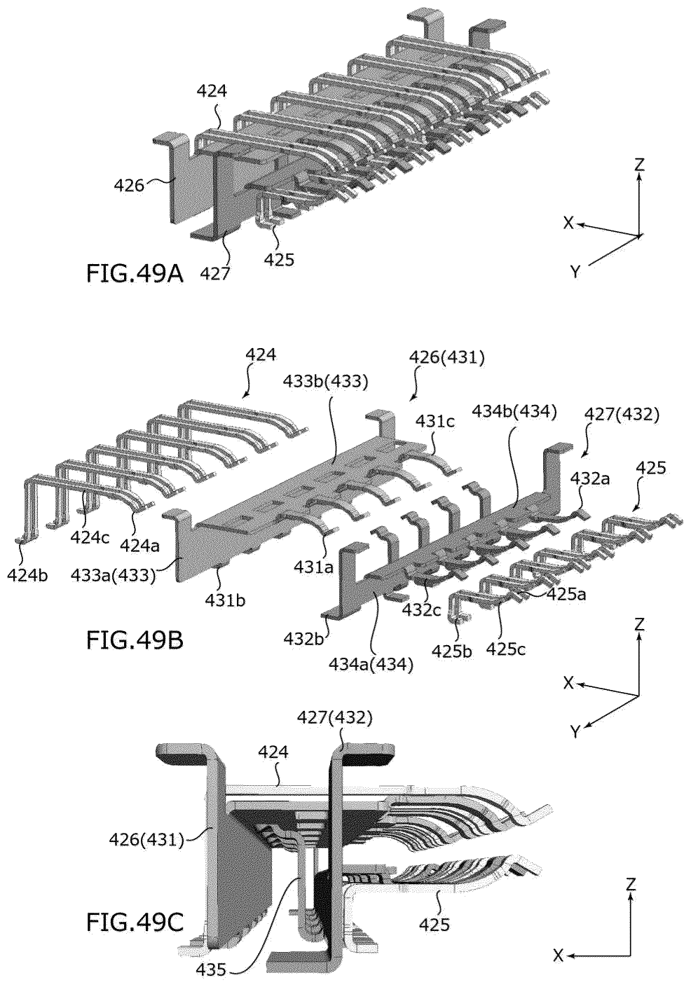

FIG. 48 is an exploded perspective view of board-side connector 4B to be mated with cable-side connector 4A. In FIG. 48, illustration of board-side shell 422 is omitted. FIGS. 49A to 49C illustrate a contact structure in board-side connector body 421.

As illustrated in FIGS. 48 and 49A to 49C, board-side connector 4B includes board-side connector body 421 and board-side shell 422. Additionally, board-side connector body 421 includes board-side insulator 423, first board-side signal contacts 424, second board-side signal contacts 425, first board-side ground fitting 426, and second board-side ground fitting 427, and the like.

Board-side connector body 421 includes first molded component M421, second molded component M422, and third board-side insulator 423C (see FIG. 48).

First molded component M421 includes first board-side signal contacts 424, first board-side ground fitting 426, and first board-side insulator 423A. First board-side signal contacts 424, first board-side ground fitting 426, and first board-side insulator 423A are integrally formed by, for example, insert molding.

Second molded component M422 includes second board-side signal contacts 425, second board-side ground fitting 427, and second board-side insulator 423B. Second board-side signal contacts 425, second board-side ground fitting 427, and second board-side insulator 423B are integrally formed by, for example, insert molding.

Board-side connector body 421 is manufactured by pressing first molded component M421 and second molded component M422, which have been primarily molded and have been fitted together in the X-axis direction, into separately molded third board-side insulator 423C from the positive side in the X-axis direction. That is, in the present embodiment, board-side insulator 423 is constituted by first board-side insulator 423A, second board-side insulator 423B, and third board-side insulator 423C.

In the following, first board-side signal contacts 424 and second board-side signal contacts 425 are referred to as “board-side signal contacts 424, 425” unless they are distinguished from each other. Additionally, first board-side ground fitting 426 and second board-side ground fitting 427 are referred to as “board-side ground fittings 426 and 427” unless they are distinguished from each other. FIG. 49B shows board-side signal contacts 424 and 425, and board-side ground fittings 426 and 427 assembled to board-side insulator 423, which are shifted in the X-axis direction.

Board-side shell 422, board-side signal contacts 424 and 425, and board-side ground fittings 426 and 427 are formed of a conductive material such as metal (e.g., copper alloy). Board-side insulator 423 is formed of an insulating material such as a synthetic resin (e.g., liquid crystal polymer).

Board-side shell 422 is a frame connected to the ground pattern of circuit board B and has a rectangular shape corresponding to the outer edge of board-side insulator 423 in plan view from the Z-axis direction. Board-side shell 422 is formed by, for example, sheet metal working (including punching and bending) of a single metal sheet. Board-side shell 422 is placed to cover the outside of board-side connector body 421 and is in contact with and electrically connected to board-side ground fittings 426 and 427 of board-side connector body 421. Board-side shell 422 is at ground potential and functions as a shield. Board-side shell 422 is fitted to, for example, a peripheral portion of board-side insulator 423.

Board-side insulator 423 has a rectangular shape in plan view from the Z-axis direction and forms a housing of board-side connector 4B. Board-side signal contacts 424 and 425 and board-side ground fittings 426 and 427 are assembled to board-side insulator 423. Board-side signal contacts 424 and 425 and board-side ground fittings 426 and 427 are integrally formed with board-side insulator 423 by, for example, insert molding. Board-side signal contacts 424 and 425 and board-side ground fittings 426 and 427 are placed apart and electrically insulated from each other by board-side insulator 423.

Board-side signal contacts 424 and 425 are members respectively connected to cable-side signal contacts 404 and 405 of cable-side connector 4A. Board-side signal contacts 424 and 425 are formed by, for example, sheet metal working (including punching and bending) of a single metal sheet. Board-side signal contacts 424 and 425 respectively correspond as a pair to cable-side signal contacts 404 and 405, and are aligned in the Y-axis direction, which is the pitch direction. First board-side signal contact 424 forms first board-side contact row L21 together with first board-side ground contact 431, which will be described later. Second board-side signal contact 425 forms second board-side contact row L22 together with second board-side ground contact 432, which will be described later.

Board-side signal contacts 424 and 425 have signal line contact sections 424a and 425a, signal line surface-mounted sections 424b and 425b, and signal line relay sections 424c and 425c, respectively. Signal line relay sections 424c and 425c connect signal line contact sections 424a and 425a to signal line surface-mounted sections 424b and 425b.

Signal line contact sections 424a and 425a contact and electrically connect to signal line contact sections 404a and 405a of cable-side connector 4A when cable-side connector 4A and board-side connector 4B are mated with each other (see FIG. 51). Signal line surface-mounted sections 424b and 425b are connected to the signal pattern of circuit board B by soldering, for example.

Board-side signal contacts 424 and 425 have an L-shaped section, with signal line relay sections 424c and 425c extending from signal line contact sections 424a and 425a on the positive side in the X-axis direction (mating direction) and bending 90° to the negative side in the Z-axis direction to reach signal line surface-mounted sections 424b and 425b.

Signal line contact sections 424a and 425a include a spring piece (whose reference sign is not illustrated) at the tips being free ends that exerts a biasing force against the facing surface. Signal line surface-mounted sections 424b of first board-side signal contact 424 extends to the positive side in the X-axis direction, and signal line surface-mounted sections 425b of second board-side signal contact 425 extend to the negative side in the X-axis direction. The length of each signal line relay section 424c of first board-side signal contact 424 extending in the X-axis and Z-axis directions is longer than the length of each signal line relay section 425c of second board-side signal contact 425 extending in the X-axis and Z-axis directions.

Board-side signal contacts 424 and 425 are arranged so that their main surfaces (plate surfaces) face each other in the Z-axis direction.

Board-side ground fittings 426 and 427 include a plurality of board-side ground contacts 431 and 432 that are connected to cable-side ground contacts 416 and 417 of cable-side connector 4A. Board-side ground contacts 431 and 432 have ground contact sections 431a and 432a, ground surface-mounted sections 431b and 432b, and ground relay sections 431c and 432c. Ground relay sections 431c and 432c connect ground contact sections 431a and 432a to ground surface-mounted sections 431b and 432b, respectively.

Ground contact sections 431a and 432a contact and electrically connect to ground contact sections 416a and 417a of cable-side connector 4A when cable-side connector 4A and board-side connector 4B are mated (see FIG. 50). Ground surface-mounted sections 431b and 432b are connected to the ground pattern of circuit board B by soldering, for example.

Board-side ground contacts 431 and 432 have an L-shaped section in which ground relay sections 431c and 432c extend from ground contact sections 431a and 432a to the positive side in the X-axis direction (mating direction), and bend 90 degrees to the negative side in the Z-axis direction, reaching ground surface-mounted sections 431b and 432b. In the present embodiment, parts of pin coupling sections 433 and 434 function as ground relay sections 431c and 432c.

Ground contact sections 431a and 432a have at the tips being free ends a spring piece (whose reference sign is omitted) that exerts biasing force against the facing surface. The ground surface-mounted section 431b of the first board-side ground contact 431 extends to the positive side in the X-axis direction, and the ground surface-mounted section 432b of the second board-side ground contact 432 extends to the positive side in the X-axis direction. The length of ground relay section 431c of the first board-side ground contact 431 extending in the X-axis and Z-axis directions is longer than the length of ground relay section 432c of the second board-side ground contact 432 extending in the X-axis and Z-axis directions.

Board-side ground contacts 431 and 432 are arranged so that their main surfaces (plate surfaces) face each other in the Z-axis direction.

In board-side ground fittings 426 and 427, a plurality of board-side ground contacts 431 and a plurality of board-side ground contacts 432 arranged in the Y-axis direction are connected by pin coupling sections 433 and 434 extending in the Y-axis direction, and are electrically and mechanically connected to one another.

Pin coupling sections 433 and 434 have first plate section 433a and 434a with a flat plate shape extending along the YZ plane, and second plate section 433b and 434b with a flat plate shape extending along the XY plane. That is, pin coupling sections 433 and 434 are formed in an L-shape in a section viewed from the Y-axis direction. First plate sections 433a and 434a have main surfaces perpendicular to the X-axis direction (mating direction), and second plate sections 433b and 434b have main surfaces parallel to the X-axis direction (mating direction).

Board-side ground contacts 431 and 432 are provided on board-side ground fittings 426 and 427 so as to protrude from the end surfaces of first plate sections 433a and 434a on the negative side in the Z-axis direction, and from the end surfaces of second plate sections 433b and 434b on the negative side in the X-axis direction.

The lower ends of pin coupling sections 433 and 434 are connected to the ground pattern of circuit board B by soldering, for example, and function as the surface-mounted sections of board-side ground fittings 426 and 427. By providing pin coupling sections 433 and 434, the area of the ground element is increased, and the ground is equipotentialized.

Second board-side ground fitting 427 includes ground coupling section 435 that is mechanically and electrically connected to first board-side ground fitting 426. Ground coupling section 435 functions as a pair coupling section. Ground coupling section 435, for example, protrudes from the lower end surfaces of first plate sections 434a of second board-side ground fitting 427, and is curved so that its free end at the tip contacts the lower surface of second plate sections 433b of first board-side ground fitting 426. By providing ground coupling section 435, the area of the ground element is increased, and the ground is equipotentialized. Note that the ground coupling section may be provided on first board-side ground fitting 426.

In Embodiment 4, although board-side ground contacts 431 and 432 in board-side ground fittings 426 and 427 are coupled by pin coupling sections 433 and 434, they may be configured as being separated from each other. That is, pin coupling sections 433 and 434 only need to be provided to couple at least two adjacent first board-side ground contacts 431 or two adjacent second board-side ground contacts 432.

For example, in the present embodiment, although all of first board-side ground contacts 431 and second board-side ground contacts 432 are formed respectively in single board-side ground fittings 426 and 427, a plurality of board-side ground fittings 426 and 427 in which some of first board-side ground contacts 431 and second board-side ground contacts 432 are formed may be placed along the Y-axis direction.

FIG. 50 is a sectional view illustrating the connection of grounds in connector set 4, and shows an XZ section through adjacent cables C in the Y-axis direction (pitch direction). FIG. 51 is a sectional view illustrating the connection of signal lines in connector set 4, and shows an XZ section through internal conductors 11 of cables C.

As shown in FIG. 50, ground contact sections 416a and 417a of cable-side ground contacts 416 and 417 are fitted and electrically connected to ground contact sections 431a and 432a of board-side ground contacts 431 and 432.

In cable-side connector 4A, ground plate 408 is mechanically connected and integrated with cable-side ground contacts 416 and 417. Accordingly, board-side ground contacts 431 and 432 of board-side ground fittings 426 and 427 are electrically connected to ground plate 408 via cable-side ground contacts 416 and 417.

As shown in FIG. 51, when cable-side connector 4A and board-side connector 4B are fitted, signal line contact sections 404a and 405a of cable-side signal contacts 404 and 405 are fitted and electrically connected to signal line contact sections 424a and 425a of board-side signal contacts 424 and 425.

Connector set 4 according to Embodiment 4 includes the following features alone or in combination as appropriate.

That is, connector set 4 includes cable-side connector 4A (first connector) and board-side connector 4B (second connector) that can be mated with cable-side connector 4A, in which cable-side connector 4A includes cable-side signal contacts 404 and 405 (signal contacts) connected to the signal line, cable-side ground contacts 416 and 417 (ground contacts) connected to the ground, and flat ground plate 408 connected to the ground. Cable-side signal contacts 404 and 405 include a plurality of first cable-side signal contacts 404 (first signal contacts) disposed to face the first main surface of ground plate 408, and cable-side ground contacts 416 and 417 include first cable-side ground contacts 416 disposed between adjacent first cable-side signal contacts 404, and first cable-side ground contacts 416 makes direct contact with the first main surface of ground plate 408.

In connector set 4, cable-side signal contacts 404 and 405 include a plurality of second cable-side signal contacts 405 disposed to face the second main surface of ground plate 408 opposite the first main surface, and cable-side ground contacts 416 and 417 include second cable-side ground contacts 417 disposed between adjacent second cable-side signal contacts 405, and second cable-side ground contacts 417 makes direct contact with the second main surface of the ground plate.

In connector set 4, ground plate 408 is mechanically connected and integrated with first cable-side ground contacts 416 and second cable-side ground contacts 417.

In connector set 4, cable-side signal contacts 404 and 405, cable-side ground contacts 416 and 417, and ground plate 408 are arranged so that first cable-side signal contacts 404 and second cable-side signal contacts 405 are electrically equivalent.

In connector set 4, first cable-side signal contacts 404 and second cable-side signal contacts 405 have a symmetrical structure with respect to ground plate 408.

In connector set 4, first cable-side signal contacts 404 and second cable-side signal contacts 405 have the same cross-sectional shape orthogonal to the direction of extension, and the distance from signal line contact section 404a, signal line relay section 404c, and signal line connection section 404b of first cable-side signal contact 404 to ground plate 408 is the same as the distance from signal line contact section 405a, signal line relay section 405c, and signal line connection section 405b of second cable-side signal contact 405 to ground plate 408.

In connector set 4, cable-side connector 4A (first connector) is a wire-to-board cable-side connector that connects to a plurality of cables C used for transmitting high-frequency signals. These multiple cables C include first cables C1 connected to first cable-side signal contacts 404 and second cables C2 connected to second cable-side signal contacts 405. First cables C1 and second cables C2 are drawn out in a direction parallel to the mating direction and are stacked in a direction perpendicular to the mating direction. Ground plate 408 includes a flat surface parallel to both the mating direction and the cable drawing direction.

In connector set 4, ground plate 408 is electrically connected to board-side ground contacts 431 and 432 (counterpart ground contacts) of board-side connector 4B (second connector) via first cable-side ground contacts 416 and second cable-side ground contacts 417.

In connector set 4, board-side ground contacts 431 and 432 (counterpart ground contacts) integrally support first cable-side ground contacts 416, second cable-side ground contacts 417, and ground plate 408 by spring force.

In connector set 4, a plurality of first cable-side ground contacts 416 are electrically and mechanically connected to one another.

In connector set 4, a plurality of first cable-side ground contacts 416 are electrically and mechanically connected to one another at least at one of the opposite end portions in the extending direction.

In connector set 4, first cable-side ground contacts 416 are incorporated into cable-side ground fitting 406 of a single member.

In connector set 4, first cable-side ground contacts 416 include interconnection shielding sections 416d (shielding sections) disposed between adjacent first cable-side signal contacts 404, and each of interconnection shielding sections 416d includes two shielding plates arranged to be perpendicular to the pitch direction.

In connector set 4, two first cable-side signal contacts 404 are disposed in the region sandwiched by interconnection shielding sections 416d of two first cable-side ground contacts 416.

In connector set 4, the distance from one first cable-side signal contact 404 disposed in the region sandwiched by two interconnection shielding sections 416d to one of interconnection shielding sections 416d adjacent to the one first cable-side signal contact 404 is the same as the distance from another first cable-side signal contact 404 to the other one of interconnection shielding sections 416d adjacent to the one first cable-side signal contact 404.

In connector set 4, the two shielding plates can clamp the shield part of cable C in the space formed by the two shielding plates.

In connector set 4, the shield part is drain wire 13 disposed longitudinally alongside cable C having a shield layer.

Furthermore, cable-side connector 4A includes cable-side signal contacts 404 and 405 connected to the signal line, cable-side ground contacts 416 and 417 connected to the ground, and flat ground plate 408 connected to the ground. Cable-side signal contacts 404 and 405 include a plurality of first cable-side signal contacts 404 disposed to face the first main surface of ground plate 408, and cable-side ground contacts 416 and 417 include first cable-side ground contacts 416 arranged between adjacent first cable-side signal contacts 404, and first cable-side ground contacts 416 make direct contact with the first main surface of ground plate 408.

Cable-side connector 4A is a wire-to-board connector that connects cable C used for transmitting high-frequency signals and circuit board B to each other by mating with board-side connector 4B (counterpart connector) mounted on circuit board B, the cable-side connector including a plurality of signal contacts 404 connected to internal conductors 11 (signal lines) of cables C, and interconnection shielding section 416d connected to the ground and disposed between two adjacent signal contacts 404, in which interconnection shielding section 416d includes two interconnection shielding plates provided between signal line connection sections 404b of two adjacent signal contacts 404 perpendicularly to the facing direction of signal line connection sections 404b.

Connector set 4 has the above-described features, which remarkably reinforces the ground structure. In addition, it is possible to improve EMS characteristics (e.g., characteristic impedance, insertion loss, return loss, crosstalk, etc.) in transmission lines, and to ensure favorable transmission quality. Further, a plurality of cables C can be connected to circuit board B collectively. Thus, it is possible to meet a requirement for wiring in an information device such as a server, and more particularly to enhance a high-speed transmission characteristic. It is also possible to improve the connection workability of cables C and reduce the size of the connector.

### Embodiment 5

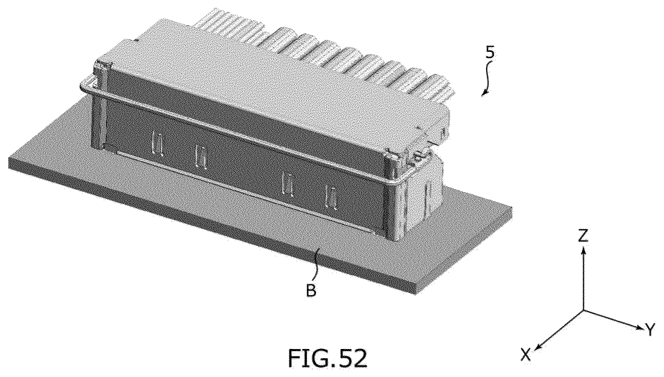

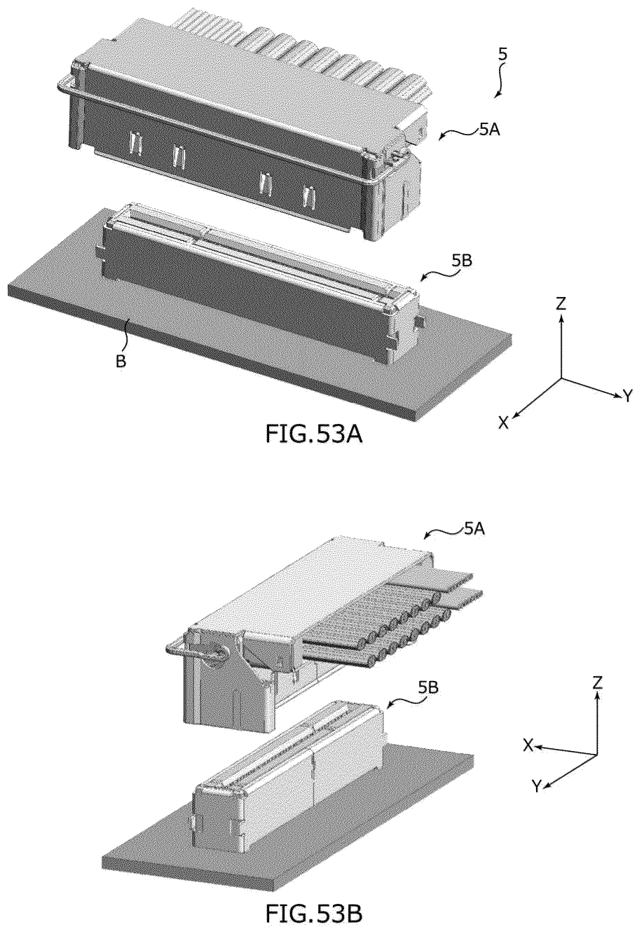

FIG. 52 illustrates the appearance of connector set 5 according to Embodiment 5 to which the present invention is applied. FIGS. 53A and 53B are exploded perspective views of connector set 5. Note that the description of components common to those in Embodiment 1 or Embodiment 4 may be omitted.

Connector set 5 is a vertical fitting type wire-to-board connector set, where the Y-axis direction is the pitch direction of connector set 5, and the Z-axis direction is the mating direction of connector set 5. Connector set 5 is used, for example, to interconnect circuit boards using cables C within information devices such as servers, switches (network devices), and storage.

As shown in FIG. 52 and others, connector set 5 includes cable-side connector 5A and board-side connector 5B. Cable-side connector 5A is a connector to which cables C are connected, and board-side connector 5B is a connector to be mounted on circuit board B.

In the present embodiment, 16 Twinax cables C are arranged along the Y-axis direction, 8 cables in the upper row and 8 cables in the lower row, and they are connected to cable-side connector 5A. That is, cables C include 8 first cables C1 in the upper row and 8 second cables C2 in the lower row. Also, eight discrete cables (whose reference sign is omitted) are arranged on the negative sides of first cables C1 and second cables C2 in the Y-axis direction. In the present embodiment as in Embodiment 4, Twinax cables including drain wires 13 are applied as cables C.

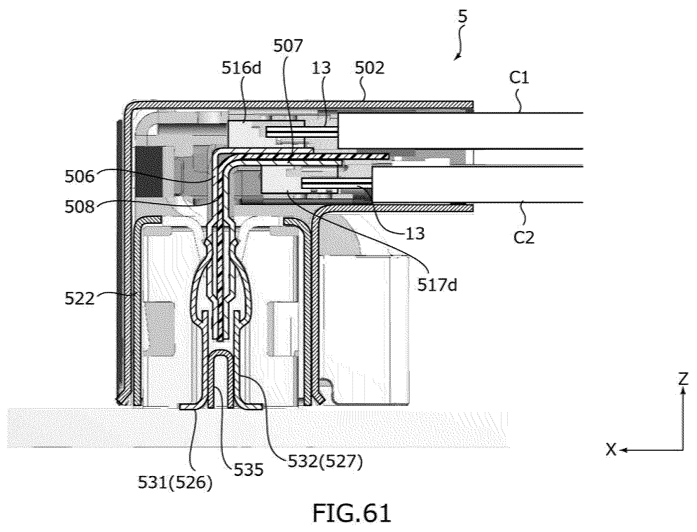

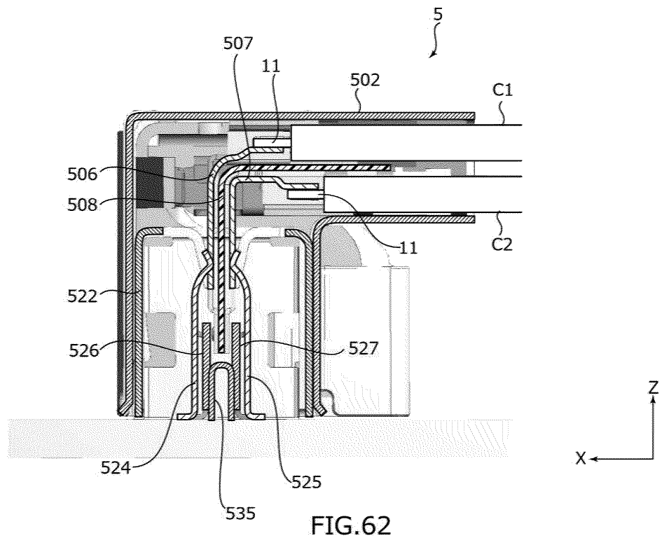

Connector set 5 electrically connects cables C to circuit board B by vertical fitting of cable-side connector 5A to board-side connector 5B. Specifically, internal conductors 11 of cables C are electrically connected to the signal pattern of circuit board B via cable-side signal contacts 504 and 505 of cable-side connector 5A and board-side signal contacts 524 and 525 of board-side connector 5B (see FIG. 62). In addition, external shield layers 12 of cables C are connected to cable-side ground contacts 516 and 517 of cable-side connector 5A via drain wires 13 and to the ground pattern of circuit board B via board-side ground contacts 531 and 532 of board-side connector 5B (see FIG. 61).

Below, the specific configurations of cable-side connector 5A and board-side connector 5B will be described.

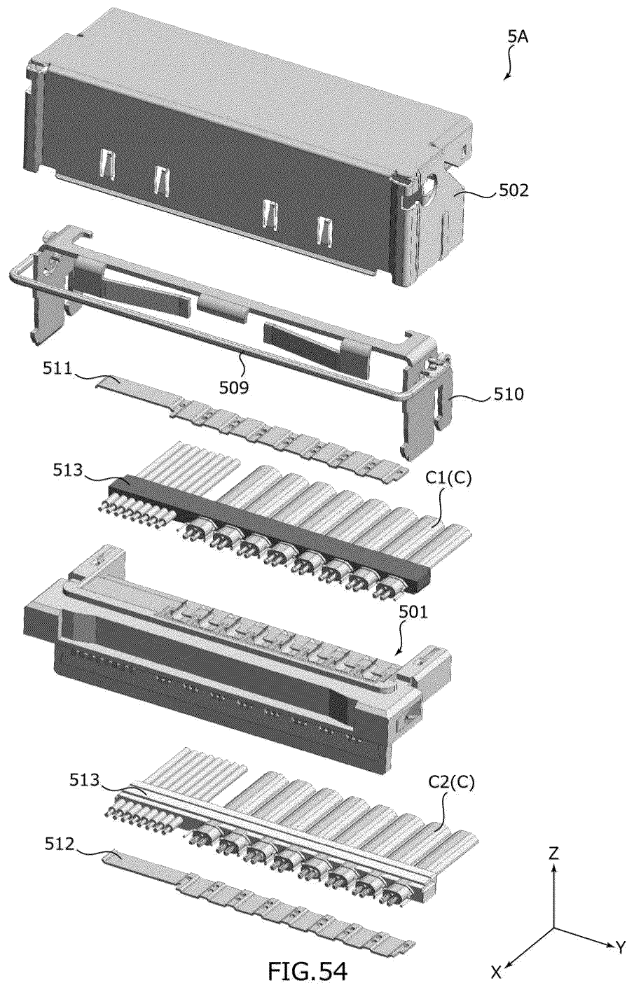

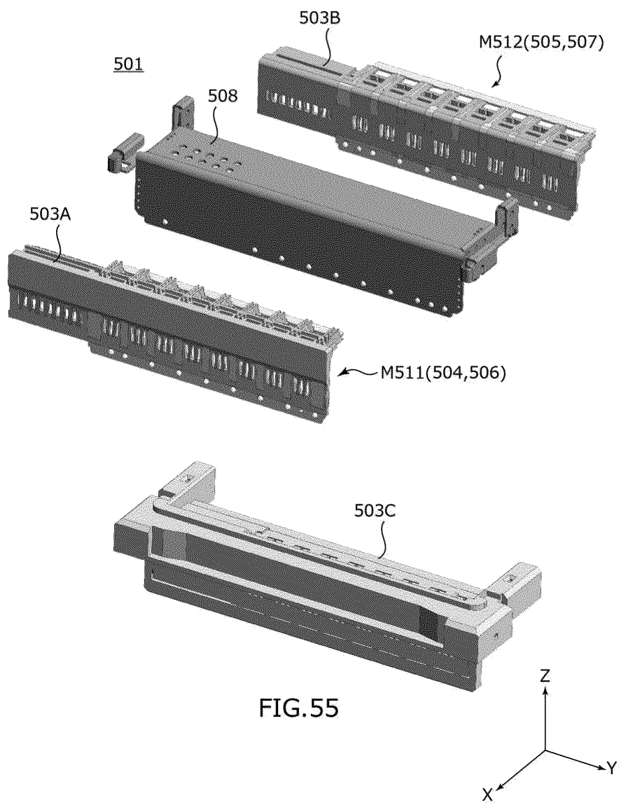

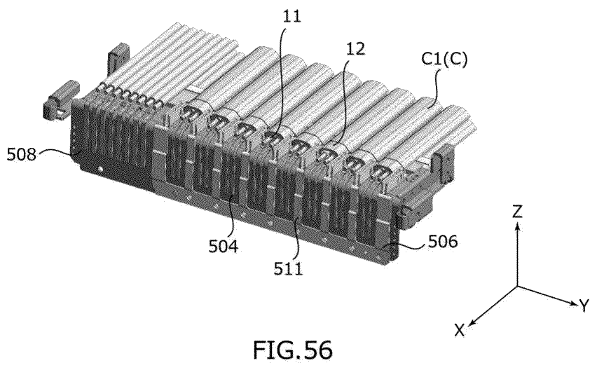

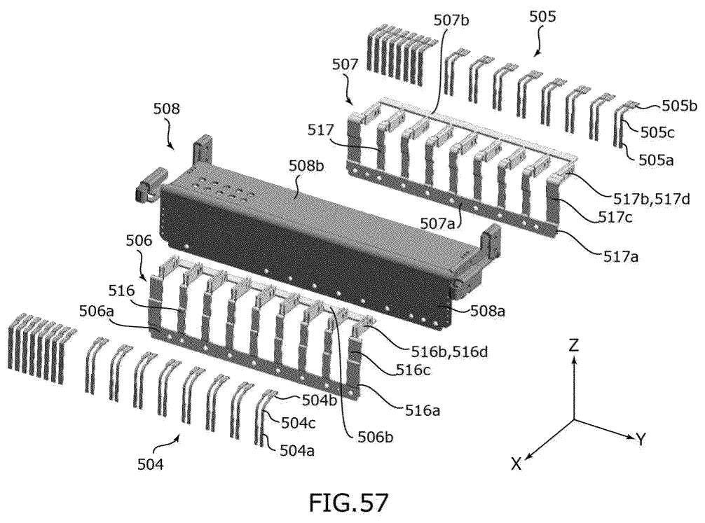

FIG. 54 is an exploded perspective view of cable-side connector 5A. FIG. 55 is an exploded perspective view of cable-side connector body 501. FIG. 56 is a perspective view illustrating how cables C are attached to cable-side connector body 501. In FIG. 56, cable-side insulator 503 is not illustrated. FIG. 57 is an enlarged view illustrating how cables C are attached to cable-side connector body 501.

As illustrated in FIG. 54 and the like, cable-side connector 5A includes cable-side connector body 501 and cover shell 502. Furthermore, cable-side connector body 501 includes cable-side insulator 503, first cable-side signal contacts 504, second cable-side signal contacts 505, first cable-side ground fitting 506, second cable-side ground fitting 507, ground plate 508, and the like.

When assembling cable-side connector 5A, first cables C1 and second cables C2 are held in an aligned state by resin cable holders 513 and 514, respectively. First cables C1 are attached to cable-side connector body 501 from above (positive side in the Z-axis direction), and second cables C2 are attached to cable-side connector body 501 from below (negative side in the Z-axis direction). After first cables C1 and second cables C2 are attached to cable-side connector body 501, connection section protection plates 511 and 512 are placed to cover the connection part.

Cable-side connector body 501 includes first molded component M511, second molded component M512, ground plate 508, and third cable-side insulator 503C (see FIG. 55). First molded component M511 is positioned on the positive side in the X-axis direction relative to ground plate 508. Second molded component M512 is positioned on the negative side in the X-axis direction relative to ground plate 508.

First molded component M511 includes first cable-side signal contacts 504, first cable-side ground fitting 506, and first cable-side insulator 503A. First cable-side signal contacts 504, first cable-side ground fitting 506, and first cable-side insulator 503A are, for example, integrally formed by insert molding.

Second molded component M512 includes second cable-side signal contacts 505, second cable-side ground fitting 507, and second cable-side insulator 503B. Second cable-side signal contacts 505, second cable-side ground fitting 507, and second cable-side insulator 503B are, for example, integrally formed by insert molding.

Cable-side connector body 501 is produced by, for example, laminating primarily molded first molded body M511 and second molded body M512 on each other with ground plate 508 in between, and forming third cable-side insulator 503C by insert molding (secondary molding). That is, in the present embodiment, cable-side insulator 503 is constituted by first cable-side insulator 503A, second cable-side insulator 503B, and third cable-side insulator 503C.

After first cables C1 and second cables C2 are mounted on cable-side connector body 501, a resin material is poured between first cable C1 and second cable C2 and cable-side insulator 503, forming a connection reinforcement member (see Embodiment 4).

In the following, when not distinguishing between first cable-side signal contact 504 and the second cable-side signal contacts 505, they are referred to as “cable-side signal contacts 504 and 505.” When not distinguishing between first cable-side ground fitting 506 and second cable-side ground fitting 507, they are referred to as “cable-side ground fittings 506 and 507.” FIG. 57 shows an exploded view of cable-side signal contacts 504 and 505, cable-side ground fittings 506 and 507, and ground plate 508 assembled to cable-side insulator 503.

Cover shell 502, cable-side signal contacts 504 and 505, cable-side ground fittings 506 and 507, and ground plate 508 are formed of a conductive material such as metal (e.g., copper alloy). Cable-side insulator 503 is formed of an insulating material such as a synthetic resin (e.g., liquid crystal polymer).

Cover shell 502 is arranged to cover the outside of cable-side connector body 501. Cover shell 502, for example, comes into contact with ground plate 508 of cable-side connector body 501 and is electrically connected thereto. Cover shell 502 becomes at ground potential and functions as a shield. Furthermore, cover shell 502 may be formed of an insulating material such as a synthetic resin, as in cable-side insulator 503, and may form a housing of cable-side connector 5A.

Additionally, locking member 510 is attached to the inner surface of cover shell 502 to fix the mating state of connector set 5. Locking member 510 engages with removal operation member 509, and by rotating removal operation member 509 around the axis of rotation, the rotational force is transmitted to locking member 510, thereby releasing the locked state.

Cable-side insulator 503 forms the housing of cable-side connector 5A. As mentioned above, cable-side signal contacts 504 and 505, cable-side ground fittings 506 and 507, and ground plate 508 are assembled to cable-side insulator 503. Cable-side signal contacts 504 and 505, cable-side ground fittings 506 and 507, and ground plate 508 are integrally formed with cable-side insulator 503 by, for example, insert molding. Cable-side signal contacts 504 and 505, cable-side ground fittings 506 and 507, and ground plate 508 are placed apart and electrically insulated from each other by cable-side insulator 503.

Ground plate 508 is a ground member connected to the ground, which is the reference potential, together with cable-side ground fittings 506 and 507. Ground plate 508 is formed by, for example, sheet metal working (including punching and bending) of a single metal sheet. Ground plate 508 includes first plate portion 508a and second plate portion 508b. First plate portion 508a has a planar shape extending along the YZ plane. Second plate portion 508b has a planar shape extending along the XY plane.

Cable-side signal contacts 504 and 505 are members connected to internal conductors 11 of cables C. To be more specific, first cable-side signal contacts 504 are connected to internal conductors 11 of first cables C1 placed in the upper row. Second cable-side signal contacts 505 are connected to internal conductors 11 of second cables C2 placed in the lower row. Cable-side signal contacts 504 and 505 are each formed by, for example, sheet metal working (including punching and bending) of a single metal sheet.

Cable-side signal contacts 504 and 505 have similar configurations and include signal line contact sections 504a and 505a, signal line connection sections 504b and 505b, and signal line relay sections 504c and 505c, respectively. Signal line relay sections 504c and 505c connect signal line contact sections 504a and 505a to signal line connection sections 504b and 505b.

Signal line contact sections 504a and 505a contact and electrically connect to signal line contact sections 524a and 525a of board-side connector 5B when cable-side connector 5A and board-side connector 5B are mated with each other (see FIG. 62). Internal conductors 11 of cables C exposed by stripping processing on the tips are connected to signal line connection sections 504b and 505b by a mechanical joining method such as soldering, welding, crimping, or the like.

Cable-side signal contacts 504 and 505 have an L-shaped section in which signal line relay sections 504c and 505c extend from signal line contact sections 504a and 505a to the positive side in the Z-axis direction (mating direction), bend by 90 degrees toward the negative side in the X-axis direction (pull-out direction of cables C), and reach signal line connection sections 504b and 505b.

Cable-side signal contacts 504 and 505 are connected as a pair to the same cables C, and are aligned in the Y-axis direction, which is the pitch direction. First cable-side signal contacts 504 form first cable-side contact row L11 together with first cable-side ground contacts 516, which will be described later. Second cable-side signal contacts 505 form second cable-side contact row L12 together with second cable-side ground contacts 517, which will be described later. First cable-side contact row L11 and second cable-side contact row L12 are as described in Embodiment 3, etc.

As described also in Embodiment 3, distance W1 between cable-side signal contacts 504 or 505 connected to adjacent cables C in the Y-axis direction is wider than distance W2 between cable-side signal contacts 504 or 505 connected to the same cable C. Hereinafter, adjacent two cable-side signal contacts among cable-side signal contacts 504 or 505 connected to adjacent cables C in the Y-axis direction are simply referred to as “adjacent cable-side signal contacts 504 or 505.”

First cable-side signal contacts 504 are arranged so that the main surfaces (plate surfaces) are along one surface (first main surface) of ground plate 508. Signal line contact sections 504a of first cable-side signal contacts 504 are located on the positive side in the X-axis direction of first plate portion 508a of ground plate 508, and signal line connection sections 504b are located on the positive side (upper side) in the Z-axis direction of second plate portion 508b of ground plate 508.

Second cable-side signal contacts 505 are arranged so that the main surfaces (plate surfaces) are along the other surface (second main surface) of ground plate 508. Signal line contact sections 505a of second cable-side signal contacts 505 are located on the negative side in the X-axis direction of first plate portion 508a of ground plate 508, and signal line connection sections 505b are located on the negative side (lower side) in the Z-axis direction of second plate portion 508b of ground plate 508.

The first main surface of first plate portion 508a of ground plate 508 faces first cable-side signal contacts 504. The second main surface of first plate portion 508a of ground plate 508 faces second cable-side signal contacts 505. That is, planar grounds formed by ground plate 508 are placed for a plurality of cable-side signal contacts 504 and 505 aligned in the Y-axis direction.

Thus, ground plate 508 extends to shield between signal line connection sections 504b of first cable-side signal contacts 504 and signal line connection sections 505b of second cable-side signal contacts 505. Ground plate 508 also extends to shield between signal line relay sections 504c of first cable-side signal contacts 504 and signal line relay sections 505c of second cable-side signal contacts 505 over the entire length of signal line relay sections 504c and 505c. Furthermore, ground plate 508 extends to shield between signal line contact sections 504a of first cable-side signal contacts 504 and signal line contact sections 505a of second cable-side signal contacts 505.

First cable-side signal contacts 504 and second cable-side signal contacts 505 have a symmetrical structure with respect to ground plate 508. The symmetrical structure is a structure securing electrical equivalency with respect to ground plate 508. Specifically, first cable-side signal contacts 504 and second cable-side signal contacts 505 have the same shape in a cross-section taken orthogonal to the direction of extension, and the distance from signal line contact section 504a, signal line relay section 504c, and signal line connection section 504b of first cable-side signal contact 504 to ground plate 508 is the same as the distance from signal line contact section 505a, signal line relay section 505c, and signal line connection section 505b of second cable-side signal contact 505 to ground plate 508.

Cable-side ground fittings 506 and 507 are ground members connected to the ground, which is the reference potential. Specifically, first cable-side ground fitting 506 is electrically connected via drain wires 13 to external shield layers 12 of first cables C1 placed in the upper row. Second cable-side ground fitting 507 is electrically connected via drain wires 13 to external shield layers 12 of second cables C2 placed in the lower row. Cable-side ground fittings 506 and 507 are each formed by sheet metal working (including punching and bending) of a single metal sheet. Cable-side ground fittings 506 and 507 have substantially similar configurations.

First cable-side ground fitting 506 includes a plurality of first cable-side ground contacts 516 each disposed between adjacent first cable-side signal contacts 504. Second cable-side ground fitting 507 includes a plurality of second cable-side ground contacts 517 each disposed between adjacent second cable-side signal contacts 505. In the following, first cable-side ground contacts 516 and second cable-side ground contacts 517 are referred to as “cable-side ground contacts 516 and 517” unless they are distinguished from each other.

Cable-side ground contacts 516 and 517 have ground contact sections 516a and 517a, ground connection sections 516b and 517b, and ground relay sections 516c and 517c, respectively. Ground relay sections 516c and 517c connect ground contact sections 516a and 517a to ground connection sections 516b and 517b. In the present embodiment, ground connection sections 516b and 517b are provided on the inner surfaces of interconnection shielding sections 516d and 517d, similarly to Embodiment 4.

Cable-side ground contacts 516 and 517 have an L-shaped section in which ground relay sections 516c and 517c extend from ground contact sections 516a and 517a to the positive side in the Z-axis direction, bend by 90 degrees toward the negative side in the X-axis direction, and reach ground connection sections 516b and 517b. The shapes of cable-side ground contacts 516 and 517 are substantially the same as the shapes of cable-side signal contacts 504 and 505. Cable-side ground contacts 516 and 517 are formed wider than cable-side signal contacts 504 and 505.

Cable-side ground contacts 516 and 517 are aligned in the Y-axis direction, which is the pitch direction. Cable-side ground contacts 516 and 517 are each disposed between adjacent cable-side signal contacts 504 and 505.

Ground contact sections 516a of first cable-side ground contacts 516 are each disposed between signal line contact sections 504a of adjacent first cable-side signal contacts 504 and shield between signal line contact sections 504a. In addition, on the negative side in the Z-axis direction, end sections 506a of ground contact sections 516a of the plurality of first cable-side ground contacts 516 are connected to each other, so that the ground is equipotentialized. End sections 506a each have a flat surface portion that contacts ground plate 508.

Likewise, ground contact sections 517a of second cable-side ground contacts 517 are each disposed between signal line contact sections 505a of adjacent second cable-side signal contacts 505 and shield between signal line contact sections 505a. In addition, on the negative side in the Z-axis direction, end sections 507a of ground contact sections 517a of the plurality of second cable-side ground contacts 517 are connected to each other, so that the ground is equipotentialized. End sections 507a each have a flat surface portion that contacts ground plate 508.

Ground contact sections 516a and 517a contact and electrically connect to board-side ground contacts 531 and 532 of board-side connector 5B when cable-side connector 5A and board-side connector 5B are mated with each other (see FIG. 61).

End sections 506b on the negative side of interconnection shielding sections 516d in the X-axis direction of the plurality of first cable-side ground contacts 516 are connected to one another in the Y-axis direction and have a flat plate shape. The lower surfaces of end sections 506b contact and are electrically connected to the upper surface of ground plate 508.

Likewise, end sections 507b on the negative side of interconnection shielding sections 517d in the X-axis direction of the plurality of second cable-side ground contacts 517 are connected to one another in the Y-axis direction and have a flat plate shape. The upper surfaces of end sections 507b contact and are electrically connected to the lower surface of ground plate 508.

Signal line contact sections 504a and 505a of cable-side signal contacts 504 and 505 and ground contact sections 516a and 517a of cable-side ground contacts 516 and 517 are exposed from the surface of a fitting portion of cable-side insulator 503. Signal line connection sections 504b and 505b of cable-side signal contacts 504 and 505 and ground connection sections 516b and 517b of cable-side ground contacts 516 and 517 are exposed from the surface of a cable placement portion of cable-side insulator 503.

Cable-side signal contacts 504 and cable-side ground contacts 516 are placed so that the portions of signal line contact sections 504a and ground contact sections 516a are flush with each other. In addition, cable-side signal contacts 505 and cable-side ground contacts 517 are placed so that the portions of signal line contact sections 505a and ground contact sections 517a are flush with each other. A similar design (e.g., spring characteristics) can be applied in spring pieces forming signal line contact sections 524a and 525a and spring pieces forming ground contact sections 531a and 532a in board-side connector 5B.

Ground relay section 516c of each of first cable-side ground contacts 516 is provided with interconnection shielding section 516d including two flat-plane shielding plates that stand upright from both ends in the Y-axis direction to the positive side in the Z-axis direction and extend along the XZ plane. Interconnection shielding section 516d is located between signal line connection sections 504b of two adjacent first cable-side signal contacts 504 among first cable-side signal contacts 504 connected to adjacent first cables C1, and is perpendicular to the facing direction of two signal line connection sections 504b. Furthermore, the distance from one of the two shielding plates of interconnection shielding section 516d to nearby first cable-side signal contact 504 is the same as the distance from the other one of the shielding plates the nearby first cable-side signal contact 504. That is, two signal line connection sections 504b adjacent to interconnection shielding section 516d are in a plane symmetrical arrangement with respect to the XZ plane passing through the midpoint between the two shielding plates of interconnection shielding section 516d.

On the inner surfaces (facing each other) of the two shielding plates of interconnection shielding section 516d, contact pieces are provided that function as ground connection section 516b. The two shielding plates can clamp drain wire 13 that functions as the shield part of first cable C1. Drain wire 13 is placed in the space formed by the two shielding plates and is electrically connected to the shielding plates, for example, by soldering (see FIG. 44).

In the present embodiment, two drain wires 13 drawn from two first cables C1 located on both sides of interconnection shielding section 516d are arranged in a single space formed by the two shielding plates, but it may be configured to accommodate single drain wire 13.

Similarly, ground relay section 517c of each of second cable-side ground contacts 517 is provided with interconnection shielding section 517d including two flat-plane shielding plates that extend downward from both ends in the Y-axis direction to the negative side in the Z-axis direction and extend along the XZ plane. Interconnection shielding section 517d is located between signal line connection sections 505b of two adjacent second cable-side signal contacts 505 among second cable-side signal contacts 505 connected to adjacent second cables C2, and is perpendicular to the facing direction of two signal line connection sections 505b. Furthermore, the distance from one of the two shielding plates of interconnection shielding section 517d to nearby second cable-side signal contact 505 is the same as the distance from the other shielding plate to nearby second cable-side signal contact 505. That is, two signal line connection sections 505b adjacent to interconnection shielding section 517d are in a plane symmetrical arrangement with respect to the XZ plane passing through the midpoint between the two shielding plates of interconnection shielding section 517d.

On the inner surfaces (facing each other) of the two shielding plates of interconnection shielding section 517d, contact pieces are provided that function as ground connection section 517b. The two shielding plates can clamp drain wire 13 that functions as the shield part of second cable C2. Drain wire 13 is placed in the space formed by the two shielding plates and is electrically connected to the shielding plates, for example, by soldering.

In the present embodiment, two drain wires 13 drawn from the two second cables C2, which are located on both sides of interconnection shielding section 517d, are arranged in a single space formed by two shielding plates, but it may be configured to have only one drain wire 13 arranged.

Connection-section protection plates 511 and 512 are arranged to contact interconnection shielding sections 516d and 517d. Connection-section protection plates 511 and 512 contact the inner surface of cover shell 502. Cover shell 502 is electrically connected to interconnection shielding sections 516d and 517d through the connection-section protection plates 511 and 512. Connection-section protection plates 511 and 512 and cover shell 502 may be connected, for example, by soldering.

In cable-side connector 5A, ground contact sections 516a, which are at ground potential, are each disposed between signal line contact sections 504a of two adjacent cable-side signal contacts 504, and shield between signal line contact sections 504a. Likewise, ground contact sections 517a, which are at ground potential, are each disposed between signal line contact sections 505a of two adjacent cable-side signal contacts 505, and shield between signal line contact sections 505a.

Interconnection shielding sections 516d of first cable-side ground contacts 516 are each placed three-dimensionally so as to extend in the XZ plane between signal line connection sections 504b of two adjacent cable-side signal contacts 504, and shield between signal line connection sections 504b. Likewise, interconnection shielding sections 517d of second cable-side ground contacts 517 are each placed three-dimensionally so as to extend in the XZ plane between signal line connection sections 505b of two adjacent cable-side signal contacts 505, and shield between signal line connection sections 505b.

With interconnection shielding sections 516d and 517d, it is possible to improve EMS characteristics (e.g., characteristic impedance, insertion loss, return loss, crosstalk, etc.) in transmission lines, and to ensure favorable transmission quality. Furthermore, two each of interconnection shielding sections 516d and 517d are provided and they have an even ground structure with respect to cable-side signal contacts 504 and 505, so that the transmission quality in two signal transmission lines is stabilized. To be more specific, since interconnection shielding sections 516d and 517d are formed at both ends in the Y-axis direction (width direction) by bending processing, the distance to cable-side signal contacts 504 and 505 can be easily adjusted by a setting of the bending position, and impedance control is also facilitated.

Furthermore, ground plate 508 is in surface contact, at least in part, with cable-side ground contacts 516 and 517. To be more specific, ground plate 508 is interposed between end sections 506a and 507a of cable-side ground contacts 516 and 517 and they are in surface contact with each other. Additionally, ground plate 508 is interposed and in surface contact with parts extending from ground relay sections 516c and 517c to end sections 506b and 507b of cable-side ground contacts 516 and 517.

In the present embodiment, to facilitate the design of the spring pieces in board-side connector 5B, signal line contact sections 504a and 505a of cable-side signal contacts 504 and 505 and ground contact sections 516a and 517a of cable-side ground contacts 516 and 517 are made flush with each other, resulting in gaps formed between ground plate 508 and cable-side ground contacts 516 and 517. From the perspective of ground reinforcement, ground plate 508 and cable-side ground contacts 516 and 517 may be made to contact each other over the entire surface as much as possible without gaps.

Also, in the present embodiment, similar to Embodiment 4, the impedance of cable-side signal contacts 504 and 505 is adjusted by forming voids in cable-side insulator 503 and the connection-section reinforcement member.

Cable-side insulator 503 forms a housing of cable-side connector 5A. Cable-side signal contacts 504 and 505, cable-side ground fittings 506 and 507, and ground plate 508 are assembled to cable-side insulator 503. Cable-side signal contacts 504 and 505, cable-side ground fittings 506 and 507, and ground plate 508 are integrally formed with cable-side insulator 503 by, for example, insert molding. Cable-side signal contacts 504 and 505, cable-side ground fittings 506 and 507, and ground plate 508 are placed apart and electrically insulated from each other by cable-side insulator 503.

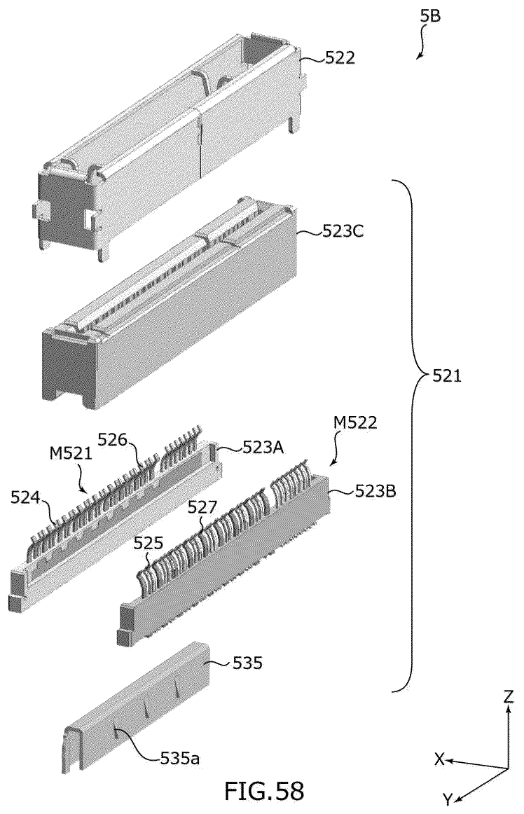

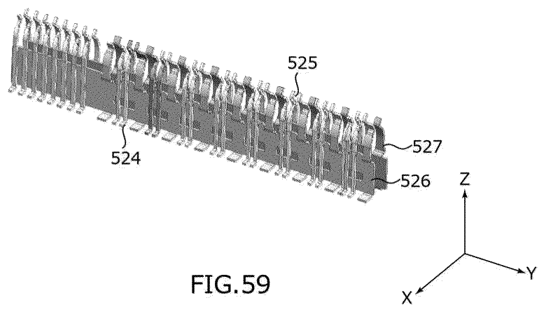

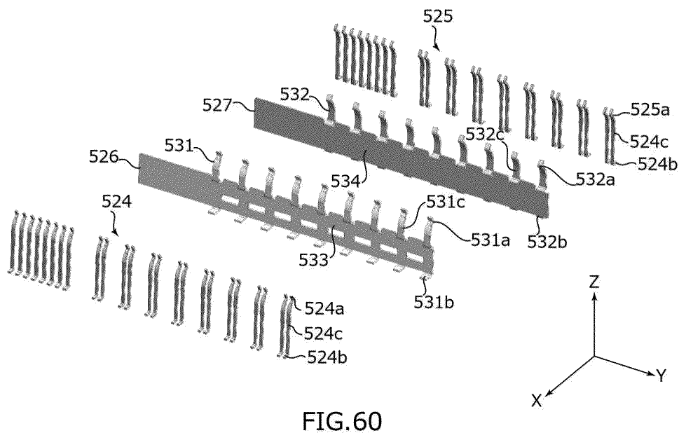

FIG. 58 is an exploded perspective view of board-side connector 5B to be mated with cable-side connector 5A. FIGS. 59 and 60 illustrate a contact structure in board-side connector body 521. Note that in FIGS. 59 and 60, a coupling member is omitted.

As illustrated in FIGS. 58 to 60, board-side connector 5B includes board-side connector body 521 and board-side shell 522. Board-side connector body 521 includes board-side insulator 523, first board-side signal contacts 524, second board-side signal contacts 525, first board-side ground fitting 526, second board-side ground fitting 527, etc.

Board-side connector body 521 includes first molded component M521, second molded component M522, and third board-side insulator 523C (see FIG. 58).

First molded component M521 includes first board-side signal contact 524, first board-side ground fitting 526, and first board-side insulator 523A. First board-side signal contact 524, first board-side ground fitting 526, and first board-side insulator 523A are integrally formed by, for example, insert molding.

Second molded component M522 includes second board-side signal contact 525, second board-side ground fitting 527, and second board-side insulator 523B. Second board-side signal contact 525, second board-side ground fitting 527, and second board-side insulator 523B are integrally formed by, for example, insert molding.

First molded component M521 and second molded component M522 are symmetrical with respect to the YZ plane, including their internal structures.

Board-side connector body 521 is manufactured by pressing first molded body M521 and second molded body M522, which are primary molded and arranged to face each other in the Y-axis direction, into separately molded third board-side insulator 523C from the negative side in the Z-axis direction. That is, in the present embodiment, board-side insulator 523 is constituted by first board-side insulator 523A, second board-side insulator 523B, and third board-side insulator 523C.

Furthermore, in the present embodiment, coupling member 535 having a U-shaped cross-section when viewed from the X-axis direction is arranged between first molded body M521 and second molded body M522.

Coupling member 535 is formed of a conductive material such as metal (e.g., copper alloy). Coupling member 535 is held between first molded body M521 and second molded body M522 by being pressed into third board-side insulator 523C while being clamped between first molded body M521 and second molded body M522.

Coupling member 535 contacts first board-side ground fitting 526 exposed from the inner surface of first board-side insulator 523A along the XZ plane and second board-side ground fitting 527 exposed from the inner surface of second board-side insulator 523B along the XZ plane, and electrically connects them to each other. Coupling member 535 has spring piece 535a that contacts first board-side ground fitting 526 and second board-side ground fitting 527. It should be noted that coupling member 535 may not include spring piece 535a and may be configured to make surface contact with first board-side ground fitting 526 and second board-side ground fitting 527.

In the following, when not distinguishing between first board-side signal contact 524 and second board-side signal contact 525, they are referred to as “board-side signal contacts 524 and 525.” Also, when not distinguishing between first board-side ground fitting 526 and second board-side ground fitting 527, they are referred to as “board-side ground fittings 526 and 527.” FIG. 60 shows board-side signal contacts 524 and 525 and board-side ground fittings 526 and 527 to be assembled to board-side insulator 523, which are shifted in the X-axis direction.

Board-side shell 522, board-side signal contacts 524 and 525, and board-side ground fittings 526 and 527 are formed of a conductive material such as metal (e.g., copper alloy). Board-side insulator 523 is formed of an insulating material such as synthetic resin (e.g., liquid crystal polymer).

Board-side shell 522 is a frame connected to the ground pattern of circuit board B and has a rectangular shape corresponding to the outer edge of board-side insulator 523 in plan view from the Z-axis direction. Board-side shell 522 is formed by, for example, sheet metal working (including punching and bending) of a single metal sheet. Board-side shell 522 is placed to cover the outside of the board-side connector body 521 and is in contact with and electrically connected to board-side ground fittings 526 and 527 of the board-side connector body 521. Board-side shell 522 is at ground potential and functions as a shield. Board-side shell 522 is fitted to, for example, a peripheral portion of board-side insulator 523.

Board-side insulator 523 has a rectangular shape in plan view from the Z-axis direction and forms a housing of board-side connector 5B. Board-side signal contacts 524 and 525 and board-side ground fittings 526 and 527 are assembled to board-side insulator 523. Board-side signal contacts 524 and 525 and board-side ground fittings 526 and 527 are integrally formed with board-side insulator 523 by, for example, insert molding. Board-side signal contacts 524 and 525 and board-side ground fittings 526 and 527 are placed apart and electrically insulated from each other by board-side insulator 523.

Board-side signal contacts 524 and 525 are members respectively connected to cable-side signal contacts 504 and 505 of cable-side connector 5A. Board-side signal contacts 524 and 525 are formed by, for example, sheet metal working (including punching and bending) of a single metal sheet. Board-side signal contacts 524 and 525 are each in pairs, respectively corresponding to cable-side signal contacts 504 and 505, and are aligned in the Y-axis direction, which is the pitch direction. First board-side signal contact 524 forms first board-side contact row L21 together with first board-side ground contact 531, which will be described later. Second board-side signal contact 525 forms second board-side contact row L22 together with second board-side ground contact 532, which will be described later.

Board-side signal contacts 524 and 525 have signal line contact sections 524a and 525a, signal line surface-mounted sections 524b and 525b, and signal line relay sections 524c and 525c, respectively. Signal line relay sections 524c and 525c connect signal line contact sections 524a and 525a to signal line surface-mounted sections 524b and 525b.

Signal line contact sections 524a and 525a contact and electrically connect to signal line contact sections 504a and 505a of cable-side connector 5A when cable-side connector 5A and board-side connector 5B are mated with each other (see FIG. 62). Signal line surface-mounted sections 524b and 525b are connected to the signal pattern of circuit board B by soldering, for example.

Board-side signal contacts 524 and 525 have a straight shape in which signal line relay sections 524c and 525c extend from signal line contact sections 524a and 525a to the negative side in the Z-axis direction (mating direction) and reach signal line surface-mounted sections 524b and 525b.

Signal line contact sections 524a and 525a include, at the tips being free ends, a spring piece (whose reference sign is omitted) for exerting a biasing force against the facing surface. Signal line surface-mounted section 524b of each of first board-side signal contacts 524 extends to the positive side in the X-axis direction, and signal line surface-mounted section 525b of each of second board-side signal contacts 525 extends to the negative side in the X-axis direction.

Board-side signal contacts 524 and 525 are arranged so that their main surfaces (plate surfaces) face each other in the X-axis direction.

Board-side ground fittings 526 and 527 include a plurality of board-side ground contacts 531 and 532 to be respectively connected to cable-side ground contacts 516 and 517 of cable-side connector 5A. Board-side ground contacts 531 and 532 have ground contact sections 531a and 532a, ground surface-mounted sections 531b and 532b, and ground relay sections 531c and 532c. Ground relay sections 531c and 532c connect ground contact sections 531a and 532a and ground surface-mounted sections 531b and 532b.

Ground contact sections 531a and 532a contact and electrically connect to ground contact sections 516a and 517a of cable-side connector 5A when cable-side connector 5A and board-side connector 5B are mated with each other (see FIG. 61). Ground surface-mounted sections 531b and 532b are connected to the ground pattern of circuit board B by soldering, for example.

Board-side ground contacts 531 and 532 have a straight shape in which ground relay sections 531c and 532c extend from ground contact sections 531a and 532a to the negative side in the Z-axis direction (mating direction) and reach ground surface-mounted sections 531b and 532b. In the present embodiment, parts of pin coupling sections 533 and 534 function as ground relay sections 531c and 532c.

Ground contact sections 531a and 532a include, at the tips being free ends, a spring piece (whose reference sign is omitted) for exerting a biasing force against the facing surface. Ground surface-mounted section 531b of each of first board-side ground contacts 531 extends to the positive side in the X-axis direction, and ground surface-mounted section 532b of each of second board-side ground contacts 532 extends to the negative side in the X-axis direction.

Board-side ground contacts 531 and 532 are arranged so that their main surfaces (board surfaces) face each other in the X-axis direction.

In board-side ground fittings 526 and 527, a plurality of board-side ground contacts 531 and a plurality of board-side ground contacts 532 arranged in the Y-axis direction are connected by pin coupling sections 533 and 534 extending in the Y-axis direction, and are electrically and mechanically connected. Pin coupling sections 533 and 534 have a flat plate shape that extends along the YZ plane.

Board-side ground contacts 531 and 532 are provided on board-side ground fittings 526 and 527 so as to protrude from the end surfaces of first plate parts 533a and 534a on the negative side in the Z-axis direction, and from the end surfaces of second plate parts 533b and 534b on the negative side in the X-axis direction.

The lower ends of pin coupling sections 533 and 534 are connected to the ground pattern of circuit board B by soldering, for example, and function as the surface-mounted sections of board-side ground fittings 526 and 527. By providing pin coupling sections 533 and 534, the area of the ground element is increased, and the ground is equipotentialized.

In Embodiment 5, although board-side ground contacts 531 and 532 in board-side ground fittings 526 and 527 are coupled to each other by pin coupling sections 533 and 534, they may be configured separately from each other. That is, pin coupling sections 533 and 534 only need to be provided to couple at least two adjacent first board-side ground contacts 531 or two adjacent second board-side ground contacts 532.

For example, in the present embodiment, all of first board-side ground contacts 531 and second board-side ground contacts 532 are formed in single board-side ground fittings 526 and 527, respectively, but it is also possible to arrange a plurality of board-side ground fittings 526 and 527, in which parts of first board-side ground contacts 531 and second board-side ground contacts 532 are formed, along the Y-axis direction.

FIG. 61 is a sectional view showing the connection of the ground in connector set 5, illustrating an XZ section between adjacent cables C in the Y-axis direction (pitch direction). FIG. 62 is a sectional view showing the connection of signal lines in connector set 5, illustrating an XZ section through internal conductor 11 of cable C.

As shown in FIG. 61, ground contact sections 516a and 517a of cable-side ground contacts 516 and 517 are fitted and electrically connected to ground contact sections 531a and 532a of board-side ground contacts 531 and 532.

In cable-side connector 5A, ground plate 508 is mechanically connected and integrated with cable-side ground contacts 516 and 517. Accordingly, board-side ground contacts 531 and 532 of board-side ground fittings 526 and 527 are electrically connected to ground plate 508 via cable-side ground contacts 516 and 517.

Furthermore, as shown in FIG. 62, when cable-side connector 5A and board-side connector 5B are mated, signal line contact sections 504a and 505a of cable-side signal contacts 504 and 505 are fitted and electrically connected to signal line contact sections 524a and 525a of board-side signal contacts 524 and 525.

Connector set 5 according to Embodiment 5 includes the following features alone or in combination as appropriate.

That is, connector set 5 includes cable-side connector 5A (first connector) and board-side connector 5B (second connector) that can be mated with cable-side connector 5A, in which cable-side connector 5A includes cable-side signal contacts 504 and 505 (signal contacts) connected to the signal lines, cable-side ground contacts 516 and 517 (ground contacts) connected to the ground, and flat ground plate 508 connected to the ground. Cable-side signal contacts 504 and 505 include a plurality of first cable-side signal contacts 504 (first signal contacts) disposed to face the first main surface of ground plate 508, and cable-side ground contacts 516 and 517 include first cable-side ground contacts 516 (first ground contacts) disposed between adjacent first cable-side signal contacts 504, and first cable-side ground contacts 516 make direct contact with the first main surface of ground plate 508.

In connector set 5, cable-side signal contacts 504 and 505 include a plurality of cable-side signal contacts 505 (second signal contacts) disposed to face the second main surface of ground plate 508 opposite the first main surface, and cable-side ground contacts 516 and 517 include second cable-side ground contacts 517 (second ground contacts) disposed between adjacent second cable-side signal contacts 505, and second cable-side ground contacts 517 make direct contact with the second main surface of ground plate 508.

In connector set 5, ground plate 508 is mechanically connected and integrated with first cable-side ground contacts 516 and second cable-side ground contacts 517.

In connector set 5, cable-side signal contacts 504 and 505, cable-side ground contacts 516 and 517, and ground plate 508 are disposed such that first cable-side signal contacts 504 and second cable-side signal contacts 505 are electrically equivalent.

In connector set 5, first cable-side signal contacts 504 and second cable-side signal contacts 505 have a symmetrical structure with respect to ground plate 508.

In connector set 5, first cable-side signal contacts 504 and second cable-side signal contacts 505 have the same shape in a cross-section taken orthogonal to the extending direction, and the distance from signal line contact section 504a, signal line relay section 504c, and signal line connection section 504b of each of first cable-side signal contacts 504 to ground plate 508 is the same as the distance from signal line contact section 505a, signal line relay section 505c, and signal line connection section 505b of each of second cable-side signal contact 505 to ground plate 508.

In connector set 5, cable-side connector 5A (first connector) is a wire-to-board cable-side connector configured to be connected to a plurality of cables C used for transmission of a high-frequency signal, in which a plurality of cables C include first cables C1 connected to first cable-side signal contacts 504 and second cables C2 connected to second cable-side signal contacts 505, first cables C1 and second cables C2 are pulled out in a direction orthogonal to the mating direction and the row of first cables C1 and the row of second cables C2 are stacked on top of each other in the mating direction, ground plate 508 is bent in an L-shape, and includes first plate section 508a (first flat surface) parallel to the mating direction and second plate section 508b (second flat surface) extending in the pull-out direction of cables C.

In connector set 5, ground plate 508 is electrically connected to board-side ground contacts 531 and 532 (counterpart ground contacts) of board-side connector 5B (second connector) via first cable-side ground contacts 516 and second cable-side ground contacts 517.

In connector set 5, board-side ground contacts 531 and 532 support first cable-side ground contacts 516, second cable-side ground contacts 517, and ground plate 508 integrally by a spring force.

In connector set 5, a plurality of first cable-side ground contacts 516 are electrically and mechanically connected to one another.

In connector set 5, a plurality of first cable-side ground contacts 516 are electrically and mechanically connected to one another at least at one of the opposite ends in the extending direction.

In connector set 5, first cable-side ground contacts 516 are integrated into cable-side ground fitting 506 being a single member.

In connector set 5, first cable-side ground contacts 516 include interconnection shielding sections 516d (shielding sections) disposed between adjacent first cable-side signal contacts 504, and each of interconnection shielding sections 516d includes two shielding plates disposed to be orthogonal to the pitch direction.

In connector set 5, two first cable-side signal contacts 504 are disposed in the region sandwiched by interconnection shielding sections 516d of two first cable-side ground contacts 516.

In connector set 5, the distance from one of two first cable-side signal contacts 504 disposed in the region sandwiched by two interconnection shielding sections 516d to one of two interconnection shielding section 516d adjacent to the one of two first cable-side signal contacts 504 is the same as the distance from the other one of two first cable-side signal contacts 504 to the other of two interconnection shielding sections 516d adjacent to the other one of two first cable-side signal contacts 504.

In connector set 5, the two shielding plates can clamp the shield part of cable C in the space formed by the two shielding plates.

In connector set 5, the shield part is drain wire 13 disposed longitudinally alongside cable C having an external shield layer.

Furthermore, cable-side connector 5A includes cable-side signal contacts 504 and 505 connected to the signal line, cable-side ground contacts 516 and 517 connected to the ground, and flat ground plate 508 connected to the ground, in which cable-side signal contacts 504 and 505 include a plurality of first cable-side signal contacts 504 disposed to face the first main surface of cable-side ground plate 508, cable-side ground contacts 516 and 517 include first cable-side ground contacts 516 disposed between adjacent first cable-side signal contacts 504, and first cable-side ground contacts 516 make direct contact with the first main surface of ground plate 508.

Cable-side connector 5A is a wire-to-board connector configured to connect cables C used for transmission of a high-frequency signal and circuit board B to each other by mating with board-side connector 5B (counterpart connector) mounted on circuit board B, the cable-side connector including a plurality of cable-side signal contacts 504 connected to internal conductors 11 (signal lines) of cables C, and interconnection shielding sections 516d connected to the ground and disposed between two adjacent cable-side signal contacts 504, in which interconnection shielding sections 516d include two interconnection shielding plates disposed between two adjacent cable-side signal contacts 504, the two interconnection shielding plates being disposed to be orthogonal to the facing direction of signal line connection sections 504b.

Connector set 5 has the above-described features, which significantly strengthens the ground structure. In addition, it is possible to improve EMS characteristics (e.g., characteristic impedance, insertion loss, return loss, crosstalk, etc.) in transmission lines, and to ensure favorable transmission quality. Further, a plurality of cables C can be connected to circuit board B collectively. Thus, it is possible to meet a requirement for wiring in an information device such as a server, and more particularly to enhance a high-speed transmission characteristic. It is also possible to improve the connection workability of cables C and reduce the size of the connector.

While the invention made by the present inventor has been specifically described based on the preferred embodiments, it is not intended to limit the present invention to the above-mentioned preferred embodiments but the present invention may be further modified within the scope and spirit of the invention defined by the appended claims.

For example, the detailed structures of cable-side connectors 1A to 5A and board-side connectors 1B to 5B are not limited to the examples described in the embodiments and can be appropriately modified. The number of cables C can also be changed as appropriate.

In the embodiments, the wire-to-board connector sets are described, but the present invention can also be applied to a board-to-board connector set. Specifically, it can be adapted by changing the wire-compatible structure of cable-side connectors 1A to 5A for use in board-side connectors 1B to 5B.

Furthermore, the present invention can also be applied to connectors (so-called edge connector sockets) that are compatible with card edge connectors. Specifically, it can be adapted by inserting a board instead of cable-side connectors 1A to 5A into board-side connectors 1B to 5B. Adaptation can be achieved by disposing contact points of the card-edge board at the same positions in the X-, Y-, and Z-axis directions as the contact points of the signal contacts and ground contacts of the cable-side connector. Additionally, the width of the board can be adapted to be the same as the width of the mating part of the cable-side insulator of the cable-side connector (the part that is inserted into a mating opening of the board-side connector).

Also, flat cables such as Flexible Flat Cables (FFC) can be applied as cables C for connection. In the above embodiments, since cables C are connected to the cable-side connector in two stages in the Z-direction, two flat cables will be applied. The flat cable includes a plurality of internal conductors arranged in a plane, an insulator formed around the outer periphery of the internal conductors, and an external shield layer formed around the outer periphery of the insulator.

The internal conductors may be a flat rectangular wire having a flat plate shape, or it may be a round wire. The insulator may be formed by laminating insulating tape on both sides of the internal conductors, or it may be formed by extrusion molding. Also, the insulator may be formed individually for a plurality of internal conductors, or it may be formed to collectively cover a plurality of internal conductors. For example, pairs of adjacent ones of the internal conductors are used for transmitting differential signals. The internal conductors placed on both sides of one pair of internal conductors for differential signal transmission are used as the ground.

The external shield layer may be a metal film in which a metal component (e.g., copper or aluminum) is vapor-deposited on one side of a resin film such as polyethylene resin, or it may be a thin metal foil. The external shield layer may be formed by laminating metal film or metal foil on both sides of the insulator, or by wrapping a metal film or metal foil on the entire peripheral surface. When using a metal film, a metal deposition surface is disposed to be the inside.

When connecting the signal connection section and the ground connection section of the cable-side connector to the flat cable, the tip of the flat cable is processed. Specifically, the insulator and the external shield layer are removed (stripped) from the tip of the flat cable for a specified length using a stripper, exposing the internal conductor. Alternatively, the insulator and external shield layer may be removed to form an opening, exposing the internal conductor. A portion of the external shield layer with a certain width on the cable rear end side of the exposed part of the internal conductors serves as the contact part with the ground connection section. If the external shield layer is formed of a metal film, a certain amount of the metal film is folded back from the tip so that the metal surface is positioned on the outside. Alternatively, processing for removing the insulator by a laser may be used. The processed tip of the flat cable is placed in the signal connection section and the ground connection section of the cable-side connector and is connected by soldering or the like.

In the cable-side ground contact, if two interconnection shielding sections 111d are provided between adjacent signal line connection sections (see FIG. 6A), a slit for insertion of the tip of the flat cable is provided at the end of interconnection shielding sections 111d on the negative side in the X-axis direction. The width of the slit in the Z-axis direction corresponds to the thickness of the flat cable. If interconnection shielding sections 111d are embedded in the board-side insulator, the slit for insertion of the tip of the flat cable is similarly formed in the board-side insulator.

By inserting the tip of the flat cable into the slit, the internal conductor for differential signal transmission is placed in the signal line connection section of the cable-side connector and is connected, for example, by soldering. The internal conductor for grounding enters the ground connection section between two interconnection shielding sections 111d (the region sandwiched in the Y-axis direction by interconnection shielding sections 111d) and is connected by soldering or clamping. The external shield layer is clamped in the slit of the interconnection shielding sections, making contact therewith and being electrically connected thereto. Furthermore, the external shield layer may be joined to the interconnection shielding sections by soldering.

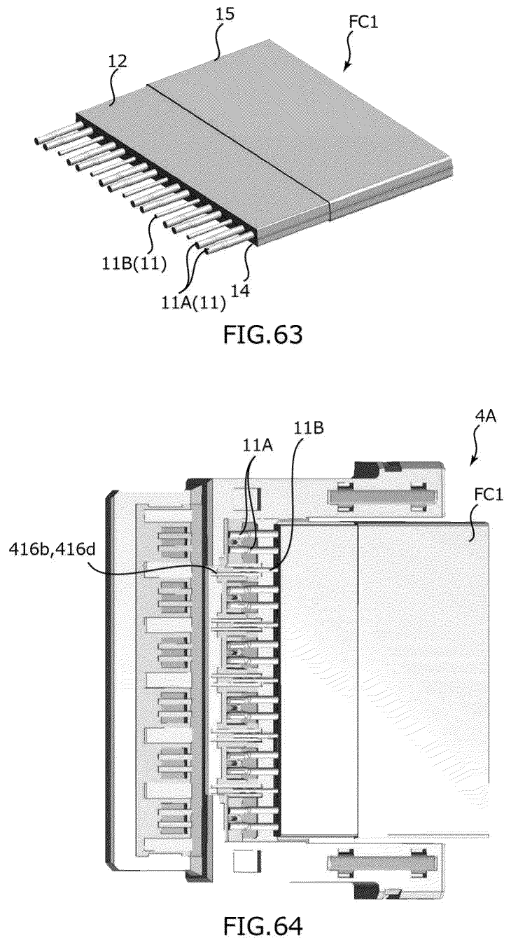

FIG. 63 illustrates an example of a flat cable. In flat cable FC1 shown in FIG. 63, a plurality of internal conductors 11 are arranged in a plane, and insulator 14 is formed to collectively cover a plurality of internal conductors 11. Furthermore, external shield layer 12 is formed on the outer peripheral surface of insulator 14 and is covered with sheath 15.

Internal conductors 11 are a round conductor with a circular cross-sectional shape. Insulator 14 may be formed by laminating an insulating tape on both sides of the array surface of internal conductors 11, or it may be formed by extrusion molding. Additionally, the insulator may be individually formed on a plurality of internal conductors 11.

External shield layer 12 may be a metal film formed by vapor deposition of a metal component (for example, copper or aluminum) on one side of a resin film such as polyethylene resin, or it may be a metal foil that is thinly stretched metal. External shield layer 12 may be formed by laminating a metal film or metal foil on both sides of insulator 14, or by wrapping a metal film or metal foil on the entire periphery. When using a metal film, for example, it is arranged so that the vapor-deposited metal surface is on the inside. Furthermore, external shield layer 12 may be composed of a braided wire.

For example, by cutting a long cable wound on a bobbin to a predetermined length and removing insulator 14, external shield layer 12, and sheath 15 from the tip by a stripper, internal conductor 11 is exposed at the tip of FC1 (see FIG. 63).

FIG. 64 illustrates an aspect of connection of flat cable FC1 to the cable-side connector. FIG. 64 shows the case where flat cable FC1 is connected to cable-side connector 4A of Embodiment 4.

In the example shown in FIG. 64, among internal conductors 11 of flat cable FC1, a pair of adjacent internal conductors 11A are used for differential signal transmission and are connected to first cable-side signal contacts 404 of cable-side connector 4A. Also, internal conductors 11B located on both sides of the pair of internal conductors 11A for differential signal transmission are used as the ground and are connected to first cable-side ground contacts 416 of cable-side connector 4A.

Furthermore, in external shield layer 12, external shield layer 12 may be exposed at the cable rear end side of the exposed part of internal conductors 11, and brought into contact with cover shell 402. When external shield layer 12 is formed of a metal film, it may be processed by folding back a certain length from the tip so that the metal surface is positioned on the outside. The processed tip of flat cable FC1 is disposed between signal connection sections 404b and ground connection sections 416b (between the two shielding plates of connection shielding sections 417d) of cable-side connector 4A, and is connected by soldering or the like.

Note that, FIG. 64 shows the case where upper flat cable FC1 is connected to cable-side connector 4A, but the same applies to lower flat cable FC1.

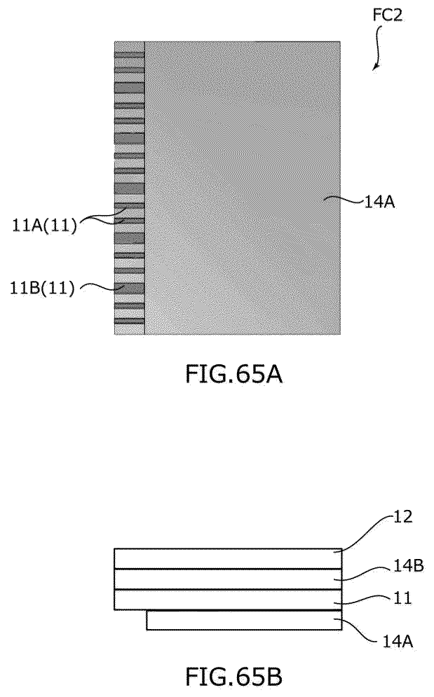

FIGS. 65A and 65B are diagrams showing another example of a flat cable. flat cable FC2 shown in FIGS. 65A and 65B is a so-called flexible flat cable (FFC) in which internal conductors 11 composed of flat rectangular conductors are sandwiched between insulators 14A and 14B formed of insulating films (for example, PET films). In flat cable FC2, external shield layer 12 is disposed on the outer surface of one of insulators 14B, where internal conductors 11 are not exposed. External shield layer 12 may also be disposed on the outer surface of other insulator 14A, where internal conductors 11 are exposed, or on the outer surfaces of both insulators 14A and 14B.

Generally, flat cable FC2 is made by cutting from a long cable wound on a bobbin. In the long cable, openings are provided at predetermined intervals in one insulator 14A, exposing internal conductors 11 through these openings. By cutting the long cable at parts where the openings are provided, short lengths of flexible flat cables are produced. As shown in FIG. 65A, at the end of flat cable FC2, internal conductors 11 are exposed from one side (the bottom side in FIG. 65B). Note that there are also cases where openings are provided in both insulators 14A and 14B, exposing internal conductors 11 from both sides.

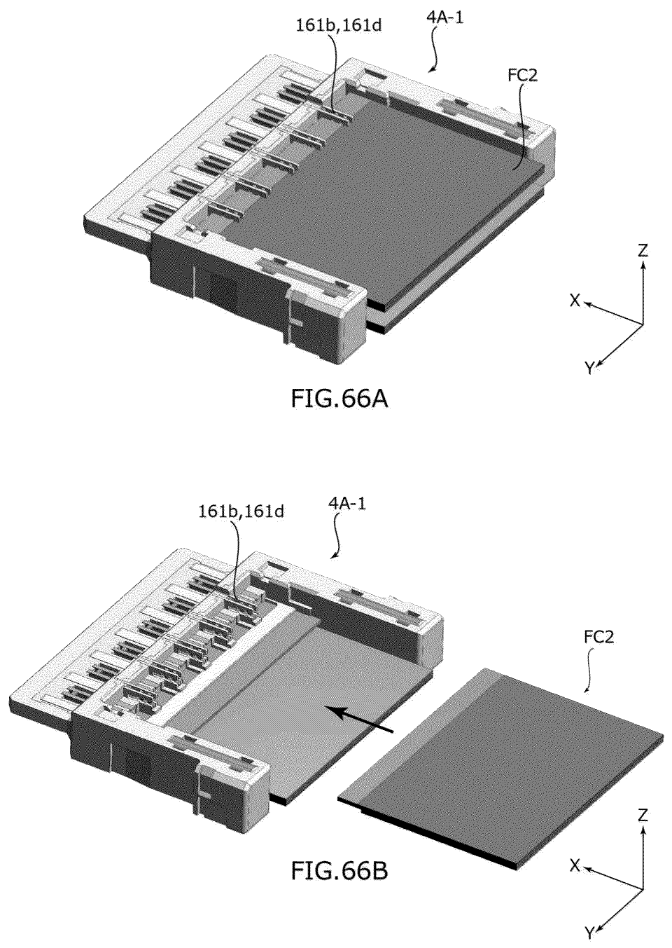

FIG. 66 illustrates an aspect of connection of flat cable FC2 to the cable-side connector. FIG. 66 shows the case where flat cable FC2 is connected to cable-side connector 4A-1, which is based on cable-side connector 4A of Embodiment 4.

In the example shown in FIG. 66, among internal conductors 11 of flat cable FC2, a pair of adjacent internal conductors 11A are used for differential signal transmission and are connected to first cable-side signal contacts 404 of cable-side connector 4A-1. Also, internal conductors 11B located on both sides of the pair of internal conductors 11A for differential signal transmission are used as the ground and are connected to first cable-side ground contacts 416 of cable-side connector 4A-1.

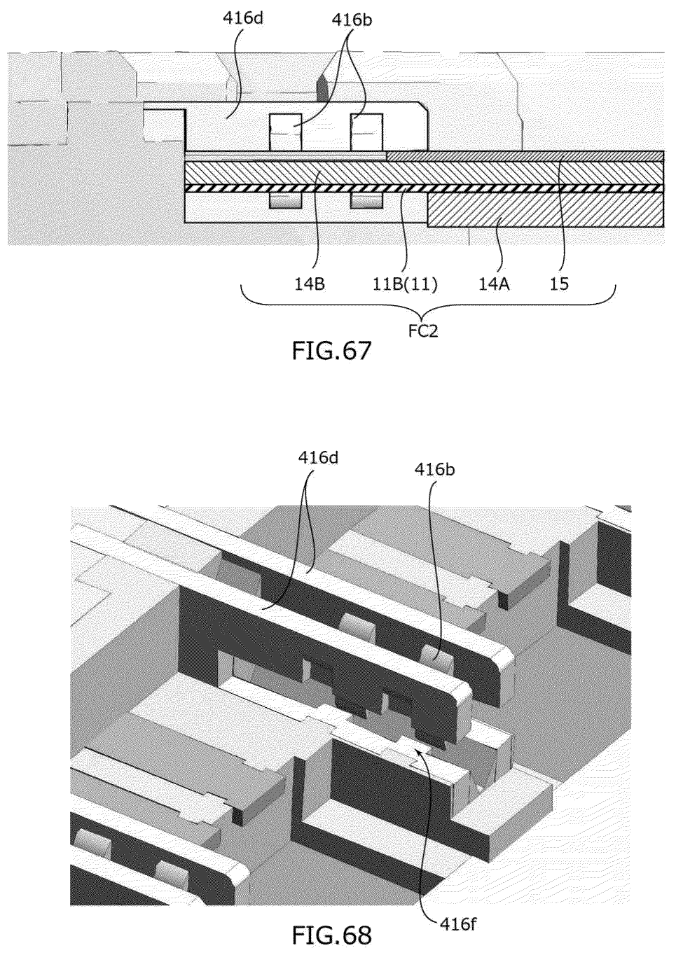

As shown in FIGS. 67 and 68, slit 416f corresponding to the thickness of flat cable FC2 is formed in interconnection shielding sections 416d. By inserting flat cable FC2 into slit 416f, internal conductors 11A and 11B of flat cable FC2 can easily be brought into contact with cable-side signal contacts 404 and 405 or cable-side ground contacts 416 and 417, and electrically connected thereto.

For example, as shown in FIG. 67, the upper surface of the slit formed in the shielding plates contacts external shield layer 12 of flat cable FC2, and the lower surface formed in the shielding plates contacts internal conductors 11B of flat cable FC2. Also, internal conductors 11A of flat cable FC2 face and make contact with signal line connection sections 404b and 405b of cable-side signal contacts 404 and 405. In this state, connections may be made with solder or laser, or by opening both sides of flat cable FC2 and exposing the contact points of internal conductors 11.

Although FIG. 64 shows the case where flat cable FC1 is connected to cable-side connector 4A of Embodiment 4, the structure of the cable-side connector applicable to flat cable FC1 is not limited to this.

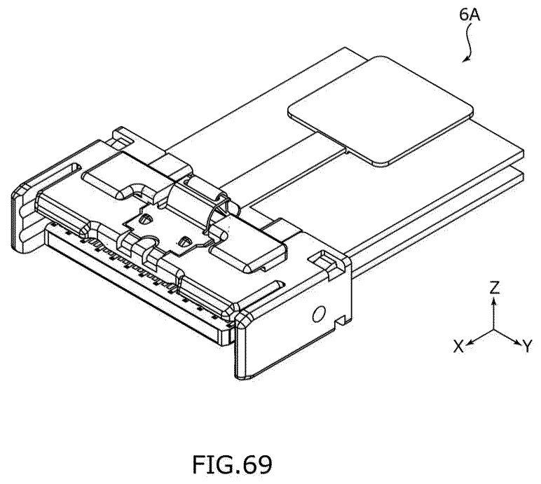

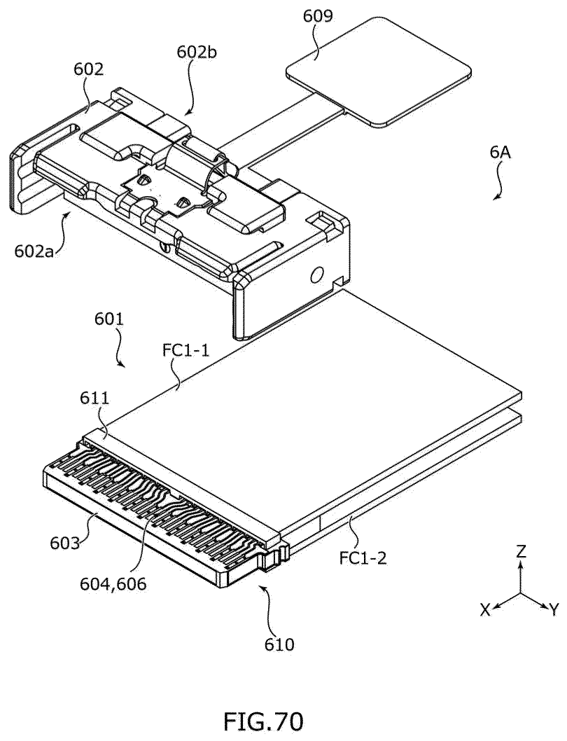

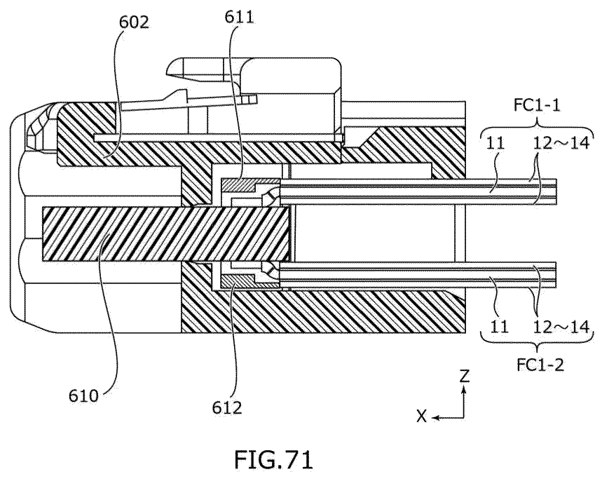

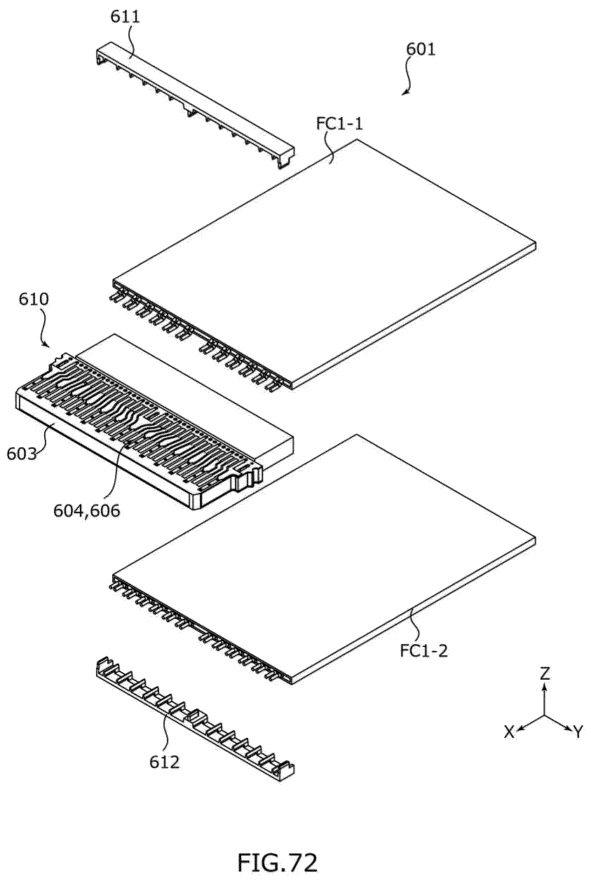

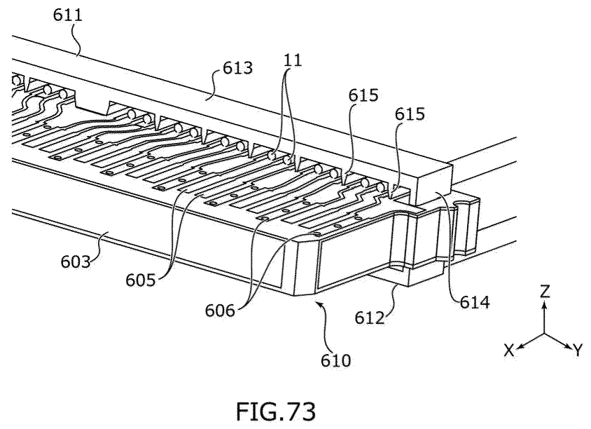

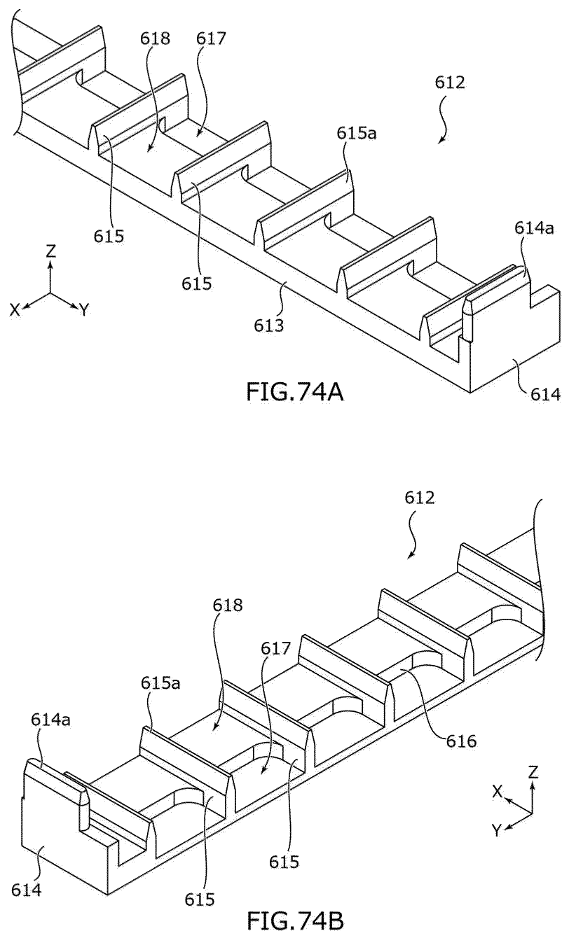

FIG. 69 illustrates another example of a cable-side connector to which flat cable FC1 is applied. FIG. 70 is an exploded perspective view of cable-side connector 6A shown in FIG. 69. FIG. 71 is an enlarged view showing the mounting state of cover shell 602 to cable-side connector body 601. FIG. 72 is an exploded perspective view of cable-side connector body 601. FIG. 73 is an enlarged view showing the connection part between paddle card 610 and flat cables FC1-1 and FC1-2. FIGS. 74A and 74B are enlarged views showing the inner structure of the ground shield.

As shown in FIG. 69 and the like, cable-side connector 6A includes cable-side connector body 601 and cover shell 602. Cable-side connector body 601 includes first flat cable FC1-1, second flat cable FC1-2, paddle card 610, first ground shield 611, and second ground shield 612.

In the following, first flat cable FC1-1 and second flat cable FC1-2 are referred to as “flat cables FC1-1 and FC1-2” unless they are distinguished from each other. Also, first ground shield 611 and second ground shield 612 are referred to as “ground shields 611 and 612” unless they are distinguished from each other.

Cover shell 602 is arranged to cover the outside of cable-side connector body 601. Cover shell 602 is attached to cable-side connector body 601 so that paddle card 610 is positioned at one opening 602a of cover shell 602, and flat cables FC1-1 and FC1-2 are drawn out from other opening 602b. Cover shell 602 is formed of an insulating material such as synthetic resin and forms a housing of cable-side connector 6A.

Removal operation member 609, such as a pull tab, is connected to cover shell 602. By pulling removal operation member 609 in a removal direction, the mating state between cable-side connector 6A and the board-side connector (not shown) can be easily released, and cable-side connector 61 can be removed.

First flat cable FC1-1 is mounted from the upper side (positive side in the Z-axis direction) to paddle card 610. To be more specific, first flat cable FC1-1 is placed on first main surface 603a of board 603 of paddle card 610. Second flat cable FC1-2 is mounted from below (negative side in the Z-axis direction) on paddle card 610. Specifically, second flat cable FC1-2 is placed on second main surface 603b of board 603 of paddle card 610.

The configurations of flat cables FC1-1 and FC1-2 are the same as that of flat cable FC1 shown in FIG. 63. That is, in flat cables FC1-1 and FC1-2, multiple internal conductors 11 (signal lines) are arranged in a planar manner, and insulator 14 is formed to collectively cover multiple internal conductors 11. Furthermore, shield layer 12 is formed on the outer peripheral surface of insulator 14 and is covered with sheath 15.

Internal conductors 11 of flat cables FC1-1 and FC1-2 are arranged in pairs and are used for the transmission of differential signals. The impedance of flat cables FC1-1 and FC1-2 is appropriately determined by adjusting cable design parameters such as the dimensions (wire gauge) of internal conductors 11, pitch, dielectric of the cables, and the distance between internal conductors 11 and external shield 12.

Internal conductors 11 become exposed at the end of flat cable FC1 by removing insulator 14, external shield layer 12, and sheath 15 using a stripper. The exposed portions of internal conductors 11 are bent towards paddle card 610 and connected to cable-side signal contacts 604 and 605. Among the exposed portions of internal conductors 11, the bent portion is referred to as “bent portion 11a,” and the portion that is soldered to cable-side signal contacts 604 and 605 is referred to as “soldering portion 11b.”

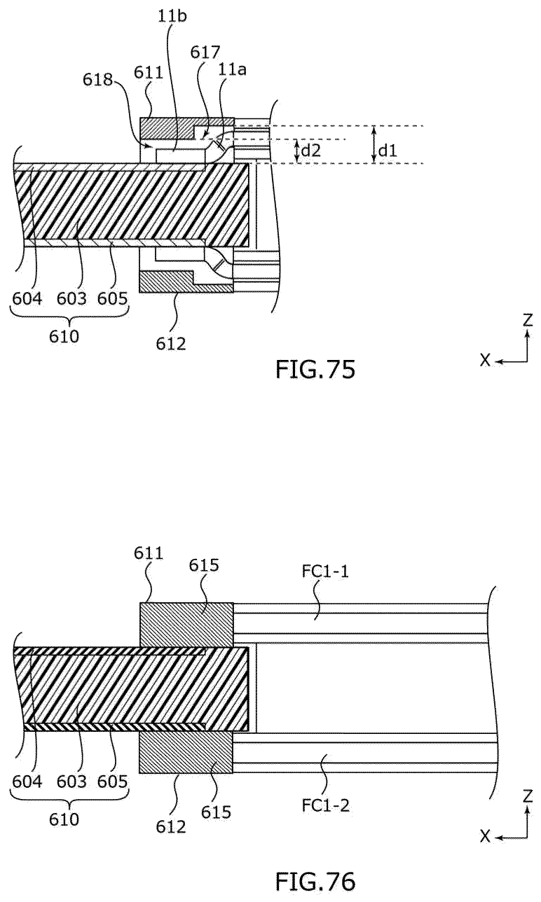

Paddle card 610 is a small circuit board with a conductor pattern formed on board 603 made of an insulating material. The conductor pattern includes first cable-side signal contacts 604, second cable-side signal contacts 605 (see FIG. 74), first cable-side ground contacts 606, and second cable-side ground contacts 607 (see FIG. 75). Paddle card 610 may have a configuration corresponding to ground plate 408 of Embodiment 4.

First cable-side signal contacts 604 are placed on first main surface 603b of board 603. First cable-side signal contacts 604 are connected to internal conductors 11 of first flat cable FC1-1 (see FIG. 75). Second cable-side signal contacts 605 are placed on second main surface 603b of board 603. Second cable-side signal contacts 605 are connected to internal conductors 11 of second flat cable FC1-2 (see FIG. 75).

First cable-side ground contacts 606 are placed between adjacent first cable-side signal contacts 604. First cable-side ground contacts 606 are connected to partition sections 615 of first ground shield 611 (see FIG. 76). Second cable-side ground contacts 607 are placed between adjacent second cable-side signal contacts 605. Second cable-side ground contacts 607 are connected to partition sections 615 of second ground shield 612 (see FIG. 76).

The impedance of paddle card 610 is appropriately determined by adjusting paddle card design parameters such as the width of a conductor pattern, the pitch of a differential trace pattern, and the distance from a signal trace pattern to ground planes on all sides.

Ground shields 611 and 612 are arranged to cover the connection parts after flat cables FC1-1 and FC1-2 are mounted on paddle card 610. Ground shields 611 and 612 are soldered to paddle card 610 by locally heating and pressing using, for example, a hot bar.

Specifically, first ground shield 611 is mounted on first main surface 603a of board 603 to cover the connection part between the internal conductors 11 (signal lines) of first flat cable FC1-1 and first cable-side signal contacts 604. Second ground shield 612 is mounted on second main surface 603b of board 603 to cover the connection part between internal conductors 11 (signal lines) of second flat cable FC1-2 and second cable-side signal contacts 605.

Each of ground shields 611 and 612 includes base section 613, sidewall sections 614, and partition sections 615 (see FIGS. 74A and 74B). Although FIGS. 74A and 74B show lower second ground shield 612, upper first ground shield 611 is similar.

Base section 613 has a flat plate shape and extends in the Y-axis direction. Step section 616 is formed on the inner surface (facing paddle card 610) of base section 613.

Sidewall sections 614 are located at the opposite ends of base section 613 in the Y-axis direction (longitudinal direction). Leg sections 614a located at the tips of sidewall sections 614 in the Z-axis direction engage with engagement holes (not shown) provided in board 603 of paddle card 610. This stabilizes the posture of ground shields 611 and 612 when soldering them to paddle card 610.

Partition sections 615 are provided on the inner surface of base section 613 so as to protrude in the Z-axis direction. Partition sections 615 are arranged at regular intervals along the entire length of base section 613. Tips 615a of partition sections 615 are connected to cable-side ground contacts 606 and 607. The connection parts between a pair of cable-side signal contacts 604 and 605 and internal conductors 11 of flat cables FC1-1 and FC1-2 are placed between two adjacent partition sections 615. That is, partition sections 615 separate two adjacent connection parts from each other.

First ground shield 611 is grounded through first cable-side ground contacts 606 and a board-side ground contact connected to first cable-side ground contacts 606. Second ground shield 612 is grounded through second cable-side ground contacts 607 and a board-side ground contact connected to second cable-side ground contacts 607.

By providing partition sections 615 in ground shields 611 and 612, it is possible to improve EMS characteristics (e.g., characteristic impedance, insertion loss, return loss, crosstalk, etc.) in transmission lines, and to ensure favorable transmission quality. Furthermore, partition sections 615 form an even ground structure with respect to cable-side signal contacts 604 and 605, thereby stabilizing transmission quality in two signal transmission lines.

Tip sections 615a of partition sections 615 are chamfered, making its width narrower than a portion on the base section 613 side. By making the width of tip sections 615a of partition sections 615 smaller than the width of cable-side ground contacts 606 and 607, workability during soldering of both is improved.

Base section 613, sidewall sections 614, and partition sections 615 form first recessed sections 617 and second recessed sections 618. First recessed sections 617 cover bent portions 11a of internal conductors 11. Second recessed sections 618 cover soldering portions 11b of internal conductors 11. Due to step section 616 formed on the inner surface of base section 613, depth d2 of second recessed sections 618 is smaller than depth d1 of first recessed sections 617. Compared to forming recessed sections at a constant depth (for example, the same depth as first recessed sections 617), soldering portions 11b become closer to ground shield 611.

By varying the depths of first recessed sections 617 and second recessed sections 618, it is possible to adjust the distance from bent portions 11a and soldering portions 11b of internal conductors 11 to ground shields 611 and 612, thereby easily controlling the impedance transition between paddle card 610 and flat cable FC1.

As described above, cable-side connector 6A includes the following features alone or in combination as appropriate.

That is, cable-side connector 6A is a wire-to-board connector configured to connect cables to circuit board B by mating with a counterpart connector (for example, board-side connector 4B of Embodiment 4) mounted on circuit board B, and includes flat cables FC1 and FC2 including a plurality of internal conductors 11 (signal lines) used for transmitting high-frequency signals, paddle card 610 including a plurality of cable-side signal contacts 604 and 605 (signal contacts) connected to internal conductors 11, cable-side ground contacts 606 and 607 (ground contacts) connected to the ground, and board 603 on which cable-side signal contacts 604 and 605 and cable-side ground contacts 606 and 607 are disposed, and ground shields 611 and 612 attached to paddle card 610 to cover the connection parts between internal conductors 11 and cable-side signal contacts 604 and 605. Ground shields 611 and 612 include flat base section 613 and partition sections 615 protruding from base section 613 to separate two adjacent connection parts and connected to cable-side ground contacts 606 and 607.

In cable-side connector 6A, flat cables FC1-1 and FC1-2 include first flat cable FC1-1 disposed on first main surface 603a of board 603 and second flat cable FC1-2 disposed on second main surface 603b of board 603 opposite first main surface 603a. Cable-side signal contacts 604 and 605 (signal contacts) include a plurality of first cable-side signal contacts 604 disposed on first main surface 603b of board 603, and a plurality of second cable-side signal contacts 605 disposed on second main surface 603b of board 603. Cable-side ground contacts 606 and 607 (ground contacts) include first cable-side ground contacts 606 disposed between adjacent first cable-side signal contacts 604, and second cable-side ground contacts 607 disposed between adjacent second cable-side signal contacts 605. Ground shields 611 and 612 include first ground shield 611 attached to first main surface 603a of board 603 to cover the connection parts between internal conductors 11 (signal lines) of first flat cable FC1-1 and first cable-side signal contacts 604, and second ground shield 612 attached to second main surface 603b of board 603 to cover the connection parts between internal conductors 11 (signal lines) of second flat cable FC1-2 and second cable-side signal contacts 605.

In cable-side connector 6A, the exposed portions of internal conductors 11 (signal lines) from insulator 14 include bent portions 11a bending towards the board 603 side, and soldering portions 11b connected to signal contacts 604 and 605. Ground shields 611 and 612 have recessed sections 617 and 618 formed by base section 613 and partition sections 615. Recessed sections 617 and 618 include first recessed sections 617 covering bent portions 11a, and second recessed sections 618 covering soldering portions 11b. Depth d2 of second recessed sections 618 is smaller than the depth the first recessed sections 618.

In cable-side connector 6A, paddle card 610 includes engaging recessed sections, and ground shields 611 and 612 include sidewall sections 615a (engaging pieces) capable of engaging with the engaging recessed sections.

It should be considered that the embodiments disclosed herein are illustrative in all respects and not restrictive. The scope of the present invention is specified by the claims, not by the above-mentioned description. The scope of the present invention is intended to include all modifications in so far as they are within the scope of the appended claims or the equivalents thereof.

### REFERENCE SIGNS LIST

1 Connector set
C Cable
11 Internal conductor
12 External shield layer
1A Cable-side connector
101 Cable-side connector body
102 Cover shell
103 Cable-side insulator
104, 105 Cable-side signal contact
106, 107 Cable-side ground fitting
108 Ground plate
111, 112 Cable-side ground contact
1B Board-side connector
121 Board-side connector body
122 Board-side shell
123 Board-side insulator
124, 125 Board-side signal contact
126 Board-side ground fitting
131, 132 Board-side ground contact

1. A connector set, comprising:
a first connector; and
a counterpart second connector capable of being mated with the first connector, wherein
the first connector comprises:
a signal contact connected to a signal line;
a ground contact connected to ground; and
a flat ground plate connected to the ground,
the signal contact comprises a plurality of first signal contacts disposed to face a first main surface of the flat ground plate,
the ground contact comprises a first ground contact disposed between adjacent ones of the plurality of first signal contacts, and
the first ground contact makes direct contact with the first main surface of the flat ground plate.

2. The connector set according to claim 1, wherein:
the signal contact comprises a plurality of second signal contacts disposed to face a second main surface of the ground plate opposite the first main surface,
the ground contact comprises a second ground contact disposed between adjacent ones of the plurality of second signal contacts, and
the second ground contact makes direct contact with the second main surface of the ground plate.

3. The connector set according to claim 2, wherein
the ground plate is mechanically connected and integrated with the first ground contact and the second ground contact.

4. The connector set according to claim 2, wherein
the signal contact, the ground contact, and the ground plate are disposed such that the plurality of first signal contacts and the plurality of second signal contacts are electrically equivalent.

5. The connector set according to claim 4, wherein
the plurality of first signal contacts and the plurality of second signal contacts have a symmetrical structure with respect to the ground plate.

6. The connector set according to claim 5, wherein:
the plurality of first signal contacts and the plurality of second signal contacts have a same shape in a cross section taken perpendicular to an extending direction,
a distance from a signal line contact section, a signal line relay section, and a signal line connection section of each of the plurality of first signal contacts to the ground plate is the same as a distance from a signal line contact section, a signal line relay section, and a signal line connection section of each of the plurality of second signal contacts to the ground plate.

7. The connector set according to claim 2, wherein:
the first connector is a wire-to-board cable-side connector connected to a plurality of cables used for transmission of a high-frequency signal,
the plurality of cables comprise a first cable connected to the plurality of first signal contacts and a second cable connected to the plurality of second signal contacts,
the first cable and the second cable are pulled out in a direction parallel to a mating direction, and a row of the first cable and a row of the second cable are stacked on top of each other in a direction orthogonal to the mating direction, and
the ground plate comprises a flat surface parallel to the mating direction and a pull-out direction of the plurality of cables.

8. The connector set according to claim 2, wherein:
the first connector is a wire-to-board cable-side connector connected to a plurality of cables used for transmission of a high-frequency signal,
the plurality of cables comprise a first cable connected to the plurality of first signal contacts and a second cable connected to the plurality of second signal contacts,
the first cable and the second cable are pulled out in a direction orthogonal to a mating direction, and a row of the first cable and a row of the second cable are stacked on top of each other in the mating direction, and
the ground plate is bent in an L-shape, and comprises a first flat surface parallel to the mating direction and a second flat surface extending in a pull-out direction of the plurality of cables.

9. The connector set according to claim 2, wherein
the ground plate is electrically connected to a counterpart ground contact of the counterpart second connector via the first ground contact and the second ground contact.

10. The connector set according to claim 9, wherein
the counterpart ground contact integrally supports the first ground contact, the second ground contact, and the ground plate by a spring force.

11. The connector set according to claim 1, wherein
a plurality of the first ground contacts are electrically and mechanically connected to one another.

12. The connector set according to claim 11, wherein
the plurality of first ground contacts are electrically and mechanically connected to one another at least at one of opposite ends in an extending direction.

13. The connector set according to claim 1, wherein
the first ground contact is incorporated into a ground fitting being a single member.

14. The connector set according to claim 1, wherein:
the first ground contact comprises a shielding section disposed between adjacent ones of the plurality of first signal contacts, and
each of a plurality of the shielding sections comprises two shielding plates disposed to be perpendicular to a pitch direction.

15. The connector set according to claim 14, wherein
two of the plurality of first signal contacts are disposed in a region sandwiched by the shielding sections of two of the first ground contacts.

16. The connector set according to claim 15, wherein
a distance from one of the two first signal contacts disposed in the region sandwiched by the two shielding sections to one of the shielding sections adjacent to the one first signal contact is the same as a distance from an other of the two first signal contacts to an other of the shielding sections adjacent to the other first signal contact.

17. The connector set according to claim 14, wherein
the two shielding plates is capable of clamping a shield part of a cable in a space formed by the two shielding plates.

18. The connector set according to claim 17, wherein
the shield part is a drain wire disposed longitudinally alongside the cable having a shield layer.

19. A connector, comprising:
a signal contact connected to a signal line;
a ground contact connected to ground; and
a flat ground plate connected to the ground, wherein
the signal contact comprises a plurality of first signal contacts disposed to face a first main surface of the flat ground plate,
the ground contact comprises a first ground contact disposed between adjacent ones of the plurality of first signal contacts, and
the first ground contact makes direct contact with the first main surface of the flat ground plate.

20. A connector that is a wire-to-board connector configured to connect a cable used for transmission of a high-frequency signal and a circuit board to each other by mating with a counterpart connector mounted on the circuit board, the connector comprising:
a plurality of signal contacts connected to a signal line of the cable; and
a shielding section that is connected to ground and disposed between two adjacent ones of the plurality of signal contacts, wherein
the shielding section comprises two interconnection shielding plates disposed between signal line connection sections of the two adjacent signal contacts, the two interconnection shielding plates being disposed to be perpendicular to a facing direction in which the signal line connection sections face each other.

21. The connector according to claim 20, wherein
two of the plurality of signal contacts are disposed in a region sandwiched between two of the shielding sections.

22. The connector according to claim 21, wherein
a distance from one of the two signal contacts disposed in the region sandwiched between the two shielding sections to one of the two shielding section adjacent to the one signal contact is the same as a distance from an other of the two signal contacts to an other of the two shielding sections adjacent to the other signal contact.

23. The connector according to claim 20, wherein
the two interconnection shielding plates are capable of clamping a shield part of the cable in a space formed by the two interconnection shielding plates.

24. The connector according to claim 23, wherein
the shield part is a drain wire disposed longitudinally alongside the cable having a shield layer.

25. The connector according to claim 19, further comprising:
a flat cable comprising a plurality of the signal lines used for transmission of a high-frequency signal and an insulator covering the plurality of signal lines;
a paddle card comprising the signal contact, the ground contact, and a board on which the signal contact and the ground contact are disposed; and
a ground shield attached to the paddle card so as to cover a connection part between the plurality of signal lines and the signal contact, wherein
the ground shield comprises a flat base section extending in a pitch direction, and a partition section formed to protrude from the flat base section so as to separate, from each other, two of the connection parts adjacent to each other in the pitch direction, the partition section being connected to the ground contact.

26. The connector according to claim 25, wherein:
the flat cable comprises a first flat cable disposed on a first main surface of the board and a second flat cable disposed on a second main surface of the board opposite the first main surface,
the signal contact comprises a plurality of first signal contacts disposed on the first main surface of the board and a plurality of second signal contacts disposed on the second main surface of the board,
the ground contact comprises a first ground contact disposed between adjacent ones of the plurality of first signal contacts and a second ground contact disposed between adjacent ones of the plurality of second signal contacts; and
the ground shield comprises a first ground shield attached to the first main surface of the board so as to cover the connection part between the signal line of the first flat cable and the plurality of first signal contacts, and a second ground shield attached to the second main surface of the board so as to cover the connection part between the signal line of the second flat cable and the plurality of second signal contacts.

27. The connector according to claim 25, wherein:
an exposed portion of the signal line from the insulator comprises a bent portion bending towards the board side and a soldering portion connected to the signal contact, the ground shield comprises a recessed section formed by the flat base section and the partition section,
the recessed section comprises a first recessed section for covering the bent portion and a second recessed section for covering the soldering portion, and
a depth of the second recessed section is smaller than a depth of the first recessed section.

28. The connector according to claim 25, wherein:
the paddle card comprises an engaging recessed section, and
the ground shield comprises an engaging piece engageable with the engaging recessed section.

29. A connector that is a wire-to-board connector configured to connect a cable and a circuit board to each other by mating with a counterpart connector mounted on the circuit board, the connector comprising:
a flat cable comprising a plurality of signal lines used for transmission of a high-frequency signal;
a paddle card comprising:
a plurality of signal contacts connected to the plurality of signal lines,
a ground contact connected to ground, and
a board on which the plurality of signal contacts and the ground contact are disposed; and
a ground shield attached to the paddle card so as to cover a connection part between the plurality of signal lines and the plurality of signal contacts, wherein
the ground shield comprises a flat base section and a partition section formed to protrude from the flat base section so as to separate, from each other, two of the connection parts adjacent to each other, the partition section being connected to the ground contact.
